(19) United States
(12) Patent Application Publication
(10) Pub. No.: US 2025/0384882 A1
(43) Pub. Date: Dec. 18, 2025

(54) RESPONSE OUTPUT APPARATUS

(71) Applicant: MAXELL, LTD., Kyoto (JP)

(72) Inventors: Takuya SHIMIZU, Kyoto (JP); Kazuo SHIKITA, Kyoto (JP)

(21) Appl. No.: 19/235,658

(22) Filed: Jun. 12, 2025

(30) Foreign Application Priority Data
Jun. 13, 2024 (JP) 2024-096046

(51) Int. Cl. G10L 15/22; G10L 15/183

(52) U.S. Cl. CPC G10L 15/22; G10L 15/183

(57) ABSTRACT

The controller is capable of executing a client application that can exchange information with a large language model application that controls a large language model on a server external to the response output apparatus or stored in the response output apparatus. The client application is capable of generating a prompt for the large language model based on the user input received via the input interface, sending control information that differs from the prompt to the large language model application, sending the prompt to the large language model application, receiving a response phrase that is a result of inference executed by the large language model from the large language model application, and outputting a response based on the response phrase to the user via the output interface. The storage is configured to store settings related to conversation characteristics of a character.

### CROSS-REFERENCE TO RELATED APPLICATION

The present application claims priority from Japanese Patent Application No. 2024-096046 filed on Jun. 13, 2024, the contents of which are hereby incorporated by reference into this application.

### TECHNICAL FIELD

The present invention relates to a response output apparatus.

### BACKGROUND

Japanese Patent Application Laid-Open Publication No. 2019-528512 (Patent Document 1) discloses a response output technique using artificial intelligence such as language models.

### SUMMARY

However, Patent Document 1 fails to sufficiently consider, for example, a configuration to more suitably provide a user with a response output technique using artificial intelligence.

Therefore, an object of the present invention is to provide a more suitable response output technique.

In order to solve the above-described problem, a configuration described in, for example, the attached claims is adopted. The present application includes a plurality of measures for solving the above-described problem, one such example being a response output apparatus comprising an input interface configured to receive a user input, a controller, a storage, and an output interface configured to output a response to a user. The controller is capable of executing a client application that can exchange information with a large language model application that controls a large language model stored in a server external to the response output apparatus or in the response output apparatus. The client application is capable of generating a prompt for the large language model based on the user input received via the input interface, sending control information that differs from the prompt to the large language model application, sending the prompt to the large language model application, receiving a response phrase that is a result of inference executed by the large language model from the large language model application, and outputting a response based on the response phrase to the user via the output interface. The storage stores settings related to conversation characteristics of a character.

According to the present invention, a more suitable response output technique can be provided. Other problems, configurations and effects will become apparent from the following description of the embodiments.

### DRAWINGS

FIG. 1A is a drawing showing an example of an artificial intelligence response output apparatus and system according to an embodiment of the present invention.

FIG. 1B is a drawing showing an example of the artificial intelligence response output apparatus according to the embodiment of the present invention.

FIG. 1C is a drawing showing an example of an operation of the artificial intelligence response output apparatus and system according to the embodiment of the present invention.

FIG. 2A is an explanatory diagram of an example of a character conversation apparatus and character conversation system according to the embodiment of the present invention.

FIG. 2B is an explanatory diagram of an example of an operation of the character conversation apparatus and character conversation system according to the embodiment of the present invention.

FIG. 2C is an explanatory diagram of an example of an operation of the character conversation apparatus and character conversation system according to the embodiment of the present invention.

FIG. 2D is an explanatory diagram of an example of a conversation in the character conversation apparatus and character conversation system according to the embodiment of the present invention.

FIG. 2E is an explanatory diagram of an example of an operation of the character conversation apparatus and character conversation system according to the embodiment of the present invention.

FIG. 2F is an explanatory diagram of an example of an operation of the character conversation apparatus and character conversation system according to the embodiment of the present invention.

FIG. 2G is an explanatory diagram of an example of an operation of the character conversation apparatus and character conversation system according to the embodiment of the present invention.

FIG. 2H is an explanatory diagram of an example of an operation of the character conversation apparatus and character conversation system according to the embodiment of the present invention.

FIG. 2I is an explanatory diagram of an example of an operation of the character conversation apparatus and character conversation system according to the embodiment of the present invention.

FIG. 2J is an explanatory diagram of an example of an operation of the character conversation apparatus and character conversation system according to the embodiment of the present invention.

FIG. 2K is an explanatory diagram of an example of an operation of the character conversation apparatus and character conversation system according to the embodiment of the present invention.

FIG. 2L is an explanatory diagram of an example of an operation of the character conversation apparatus and character conversation system according to the embodiment of the present invention.

FIG. 3A is an explanatory diagram of an example of the character conversation apparatus and character conversation system according to the embodiment of the present invention.

FIG. 3B is an explanatory diagram of an example of an operation of the character conversation apparatus and character conversation system according to the embodiment of the present invention.

FIG. 3C is an explanatory diagram of an example of an operation of the character conversation apparatus and character conversation system according to the embodiment of the present invention.

FIG. 3D is an explanatory diagram of an example of a conversation in the character conversation apparatus and character conversation system according to the embodiment of the present invention.

FIG. 3E is an explanatory diagram of an example of an operation of the character conversation apparatus and character conversation system according to the embodiment of the present invention.

FIG. 3F is an explanatory diagram of an example of an operation of the character conversation apparatus and character conversation system according to the embodiment of the present invention.

FIG. 3G is an explanatory diagram of an example of an operation of the character conversation apparatus and character conversation system according to the embodiment of the present invention.

FIG. 3H is an explanatory diagram of an example of an operation of the character conversation apparatus and character conversation system according to the embodiment of the present invention.

FIG. 3I is an explanatory diagram of an example of an operation of the character conversation apparatus and character conversation system according to the embodiment of the present invention.

FIG. 4A is an explanatory diagram of an example of an operation of the character conversation apparatus and character conversation system according to the embodiment of the present invention.

FIG. 4B is an explanatory diagram of an example of an operation of the character conversation apparatus and character conversation system according to the embodiment of the present invention.

FIG. 5A is an explanatory diagram of an example of an operation of the artificial intelligence response output apparatus according to the embodiment of the present invention.

FIG. 5B is an explanatory diagram of display examples of the artificial intelligence response output apparatus according to the embodiment of the present invention.

FIG. 5C is an explanatory diagram of display examples of the artificial intelligence response output apparatus according to the embodiment of the present invention.

FIG. 5D is an explanatory diagram of display examples of the artificial intelligence response output apparatus according to the embodiment of the present invention.

FIG. 6 is an explanatory diagram of an example of the response generation processing of the artificial intelligence response output apparatus according to the embodiment of the present invention.

FIG. 7 is an explanatory diagram of an example of the artificial intelligence response output apparatus and system according to the embodiment of the present invention.

FIG. 8A is an explanatory diagram of an example of a configuration of the artificial intelligence response output system according to the embodiment of the present invention.

FIG. 8B is an explanatory diagram of an example of a configuration of the artificial intelligence response output system according to the embodiment of the present invention.

FIG. 8C is an explanatory diagram of an example of a configuration of the artificial intelligence response output system according to the embodiment of the present invention.

FIG. 9A is an explanatory diagram of a conversation example used to describe the embodiment of the present invention.

FIG. 9B is an explanatory diagram of an example of table information according to the embodiment of the present invention.

FIG. 9C is an explanatory diagram of a conversation example used to describe the embodiment of the present invention.

FIG. 9D is an explanatory diagram of a conversation example used to describe the embodiment of the present invention.

FIG. 9E is an explanatory diagram of an example of table information according to the embodiment of the present invention.

FIG. 9F is an explanatory diagram of a conversation example used to describe the embodiment of the present invention.

FIG. 9G is an explanatory diagram of a conversation example used to describe the embodiment of the present invention.

FIG. 10A is an explanatory diagram of a conversation example used to describe the embodiment of the present invention.

FIG. 10B is an explanatory diagram of an example of table information according to the embodiment of the present invention.

FIG. 10C is an explanatory diagram of a conversation example used to describe the embodiment of the present invention.

FIG. 10D is an explanatory diagram of a conversation example used to describe the embodiment of the present invention.

FIG. 11A is an explanatory diagram of an example of table information according to the embodiment of the present invention.

FIG. 11B is an explanatory diagram of a conversation example used to describe the embodiment of the present invention.

FIG. 11C is an explanatory diagram of a conversation example used to describe the embodiment of the present invention.

FIG. 12A is an explanatory diagram of a conversation example used to describe the embodiment of the present invention.

FIG. 12B is an explanatory diagram of a conversation example used to describe the embodiment of the present invention.

FIG. 12C is an explanatory diagram of a conversation example used to describe the embodiment of the present invention.

FIG. 13A is an explanatory diagram of an example of table information according to the embodiment of the present invention.

FIG. 13B is an explanatory diagram of an example of table information according to the embodiment of the present invention.

FIG. 13C is an explanatory diagram of a conversation example used to describe the embodiment of the present invention.

FIG. 13D is an explanatory diagram of an example of speaking speed adjustment according to the embodiment of the present invention.

FIG. 13E is an explanatory diagram of an example of speaking speed adjustment according to the embodiment of the present invention.

FIG. 13F is an explanatory diagram of an example of speaking speed adjustment according to the embodiment of the present invention.

FIG. 13G is an explanatory diagram of an example of speaking speed adjustment according to the embodiment of the present invention.

FIG. 13H is an explanatory diagram of an example of speaking speed adjustment according to the embodiment of the present invention.

FIG. 13I is an explanatory diagram of an example of speaking speed adjustment according to the embodiment of the present invention.

FIG. 13J is an explanatory diagram of an example of speaking speed adjustment according to the embodiment of the present invention.

FIG. 14 is an explanatory diagram of an example of table information according to the embodiment of the present invention.

### PREFERRED EMBODIMENTS

Hereinafter, embodiments of the present invention will be described in detail with reference to the drawings. Note that the present invention is not limited to the embodiment described herein, and various changes and modifications can be made by those skilled in the art without departing from the scope of technical concepts disclosed herein. In addition, in all of the drawings used to describe the present invention, components having identical functions may be denoted by the same reference sign, and redundant descriptions thereof may be omitted as appropriate.

Note that an artificial intelligence response output apparatus according to each embodiment of the present invention having a display screen may also be referred to as a display apparatus. The artificial intelligence response output apparatus having an audio output function may also be referred to as an audio output apparatus. The artificial intelligence response output apparatus may also simply be referred to as an information processing apparatus. A system including the artificial intelligence response output apparatus and a large language model server that holds a large language model may also be referred to as an artificial intelligence response output system. In addition, in a case where the artificial intelligence response output apparatus provides a response service of a large language model which is artificial intelligence to the user to assist the user, the artificial intelligence response output apparatus or a display output of the artificial intelligence response output apparatus can be an artificial intelligence (AI) assistant for the user. Therefore, in this case, the artificial intelligence response output apparatus may also be referred to as an AI assistant apparatus or an AI assistant display apparatus. Likewise, in this case, a system including the artificial intelligence response output apparatus and a large language model server that holds a large language model may also be referred to as an AI assistant system or an AI assistant display system. In addition, in this case, the artificial intelligence response output apparatus serves as an interface between the user and the artificial intelligence and thus may also be referred to as an artificial intelligence interface apparatus. In this case, a system including the artificial intelligence response output apparatus and a large language model server that holds a large language model may also be referred to as an artificial intelligence interface system.

### First Embodiment

Hereinafter, an artificial intelligence response output apparatus and system that outputs a response from a large language model artificial intelligence will be described as a first embodiment of the present invention.

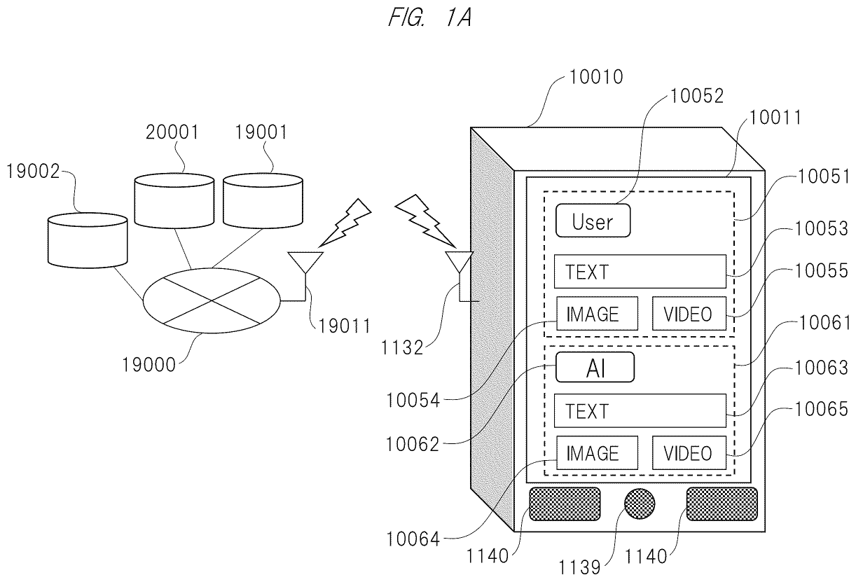

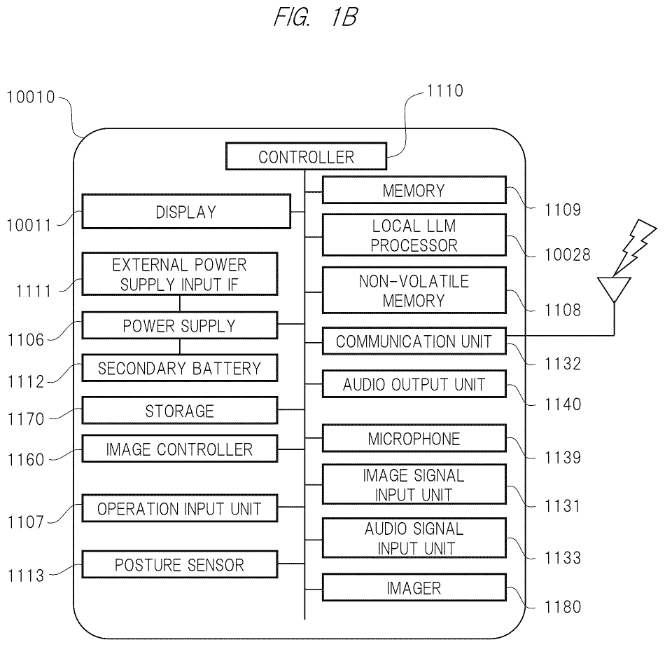

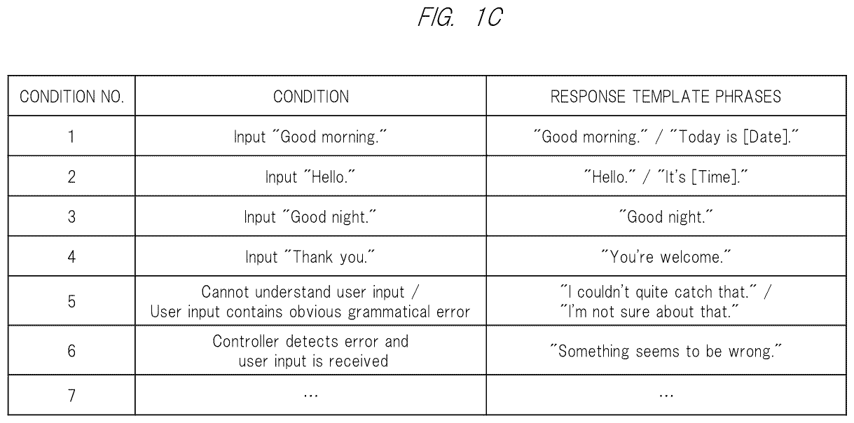

Hereinafter, an example of an artificial intelligence response output apparatus 10010 of the present invention will be described with reference to FIG. 1A. In addition, an example of a system in which the artificial intelligence response output apparatus 10010 includes a large language model server 19001 and/or a multimodal large language model server 20001 in a case where the artificial intelligence response output apparatus 10010 cooperates with the large language model server 19001 through communication or the like will be described.

In the example of FIG. 1A, the artificial intelligence response output apparatus 10010 has a display 10011. In the example of FIG. 1A, the display 10011 may be a flat panel display, a screen that projects an image from a rear surface, or an aerial projector that forms an optical image in midair. In a case where the display 10011 is a flat panel display, the display may be a liquid crystal display having a liquid crystal panel and a backlight. In addition, the display 10011 may be a plasma display. The display 10011 may be an organic EL display in which pixels emit light. In addition, the display 10011 may be provided with a touch operation input sensor configured as a touch panel.

In the example of FIG. 1A, an audio output unit 1140 of the artificial intelligence response output apparatus 10010 is configured with a speaker. In addition, the artificial intelligence response output apparatus 10010 comprises a microphone 1139 capable of capturing a user's voice. Using audio input from the microphone 1139 or an operation input of the user via an operation input unit described below, the artificial intelligence response output apparatus 10010 can acquire user input that serves as a prompt for the large language model which is artificial intelligence.

The artificial intelligence response output apparatus 10010 may comprise a local large language model. In this case, a response of the large language model may be output as display output on the above-described display 10011 and/or as audio output of the audio output unit 1140.

In addition, the artificial intelligence response output apparatus 10010 may not comprise the local large language model, but may communicate with an external large language model server 19001 and may output the response received from the large language model server 19001 as display output of the above-described display 10011 and/or as audio output of the audio output unit 1140.

Alternatively, the artificial intelligence response output apparatus 10010 may be further configured to communicate with the external large language model server 19001 having a large language model, or the external large language model server 20001 having a multimodal large language model in addition to comprising the local large language model. In this case, a response of the local large language model and a response received from the large language model of the large language model server 19001 or from the multimodal large language model of the multimodal large language model server 20001 may be switched, and either of the responses may be output as display output of the above-described display 10011 and/or as audio output of the audio output unit 1140. Alternatively, a response generated based on both the response of the local large language model and the response received from the large language model of the large language model server 19001 or the multimodal large language model server 20001 may be output as display output of the above-described display 10011 and/or as audio output of the audio output unit 1140.

A configuration where the artificial intelligence response output apparatus 10010 communicates and cooperates with the external large language model server 19001 or the large language model server 20001 is as follows. The artificial intelligence response output apparatus 10010 can communicate with a communication apparatus 19011 connected to the Internet 19000 via a communication unit 1132. The example of FIG. 1A shows a wireless communication between the communication unit 1132 and the communication apparatus 19011. However, the communication may be a wired communication. A communication path between the communication unit 1132 and the communication apparatus 19011 may include both wired and wireless portions, and may pass through a router or a repeater. The artificial intelligence response output apparatus 10010 can communicate with the large language model server 19001 via the communication apparatus 19011 and the Internet 19000. In addition, the artificial intelligence response output apparatus 10010 can communicate with the large language model server 19001 or the large language model server 20001 and a second server 19002 that differs from these servers via the communication apparatus 19011 and the Internet 19000. A configuration including the artificial intelligence response output apparatus 10010 and the large language model server 19001 or the large language model server 20001 may be considered as a single system.

In the following description, unless otherwise specified, the expression “large language model” may be considered to be a concept that includes the local large language model of the artificial intelligence response output apparatus 10010, the large language model of the large language model server 19001, and the multimodal large language model of the large language model server 20001.

The example of FIG. 1A shows the display 10011 displaying each element in two display regions, one being a prompt display region 10051 in which the user inputs a prompt to the large language model which is artificial intelligence, and the other being an artificial intelligence response display region 10061 for displaying the response from the large language model. The example of FIG. 1A shows the prompt display region 10051 displaying, for example, an icon 10052 indicating the user, text 10053 such as natural language or software code as a component of the prompt, an image 10054 as a component of the prompt, and video 10055 as a component of the prompt. The example of FIG. 1A shows the artificial intelligence response display region 10061 displaying, for example, an icon 10062 indicating the artificial intelligence or the artificial intelligence assistant, text 10063 such as natural language or software code as a component of a response from the artificial intelligence, an image 10064 as a component of a response from the artificial intelligence, and video 10065 as a component of a response from the artificial intelligence. Note that the display example of the display 10011 of the artificial intelligence response output apparatus 10010 shown in FIG. 1A is merely one example. A display that differs from the example shown in FIG. 1A may be displayed depending on an implementation example in which the artificial intelligence response output apparatus 10010 is used.

Here, the large language model will be described. The large language model is also referred to as LLM. Specifically, various models such as GPT-1, GPT-2, GPT-3, InstructGPT, and ChatGPT have been made available. These techniques may also be used in the present embodiment. Note that these large language models are artificial intelligence models generated through large-scale pre-training on natural language contained in numerous documents and texts existing in the human world. The number of parameters in these artificial intelligence models exceeds one billion. Further, there are models that have been enhanced with reinforcement learning based on human feedback. An example of a model based on this includes a model called a transformer. An example of learning of these models can be found in, for example, Reference 1.

### [Reference 1]

Long Ouyang, et. al. “Training language models to follow instructions with human feedback”, https://arxiv.org/pdf/2203.02155.pdf

These large language models are capable of performing natural language translation, natural language proofreading, natural language summarization, and the like. Among these, advanced models are capable of responding in natural language (also called dialogue or conversation), generating suggestions in natural language, generating programming code, and the like. The number of parameters in these artificial intelligence models is extremely large, requiring vast amounts of data and computational resources for training. Therefore, training artificial intelligence at this level for a specific use is extremely inefficient in terms of resources. Thus, as a foundation model that can be applied to various uses, a model has been generated through large-scale pre-training. For example, the large language model server 19001 shown in FIG. 1A may comprise such a large language model and may be configured to utilize various terminals via an API (Application Programming Interface). In addition, the artificial intelligence response output apparatus 10010 shown in FIG. 1A may comprise the local large language model and may be configured to be utilized by the artificial intelligence response output apparatus 10010 itself. Training of the large language model itself may be performed separately through large-scale pre-training, and the generated large language model may be replicated and loaded in the large language model server 19001, the artificial intelligence response output apparatus 10010, or the like. In this manner, instead of performing pre-training for each use or terminal, replicating the large language model which is the foundation model generated through large-scale pre-training and utilizing it on individual servers or terminals allows for shared resource consumption during training, resulting in improved efficiency in terms of resources.

Note that even if the large language model as the foundation model generated through large-scale pre-training is used, it may be configured to perform additional training such as transfer learning in individual servers or apparatuses according to the use or purpose.

In addition, the large language model can perform pre-training of natural language and perform input/output processing targeting natural language. Further, the multimodal large language model artificial intelligence capable of processing not only natural language text information but also other types of information other than the natural language text information can also be applied to the embodiment of the present invention. FIG. 1A shows the large language model server 20001 having the multimodal large language model. Examples of the multimodal large language model artificial intelligence specifically include GPT-4 (see Reference 2) and Gato (see Reference 3). These techniques may also be used in the present embodiment. Note that these multimodal large language models are artificial intelligence models generated through large-scale pre-training on natural language contained in numerous documents and texts existing in the human world and types of information other than the natural language text information (such as image, video, audio). Further, there are models that have been enhanced with reinforcement learning based on human feedback. Hereinafter, types of information other than the natural language text information such as image, video, and audio may also be referred to as a non-natural language information source.

### [Reference 2]

Open AI “GPT-4 Technical Report”, https://cdn.openai.com/papers/gpt-4.pdf

### [Reference 3]

Scott Reed, et. al. “A Generalist Agent”, https://arxiv.org/pdf/2205.06175.pdf

Next, a configuration example of the artificial intelligence response output apparatus 10010 configured to receive input from the user for the above-described artificial intelligence such as large language models, and to output the response from the artificial intelligence such as the large language model corresponding to the input from the user will be described with reference to FIG. 1B.

The artificial intelligence response output apparatus 10010 comprises the display 10011, a controller 1110, a memory 1109, a non-volatile memory 1108, an external power supply input interface 1111, an operation input unit 1107, a power supply 1106, a secondary battery 1112, a storage 1170, an image controller 1160, a posture sensor 1113, the communication unit 1132, the audio output unit 1140, the microphone 1139, an image signal input unit 1131, an audio signal input unit 1133, an imager 1180, and the like. The artificial intelligence response output apparatus 10010 may be an apparatus having, for example, a large screen such as a monitor or a television set.

The display 10011 may be a flat panel display, a screen that projects an image from the rear surface, or an aerial projector that forms an optical image in midair. In a case where the display 10011 is a flat panel display, the display may be a liquid crystal display having a liquid crystal panel and a backlight. In addition, the display 10011 may be a plasma display. The display 10011 may be an organic EL display in which pixels emit light. In a case where the display 10011 is a panel, it may also be referred to as a display panel. The display 10011 may be provided with a touch operation input sensor configured to receive a touch operation input by a finger of a user 230. In this case, the display 10011 may be configured as a touch panel. Operation input by the user via the touch panel allows the artificial intelligence response output apparatus 10010 to acquire user input that is the basis of the prompt for the large language model which is artificial intelligence.

The communication unit 1132 may be configured with a Wi-Fi communication interface, a Bluetooth (registered trademark) communication interface, a mobile communication interface such as 4G or 5G, or the like. These communication methods are used such that the communication unit 1132 of the artificial intelligence response output apparatus 10010 can communicate with the communication apparatus 19011 connected to the Internet 19000. Note that the communication path between the communication unit 1132 and the communication apparatus 19011 may include both wired and wireless portions, and may pass through a router or a repeater. In the case of the wired communication, the communication unit 1132 may have an Ethernet connection interface as hardware and perform communication using a LAN communication method. In this manner, the artificial intelligence response output apparatus 10010 can communicate with various servers connected to the Internet 19000.

The artificial intelligence response output apparatus 10010 comprises the controller 1110 such as a CPU and the memory 1109, and the controller 1110 controls the display 10011, the communication unit 1132, and the like.

The power supply 1106 converts AC current input from an external component via the external power supply input interface 1111 into DC current and supplies the necessary DC current to each unit of the artificial intelligence response output apparatus 10010. The secondary battery 1112 stores the power supplied from the power supply 1106. In addition, the secondary battery 1112 supplies power to each unit that requires power in a case where power is not supplied from the external component via the external power supply input interface 1111.

The operation input unit 1107 is, for example, an operation button or a signal receiver for a remote controller or the like, or an infrared light receiver, and inputs a signal regarding an operation that differs from the touch operation on the touch operation input sensor of the display 10011 by the user. The operation input unit 1107 may also be used by, for example, an administrator to operate the artificial intelligence response output apparatus 10010, separately from the user who performs the touch operation on the touch operation input sensor of the display 10011. The operation input by the user via the operation input unit 1107 allows the artificial intelligence response output apparatus 10010 to acquire user input that is the basis of the prompt for the large language model which is artificial intelligence. Note that there may also be a modification configured such that the touch operation input sensor of the display 10011 is included as a portion of the operation input unit 1107.

The image signal input unit 1131 connects to an external image output apparatus to input image data. The image signal input unit 1131 may be configured with various digital image input interfaces. For example, it may be configured with an HDMI (registered trademark) (High-Definition Multimedia Interface) compliant image input interface, a DVI (Digital Visual Interface) compliant image input interface, a DisplayPort compliant image input interface, or the like. Alternatively, an analog image input interface such as an analog RGB or a composite video may be provided. The image signal input unit 1131 may also be various USB interfaces and the like.

The audio signal input unit 1133 connects to an external audio output apparatus to input audio data. The audio signal input unit 1133 may be configured with an HDMI compliant audio input interface, an optical digital terminal interface, a coaxial digital terminal interface, or the like. The audio signal input unit 1133 may also be various USB interfaces and the like. In the case of the HDMI compliant interface, the image signal input unit 1131 and the audio signal input unit 1133 may be configured as an interface with an integrated terminal and cable.

The audio output unit 1140 can output audio based on audio data input to the audio signal input unit 1133. The audio output unit 1140 can also output audio based on audio data stored in the storage 1170. The audio output unit 1140 may be configured with a speaker. In addition, the audio output unit 1140 may output a built-in operation sound or an error warning sound. Alternatively, the audio output unit 1140 may be configured to output an audio signal as a digital signal to an external device in accordance with an audio return channel function defined in the HDMI standard. Alternatively, the audio output unit 1140 may be configured to output an audio signal as an analog signal to an external device such as a headphone.

The microphone 1139 captures sound surrounding the artificial intelligence response output apparatus 10010 and converts it into a signal to generate an audio signal. The microphone may record human voice such as the user's voice, and the controller 1110 described below may perform audio recognition processing on the generated audio signal to acquire text information from the audio signal. Audio input from the microphone 1139 allows the artificial intelligence response output apparatus 10010 to acquire user input that is the basis of the prompt for the large language model which is artificial intelligence.

The imager 1180 is a camera having an image sensor. The camera may be provided on a front surface side or a rear surface side of the display 10011 of the artificial intelligence response output apparatus 10010. Cameras may be provided on both the front surface and the rear surface. In the present embodiment, the imager 1180 is described as having cameras on both the front surface and the rear surface.

The storage 1170 is a storage apparatus that records various types of information of various types of data such as video data, image data, and audio data. The storage 1170 may be configured with a magnetic recording media apparatus such as a hard disk drive (HDD) or a semiconductor device memory such as a solid-state drive (SSD). For example, the storage 1170 may record various types of information of various types of data such as video data, image data, and audio data prior to product shipment. In addition, the storage 1170 may record various types of information of various types of data such as video data, image data, and audio data acquired from an external device, an external server, or the like via the communication unit 1132. Video data, image data, and the like recorded in the storage 1170 is output to the display 10011. Video data, image data, and the like recorded in the storage 1170 may be output to an external device, an external server, or the like via the communication unit 1132.

The image controller 1160 performs various controls regarding image signals input to the display 10011. The image controller 1160 may also be referred to as an image processing circuit, and may be configured with, for example, hardware such as an ASIC, an FPGA, or an image processor. Note that the image controller 1160 may also be referred to as a video processor or an image processor. The image controller 1160 performs image switching controls such as determining which image signal to input to the display 10011 from among the image signals stored in the memory 1109 and the image signals (image data) input to the image signal input unit 1131. In addition, the image controller 1160 may perform image processing controls on the image signal input from the image signal input unit 1131, the image signal stored in the memory 1109, and the like. Image processing includes, for example, scaling processing such as enlarging, reducing, or transforming the image, brightness adjustment processing for changing brightness of the image, contrast adjustment processing for changing the contrast curve of the image, and retinex processing such as decomposing the image into a light component and changing the weighting of each component.

The posture sensor 1113 is constituted by a gravity sensor or an acceleration sensor or a combination thereof, and can detect a posture of the artificial intelligence response output apparatus 10010. The controller 1110 may control the operation of each connected unit based on a posture detection result of the posture sensor 1113.

The non-volatile memory 1108 stores various types of data used for the artificial intelligence response output apparatus 10010. The data stored in the non-volatile memory 1108 includes, for example, data for various operations displayed on the display 10011 of the artificial intelligence response output apparatus 10010, a display icon, data for an object operated by the user for operation, layout information, and the like. The memory 1109 stores the image data to be displayed on the display 10011, data for controlling the apparatus, and the like. The controller 1110 may read various software from the storage 1170 and load and store it in the memory 1109.

A local LLM processor 10028 comprises a memory capable of holding the large language model (LLM), and can execute inference of the large language model based on the control of the controller 1110. The hardware may be configured with the so-called GPU (Graphics Processing Unit) or the like. The local LLM processor 10028 may perform not only inference but also training. Note that, in a case where execution of inference of the large language model in a local environment of the artificial intelligence response output apparatus 10010 and the like is not required, the local LLM processor 10028 is not necessary.

The controller 1110 controls the operation of each connected unit. In addition, the controller 1110 may cooperate with a program stored in the memory 1109 and perform arithmetic processing based on information acquired from each unit in the artificial intelligence response output apparatus 10010. A control state of the controller 1110 includes, for example, a state in which the response from the large language model of the local LLM processor 10028 or the response from the large language model of the large language model server 19001 or the multimodal large language model of the multimodal large language model server 20001 acquired via the communication unit 1132 is output via the display 10011 or the audio output unit 1140 such as the speaker.

Note that, in a case where input is received from the user via the above-described touch panel, the microphone 1139, or the operation input unit 1107, the controller 1110 may perform controls to generate a prompt based on the input, send the prompt to the local large language model of the local LLM processor 10028, the large language model of the large language model server 19001, or the multimodal large language model of the large language model server 20001 of the artificial intelligence response output apparatus 10010, and acquire responses from these large language models.

In addition, a response template phrase database (response template phrase DB) for outputting a template phrase in response to the prompt of the artificial intelligence response output apparatus 10010 may be stored in the storage 1170. The controller 1110 may generate the response to be output using the data stored in the response template phrase database. FIG. 1C shows an example of the response template phrase database. In the example of FIG. 1C, the artificial intelligence response output apparatus 10010 stores response template phrases to be output for each condition labeled with a condition number. For example, in a case where the user inputs “Good morning” via the above-described touch panel, the microphone 1139, or the operation input unit 1107 as in Condition 1, a response using the response template phrase “Good morning” or “Today is [Date]” may be output. The portion inside the brackets ([ ]) may be generated using the information stored in the memory 1109 of the artificial intelligence response output apparatus 10010.

In addition, in the example of the response template phrases in the database shown in FIG. 1C, in a case where a plurality of response template phrases separated by slashes (/) are stored, the controller 1110 may randomly select one of the response template phrases using a random number or the like and output the response. This can eliminate and improve a situation where responses under the same conditions become monotonous. The same description applies to the examples of condition numbers 2, 3, and 4. The controller 1110 may perform controls on the output such that response template phrases for each example shown in FIG. 1C is used for the conditions of each example shown in FIG. 1C.

Next, an example of Condition 5 shown in FIG. 1C will be described. Condition 5 is an example in which, in a case where the controller 1110 cannot understand the meaning of the user input acquired via the touch panel, the microphone 1139, or the operation input unit 1107 as natural language, or in a case where the user input contains an obvious grammatical error, the controller 1110 performs a control to output a response using the response template phrase “I couldn't quite catch that” or “I'm not sure about that”. Such a response allows the user to re-enter the input and allows the controller to wait for the corrected user input.

Next, an example of Condition 6 shown in FIG. 1C will be described. Condition 6 is an example in which the controller 1110 is in a state where an error (abnormal state) is detected in any of the units configuring the artificial intelligence response output apparatus 10010 shown in FIG. 1B, and the user input is received via the touch panel, the microphone 1139, or the operation input unit 1107. In this case, the controller 1110 performs a control to output a response using the response template phrase “Something seems to be wrong”. Such a response allows the user to be notified that the artificial intelligence response output apparatus 10010 is malfunctioning and allows the user to take error response measures.

The artificial intelligence response output apparatus 10010 may output responses using the response template phrase database (response template phrase DB) described with reference to FIG. 1C instead of responses of the large language models such as the local large language model of the artificial intelligence response output apparatus 10010, the large language model of the large language model server 19001, and the multimodal large language model of the large language model server 20001. Alternatively, the artificial intelligence response output apparatus 10010 may output responses that in which responses of these large language models and responses using the response template phrase database (response template phrase DB) are combined.

Note that the response template phrase database (response template phrase DB) described above with reference to FIG. 1C is stored in the storage 1170, and the controller 1110 of the artificial intelligence response output apparatus 10010 may use this database. However, the response template phrase database (response template phrase DB) shown in FIG. 1C may be provided on the large language model server 19001 side or the large language model server 20001 side. In this case, the controller of the large language model server 19001 or the controller of the large language model server 20001 may generate a response using the response template phrase database (response template phrase DB). The controller of the large language model server 19001 or the controller of the large language model server 20001 may send the response generated using the response template phrase database (response template phrase DB), instead of the response generated by the large language model stored in each server, to the artificial intelligence response output apparatus 10010. This makes it possible to generate a response using the response template phrase database (response template phrase DB) even if the artificial intelligence response output apparatus 10010 does not have a response template phrase database (response template phrase DB).

Note that the above-described artificial intelligence response output apparatus 10010 has been described as having a display panel of a display screen using fixed pixels. This concept may include a projection-type image display apparatus (projector) that is provided with a projection optical system after the display panel of the display screen using fixed pixels, and configured to project an optical image of the display panel of the display screen onto a screen or a wall.

Note that, in the example of FIGS. 1A and 1B, the artificial intelligence response output apparatus 10010 is shown as comprising the display 10011. However, the artificial intelligence response output apparatus 10010 according to the embodiments of the present invention does not necessarily need to comprise the display 10011. For example, even without the display 10011, the apparatus may be configured to receive input from the user input to the artificial intelligence via the audio signal input unit 1133 or the microphone 1139, and to output the response corresponding to the user input from the artificial intelligence such as the large language model via the audio output unit 1140.

According to the artificial intelligence response output apparatus and artificial intelligence response output system according to the above-described first embodiment of the present invention, it is possible to receive input from the user to the artificial intelligence such as the large language model, and to output a response corresponding to the input from the user and generated by inference of the artificial intelligence such as a large language model of a server apparatus on a network or the local large language model of the artificial intelligence response output apparatus itself.

### Second Embodiment

Next, an example in which the artificial intelligence response output apparatus 10010 according to the first embodiment is connected to the Internet and operates by connecting to a server having the large language model artificial intelligence via the Internet will be described as a second embodiment of the present invention. In the present embodiment, only differences from the first embodiment will be described, and descriptions of configurations similar to those of the first embodiment will be omitted as appropriate.

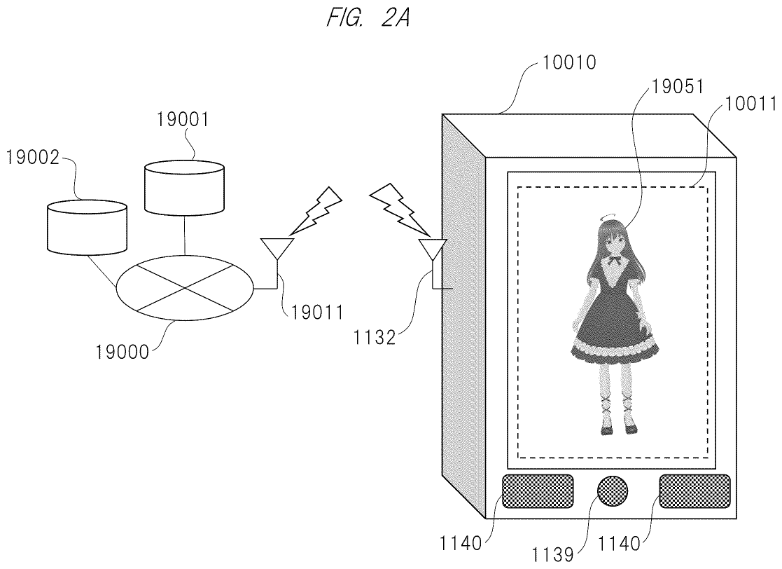

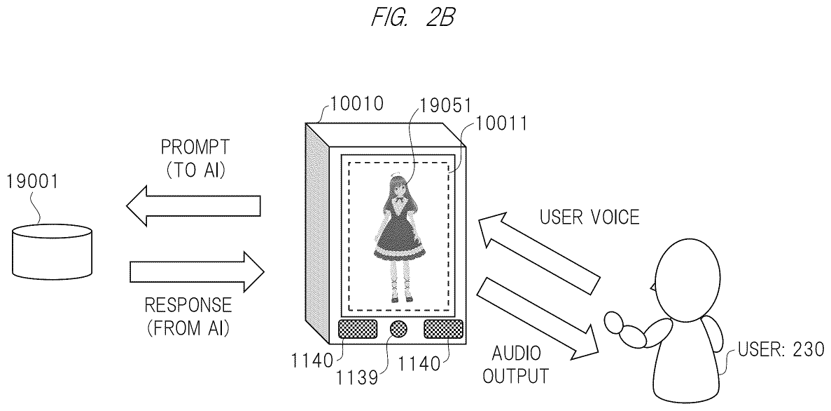

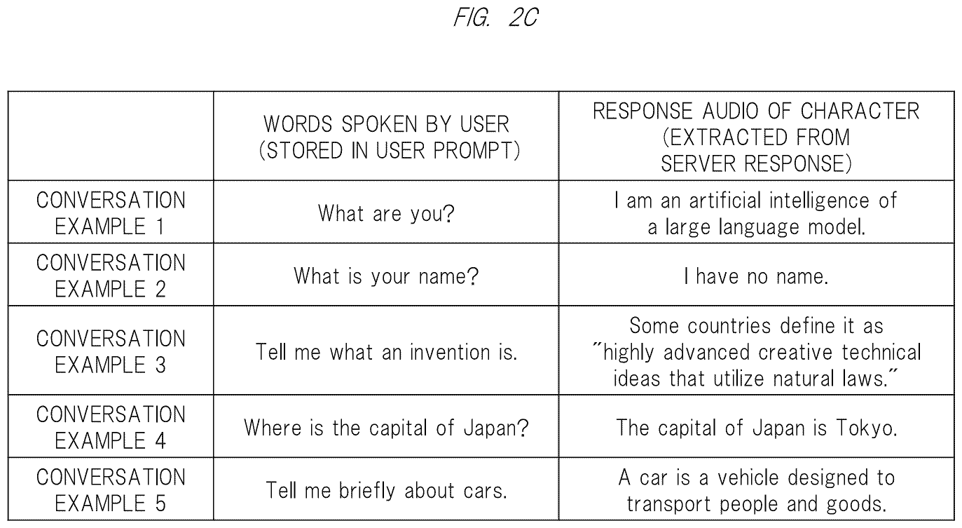

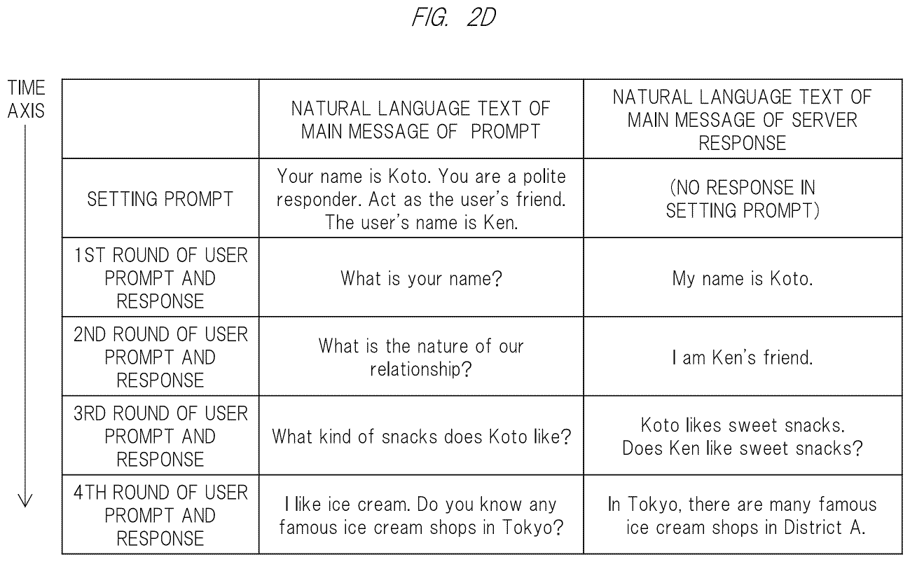

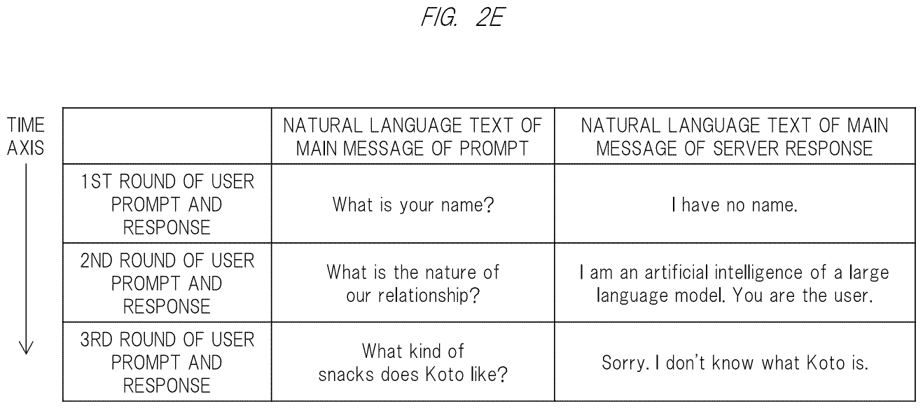

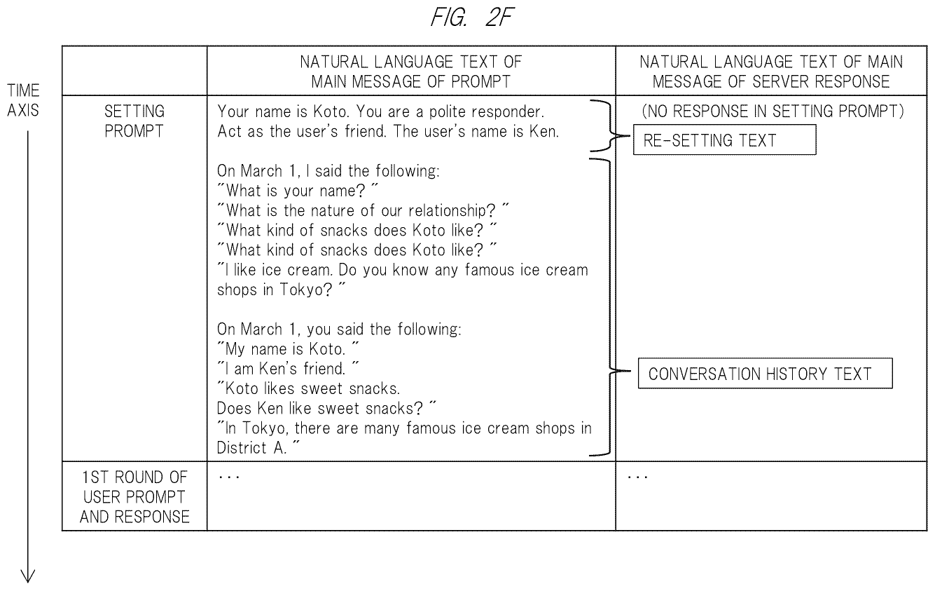

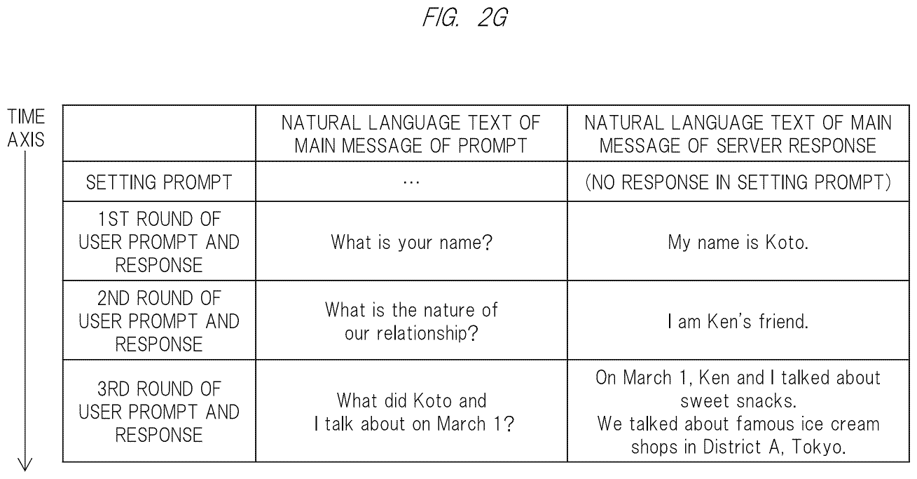

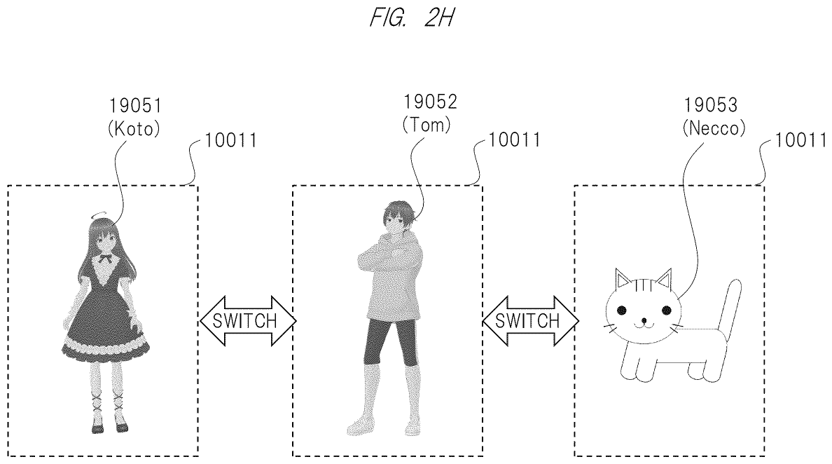

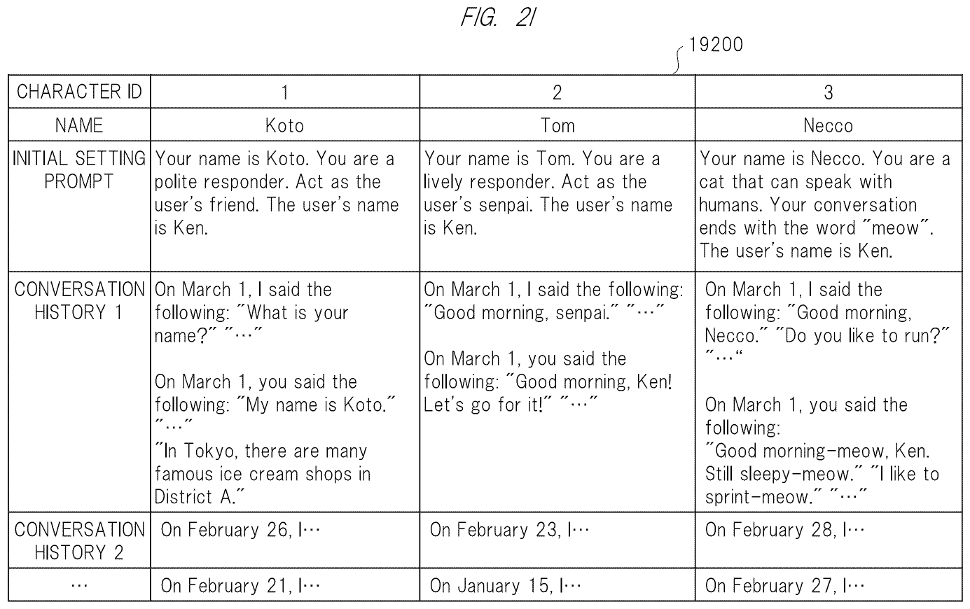

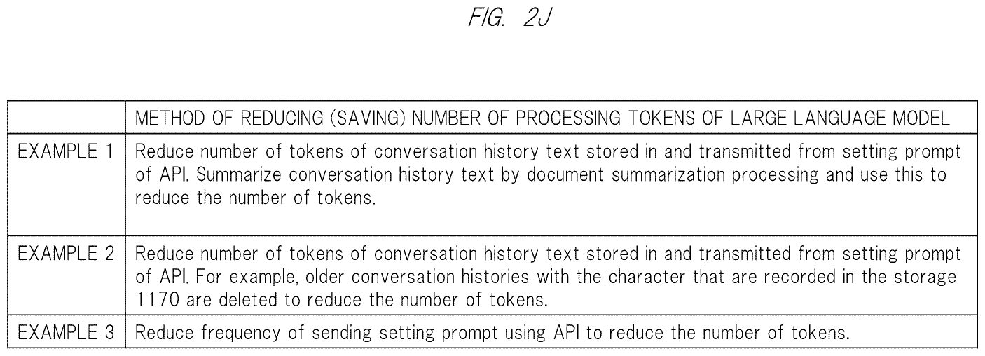

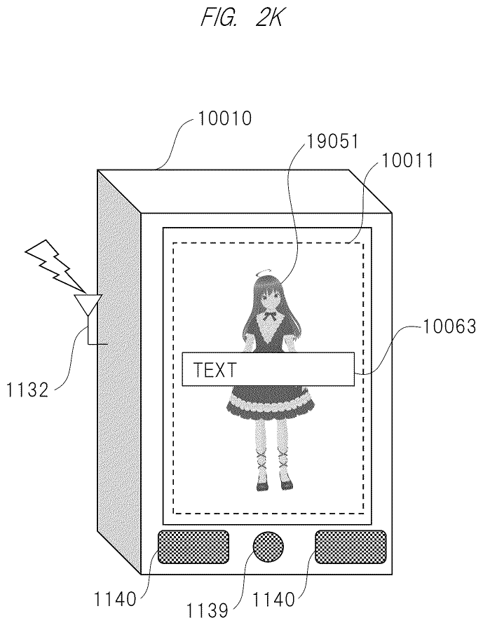

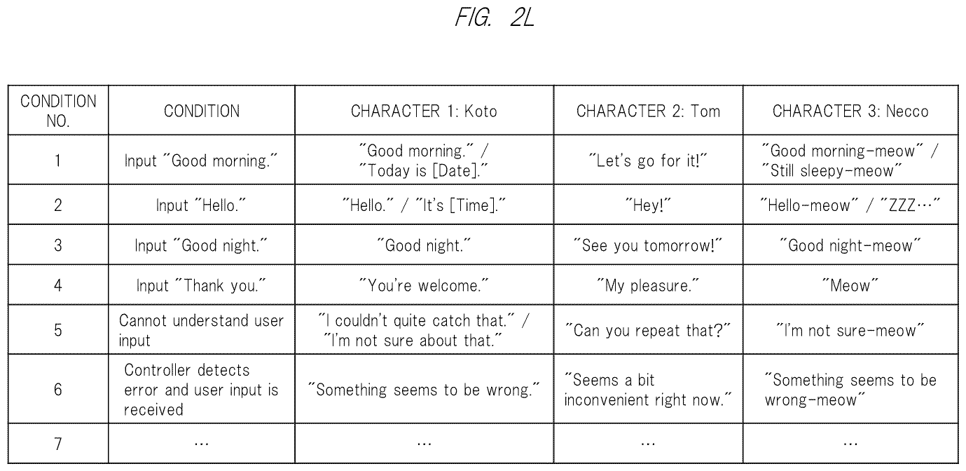

An example of a connection state between the artificial intelligence response output apparatus 10010 and the large language model server 19001 according to the second embodiment of the present invention will be described with reference to FIG. 2A. The artificial intelligence response output apparatus 10010 according to the second embodiment may also be referred to as a character conversation apparatus. In addition, a system including the artificial intelligence response output apparatus 10010 according to the second embodiment and the large language model server 19001 may also be referred to as a character conversation system. The display 10011 displayed by the artificial intelligence response output apparatus 10010 displays an image of a character 19051. The image of the character 19051 is generated by rendering a 3D model of a character in a virtual space.

In addition, the character in the present embodiment provides the user with a service of the large language model which is artificial intelligence to assist the user. Therefore, the character can serve as an artificial intelligence (AI) assistant for the user. In this case, the character conversation apparatus or the character conversation system in the present embodiment may also be referred to as an AI assistant conversation apparatus, an AI assistant display apparatus, an AI assistant response output apparatus, an AI assistant conversation system, an AI assistant display system, or an AI assistant response output system.

In the example of FIG. 2A, the audio output unit 1140 of the artificial intelligence response output apparatus 10010 is configured with a speaker. In addition, the artificial intelligence response output apparatus 10010 comprises the microphone 1139 and can capture the user's voice. The artificial intelligence response output apparatus 10010 can communicate with the communication apparatus 19011 connected to the Internet 19000 via the communication unit 1132. The example of FIG. 2A shows wireless communication between the communication unit 1132 and the communication apparatus 19011. However, the communication may be a wired communication. The communication path between the communication unit 1132 and the Internet 19000 may include both wired and wireless portions. The artificial intelligence response output apparatus 10010 can communicate with the large language model server 19001 via the communication apparatus 19011 and the Internet 19000. In addition, the artificial intelligence response output apparatus 10010 can communicate with the second server 19002 that differs from the large language model server 19001 via the communication apparatus 19011 and the Internet 19000. A configuration including the artificial intelligence response output apparatus 10010 and the large language model server 19001 may be considered as a single system.

Next, an example of the operation of the character conversation apparatus (artificial intelligence response output apparatus 10010) according to the second embodiment of the present invention will be described with reference to FIG. 2B. This is also a description of an example of the operation of the character conversation system including the artificial intelligence response output apparatus 10010 and the large language model server 19001. Note that the communication paths such as the Internet 19000 shown in FIG. 2A are omitted in FIG. 2B. In FIG. 2B, the user 230 of the artificial intelligence response output apparatus 10010 is also shown.

Here, a series of operations of the artificial intelligence response output apparatus 10010 will be described. Note that the artificial intelligence response output apparatus 10010 loads a character operation program stored in the storage 1170 or the like to the memory 1109, and the controller 1110 executes the character operation program such that it is possible to achieve various types of processing described below.

First, the artificial intelligence response output apparatus 10010 comprises the microphone 1139. When the user 230 speaks to the character 19051, the user's voice (words spoken by the user) is captured by the microphone 1139 and is converted into an audio signal. Here, the character operation program executed by the controller 1110 extracts the text of the words spoken by the user 230 from the audio signal. The text is natural language. Note that the extraction of the text of the words spoken by the user 230 may be continued for all words, or may be started after a trigger keyword is input and when words are spoken by the user within a predetermined period. For example, the trigger keyword may be a case where the user says “Hello” followed with the character's name. For example, if the name of the character 19051 is “Koto”, the trigger keyword may be “Hello, Koto!”.

Based on the text of the words spoken by the user 230, the character operation program of the artificial intelligence response output apparatus 10010 creates the prompt and sends the prompt to the large language model server 19001 using the API. Here, the prompt may be metadata in which information such as format such as markup format using tags in a markup language, format using a predetermined symbol such as markdown format, or object format using a predetermined script such as JSON is stored. Natural language text information is stored in the prompt as the main message. Types of prompts sent from the artificial intelligence response output apparatus 10010 to the large language model server 19001 include a setting prompt for storing instructions such as initial settings and a user prompt that reflect the instruction from the user. Type identification information that identifies whether the prompt is the setting prompt or the user prompt may be stored in a portion of the prompt other than its main message. When the character operation program of the artificial intelligence response output apparatus 10010 creates the prompt based on the text of the words spoken by the user 230, the user prompt is created and sent to the large language model server 19001.

Next, based on the prompt sent from the artificial intelligence response output apparatus 10010, the large language model which is artificial intelligence of the large language model server 19001 executes inference and generates a response including the natural language text information based on the inference result. The large language model server 19001 sends the response to the artificial intelligence response output apparatus 10010 using the API. Natural language text information is stored in the response as the main message. Here, the response may be metadata in which information written in the same format as the above-described prompt (e.g., format such as markup format using tags in a markup language, format using a predetermined symbol such as markdown format, or object format using a predetermined script such as JSON) is stored. In a case where the same format as the above-described prompt is used in the response, type identification information indicating that the above-described initial setting prompt and the user prompt are different types of information may be stored in a portion other than the main message. For example, information indicating that the response phrase is from the large language model may be stored.

Next, the artificial intelligence response output apparatus 10010 receives the response from the large language model server 19001, and extracts the natural language text information stored as the main message of the response. Based on the natural language text information extracted from the above-described response, the character operation program of the artificial intelligence response output apparatus 10010 generates natural language audio that serves as a response to the user using an audio synthesis technique, and outputs it from the audio output unit 1140 which is the speaker, so that it sounds as if it is the voice of the character 19051. This processing may be referred to as a “speech” of the character.

As described above, the processing of the artificial intelligence response output apparatus 10010 and the large language model server 19001 provides specific examples of response audio of the character 19051 for the words from the user 230, as shown in conversation examples 1 to 5 of FIG. 2C. In this manner, the user 230 can converse with the character 19051 as if it is a real person.

According to the artificial intelligence response output apparatus 10010 or the system including the artificial intelligence response output apparatus 10010 described above with reference to FIG. 2B, there is no need to install the large language model, which requires vast amounts of data and computational resources for learning, in the artificial intelligence response output apparatus 10010 itself. Moreover, it is possible to utilize advanced natural language processing capabilities of the large language model via the API, and thus, when the user speaks to the character, it is possible to respond to the user and converse with the user more suitably.

Next, an example of the operation of the character conversation apparatus (artificial intelligence response output apparatus 10010) according to the second embodiment of the present invention will be described with reference to FIG. 2D. This is also a description of an example of the operation of the character conversation system including the artificial intelligence response output apparatus 10010 and the large language model server 19001. Specifically, FIG. 2D shows examples of the natural language text of the main message of the prompt sent from the artificial intelligence response output apparatus 10010 to the large language model server 19001 and the natural language text of the main message of the server response which is the response to the prompt. This becomes the basis of the conversation between the user 230 and the character 19051 displayed on the artificial intelligence response output apparatus 10010.

In addition, FIG. 2D shows the setting prompt for the display and exchange of prompts and responses in chronological order from the first round of the user prompt to the fourth round of the user prompt and corresponding responses.

As shown in FIG. 2D, the setting prompt can be used to instruct the large language model which is artificial intelligence of the large language model server 19001 to set initial settings such as the name of the large language model itself, the role it should play, and characteristics of the conversation. In addition, the user's name can be understood as an initial setting. In this manner, the large language model generates the first and subsequent rounds of responses while adhering to its role. The user who hears the audio of the character 19051 based on the first and subsequent rounds of responses can then feel as if the character 19051 has the character's settings and personality as described in the setting prompt. In addition, the large language model server 19001 according to the present embodiment comprises a memory that stores contents of the conversation until the end of a series of conversations, and is configured to store a series of user prompts and their responses and to generate responses. In this manner, a conversation as shown in FIG. 2D can be achieved.

Next, an example of the operation of the character conversation apparatus (artificial intelligence response output apparatus 10010) according to the second embodiment of the present invention will be described with reference to FIG. 2E. This is also a description of an example of the operation of the character conversation system including the artificial intelligence response output apparatus 10010 and the large language model server 19001. Specifically, FIG. 2E shows examples of the natural language text of the main message of the prompt sent from the artificial intelligence response output apparatus 10010 to the large language model server 19001 and the natural language text of the main message of the server response which is the response to the prompt. This becomes the basis of the conversation between the user 230 and the character 19051 displayed on the artificial intelligence response output apparatus 10010.

FIG. 2E shows an example of a new conversation in which the user 230 speaks to the character 19051 again after the continuation of a series of conversations shown in FIG. 2D has ended. In FIG. 2E, the first round of user prompt and its response to the third round of user prompt and its response are shown as an exchange of prompts and responses in chronological order.

Here, the “end” of the “continuation of a series of conversations” refers to a processing in which, if predetermined conditions are met, the large language model server 19001 deletes the conversation memory that had been maintained while a series of conversations was ongoing from the large language model server 19001. An example of the predetermined conditions includes a case where the artificial intelligence response output apparatus 10010 instructs the large language model server 19001 to “end” the “continuation of a series of conversations” via a prompt. In addition, another example of the predetermined conditions includes a case where no prompt regarding a series of conversations is sent from the artificial intelligence response output apparatus 10010 to the large language model server 19001 for a predetermined time or longer (timeout). In addition, another example includes a case where, in the connection between the artificial intelligence response output apparatus 10010 and the large language model server 19001, an authentication processing is performed and the above-described exchange of prompts and responses is being performed, the authentication processing is interrupted due to factors such as communication disconnection or power OFF of the artificial intelligence response output apparatus 10010.

Note that when the “end” of the “continuation of a series of conversations” occurs, the large language model server 19001 deletes the conversation memory that had been maintained while a series of conversations was ongoing from the large language model server 19001. Therefore, even if the conversation shown in FIG. 2E occurs after a series of conversations shown in FIG. 2D, the server response for the user prompt is a response that does not contain contents such as the character name, the role it should play, the conversation characteristics, or the user's name in the setting prompt shown in FIG. 2D and set in the large language model. Likewise, the conversation shown in FIG. 2E is a response that does not contain any memory of a series of conversations shown in FIG. 2D. That is, the “end” of the “continuation of a series of conversations” shown in FIG. 2D causes the conversation of FIG. 2E to start from a state in which the large language model which is artificial intelligence of the large language model server 19001 has been initialized.

This makes the user 230 feel as if the character 19051 has lost its memory of the user or as if the user is dealing with a completely different person. From the perspective of the user 230, the character's response may feel very uncomfortable, leaving the user feeling lonely and disappointed. In such an operation, This posed a challenge on ensuring consistency in the name, role, conversation characteristics, personality and other settings and memories of the character 19051 displayed on the artificial intelligence response output apparatus 10010.

Next, an example of the operation of the character conversation apparatus (artificial intelligence response output apparatus 10010) according to the second embodiment of the present invention will be described with reference to FIG. 2F. This is also a description of an example of the operation of the character conversation system including the artificial intelligence response output apparatus 10010 and the large language model server 19001. Specifically, FIG. 2F shows examples of the natural language text of the main message of the prompt sent from the artificial intelligence response output apparatus 10010 to the large language model server 19001 and the natural language text the main message of the server response which is the response to the prompt. This becomes the basis of the conversation between the user 230 and the character 19051 displayed on the artificial intelligence response output apparatus 10010.

FIG. 2F shows an example of a new conversation in which the user 230 speaks to the character 19051 again after continuation of a series of conversations shown in FIG. 2D has ended. Unlike the processing of FIG. 2E, in the processing of FIG. 2F, when a new conversation is started, the artificial intelligence response output apparatus 10010 sends the setting prompt as the first prompt to the large language model server 19001. The setting prompt stores the same natural language text as the setting prompt of the initial settings of FIG. 2D. This may also be referred to as a re-setting text. The setting prompt also stores the natural language text that describes the history of past conversations. This may also be referred to as conversation history text. The history of past conversations may be recorded by the artificial intelligence response output apparatus 10010 in the storage 1170 as the natural language text information linked with information regarding the date and time of the conversation while the continuation of a series of conversations described with reference to FIG. 2D is ongoing. In a case where there are conversations at different dates, the information including date and time is linked to the respective conversation and recorded, and the conversation history is accumulated. When generating the setting prompt of the first prompt for the conversation that takes place at a later date as shown in FIG. 2F, the natural language text information of the conversation recorded in the storage 1170 and the information including the date and time the conversation took place may be read and used to generate the setting prompt.

Note that, in a case where the natural language text information of the history of past conversations is used to generate the setting prompt, the format can be determined fairly freely as it is data being sent to the large language model. However, as shown in FIG. 2F, it is preferable to prepare prefixes or suffixes in the natural language such as “On [Date], I said the following:” or “On [Date], you said the following:”, fuse them with the natural language text information of the recorded conversation, and perform processing to generate the text of the setting prompt. In addition, information including the date and time of the conversation read from the storage 1170 may be fused with the above-described “[Date]” portion and be used as a part of the text of the setting prompt.

After the continuation of a series of conversations has ended, even if the user 230 speaks to the character 19051 and starts a new conversation, performing the generation processing and the transmission processing of the setting prompt described above with reference to FIG. 2F will ensure that the subsequent response to the user prompt reflects the settings from the previous conversation such as the character's role, name, conversation characteristics, personality, and/or conversation characteristics and the conversation history. In this manner, from the perspective of the user, the consistency of the settings such as the character's role, name, conversation characteristics, or personality and memory from the previous conversation is better ensured, making it more suitable.

Next, an example of the operation of the character conversation apparatus (artificial intelligence response output apparatus 10010) according to the second embodiment of the present invention will be described with reference to FIG. 2G. This is also a description of an example of the operation of the character conversation system including the artificial intelligence response output apparatus 10010 and the large language model server 19001. Specifically, FIG. 2G shows examples of the natural language text of the main message of the prompt sent from the artificial intelligence response output apparatus 10010 to the large language model server 19001 and the natural language text of the main message of the server response which is the response to the prompt. This becomes the basis of the conversation between the user 230 and the character 19051 displayed on the artificial intelligence response output apparatus 10010.

FIG. 2G shows an example of a series of conversations shown in FIG. 2F, from the first round of user prompt following the first setting prompt and its response to the third round of user prompt and its response. In FIG. 2G, the exchange of prompts and responses is shown in chronological order. Contents of the setting prompt are the same as those shown in FIG. 2F, and thus, redundant descriptions thereof are omitted as appropriate.

As shown in the natural language text of the server response in the table of FIG. 2F, using the setting prompt shown in FIG. 2F allows the server response generated by the artificial intelligence of the large language model of the large language model server 19001 to reflect the settings such as the character's role, name, conversation characteristics, or personality and the conversation history from the prior conversation. In this manner, from the perspective of the user, the consistency of the settings such as the character's role, name, conversation characteristics, or personality from the prior conversation and the memory is better ensured, making it more suitable. Note that, since it allows the user to perceive the characters as the same, this may also be referred to as pseudo-consistency of the character as seen by the user.

In addition, from the perspective of the user, the user can share memories with the character, achieving a more enjoyable character conversation experience.

Next, an example of the operation of the character conversation apparatus (artificial intelligence response output apparatus 10010) according to the second embodiment of the present invention will be described with reference to FIG. 2H. This is also a description of an example of the operation of the character conversation system including the artificial intelligence response output apparatus 10010 and the large language model server 19001. Specifically, FIG. 2H shows an operation example in which the character displayed on the display 10011 of the artificial intelligence response output apparatus 10010 is switched to one of a plurality of character candidates. The character operation program executed by the controller 1110 of the artificial intelligence response output apparatus 10010 may switch the displayed character based on, for example, the operation input that is input to the operation input unit 1107 or the operation detected by the touch operation input sensor of the display 10011.

In the example of FIG. 2H, in addition to the character 19051 (named “Koto”) described with reference to FIGS. 2A to 2G, a character 19052 (named “Tom”) and a character 19053 (named “Necco”) are shown. The character 19051 (named “Koto”) and the character 19052 (named “Tom”) are human-like characters, while the character 19053 (named “Necco”) is a cat-like character. The display of the character displayed on the display 10011 can be switched by rendering the characters in different virtual 3D spaces and displaying the generated image on the display 10011.

In addition, it is suitable for the character operation program executed by the controller 1110 to change a synthesized audio used for each character's “speech” when switching the display of the character to be displayed on the display 10011. This may be achieved by storing the data of the synthesized audio of the voice associated with the character in the storage 1170 beforehand and performing synthesized audio change processing when switching the display of the character.

Note that, in the example of FIG. 2H, the apparatus is configured such that the user 230 can converse with any of the characters. In the artificial intelligence response output apparatus 10010 of FIG. 2H, each of these characters is assigned different roles, names, conversation characteristics, or personalities. In addition, the memory of each character based on the conversation history is managed separately for each character.

Thus, the artificial intelligence response output apparatus 10010 constructs a database shown in FIG. 2I in the storage 1170 and manages the character settings and the conversation history of the character using the database.

Next, an example of the operation of the character conversation apparatus (artificial intelligence response output apparatus 10010) according to the second embodiment of the present invention will be described with reference to FIG. 2I. This is also a description of an example of the operation of the character conversation system including the artificial intelligence response output apparatus 10010 and the large language model server 19001. Specifically, FIG. 2I is an explanatory diagram of a database 19200 for managing the character settings and the conversation history of the characters regarding the plurality of characters to be displayed on the display 10011 of the artificial intelligence response output apparatus 10010.

The character operation program executed by the controller 1110 of the artificial intelligence response output apparatus 10010 constructs, for example, the database 19200 in the storage 1170. The character ID may use an identification number that identifies the respective character that can be displayed on the artificial intelligence response output apparatus 10010, and may be a natural number or may use alphabetic characters or the like. The name is data of the respective character that can be displayed on the artificial intelligence response output apparatus 10010.

The initial setting prompt is the natural language text information that describes the settings such as the character's role, name, conversation characteristics, or personality of the respective character that can be displayed on the artificial intelligence response output apparatus 10010. The initial setting prompt is the natural language text information which is the main data of the setting prompt sent from the artificial intelligence response output apparatus 10010 to the large language model server 19001, and thus, it is desirable that the content be written as is in a format that can be read by the large language model which is artificial intelligence of the large language model server 19001.

The conversation histories that include conversation histories 1, 2, and so on are records of conversations between each of the characters and the user, and are recorded separately for each character. The conversation history is included in the natural language text information which is the main data of the setting prompt sent from the artificial intelligence response output apparatus 10010 to the large language model server 19001, and thus, it is desirable that the content be formatted to be readable by the large language model which is artificial intelligence of the large language model server 19001.

In a case where the character to be displayed on the display 10011 of the artificial intelligence response output apparatus 10010 is switched, the character operation program executed by the controller 1110 of the artificial intelligence response output apparatus 10010 uses the database 19200 of FIG. 2I to select and switch the initial setting prompt and conversation history to be used for the natural language text information which is the main data of the setting prompt sent from the artificial intelligence response output apparatus 10010 to the large language model server 19001 so as to correspond to the character displayed on the display 10011 of the artificial intelligence response output apparatus 10010. In addition, the character operation program records the conversation history in a conversation history area corresponding to the character displayed on the display 10011 in the database 19200 of FIG. 2I each time a conversation takes place between the user 230 and the character.

The character operation program executed by the controller 1110 of the artificial intelligence response output apparatus 10010 uses the database 19200 as described above to use the speech of the character to utilize the response of the large language model of the same artificial intelligence of the same large language model server 19001 to enable the conversation between the user 230 and the character while, from the perspective of the user, maintaining the uniqueness of the setting of each character such as the personality of the character, and allow the user to feel as if each character retains distinct conversation memories. From the perspective of the user, the consistency of the settings such as the character's role, name, conversation characteristics, or personality and memories from the prior conversations for each character is more effectively ensured, making it more suitable. This may also be expressed as ensuring the pseudo-consistency of each character from the user's perspective.

Therefore, even in a case where the artificial intelligence response output apparatus 10010 is configured to switch to and display a character among the plurality of character candidates on the display 10011, according to the operation using the above-described database 19200, from the perspective of the user, the user would feel less uncomfortable during the conversation with each character and would be able to share memories with each of the plurality of characters to achieve a more enjoyable character conversation experience.

Note that, by preventing the user from editing the initial setting prompts of the plurality of characters, each of the settings such as the character's role, name, conversation characteristics, or personality can be maintained in as state that is close to the intentions of the provider of the artificial intelligence response output apparatus 10010 or the creator of the character content. Alternatively, the user may be allowed to edit the initial setting prompt of the character depending on the input by the operation input unit 1107 or the like. In this case, it is possible for the user to customize the settings such as the character's role, name, conversation characteristics, or personality, allowing the user to converse with the character set to his or her preferences. In this case, the 3D model of the character, its rendered image, and the type of synthesized audio used for the character may be replaced accordingly.

Next, an example of the operation of the character conversation apparatus (artificial intelligence response output apparatus 10010) according to the second embodiment of the present invention will be described with reference to FIG. 2J. This is also a description of an example of the operation of the character conversation system including the artificial intelligence response output apparatus 10010 and the large language model server 19001. Specifically, a method providing a less costly character conversation apparatus according to the artificial intelligence response output apparatus 10010 and a character conversation service by the character conversation system including the artificial intelligence response output apparatus 10010 and the large language model server 19001 will be described.

As described with reference to FIG. 2B, training artificial intelligence at this level for a specific use limited to the large language model is extremely inefficient in terms of resources. Thus, as a foundation model that can be applied to various uses, it is efficient in terms of resources to generate a model has been through large-scale training and utilize various terminals via the API (Application Programming Interface). Then, the provider of the large language model often recovers the costs incurred in the training of the large language model from the user of the terminal as API usage fees. At this time, in the natural language model, the API usage fees are often charged based on the number of tokens which is the processing amount of word units that make up a sentence.

Thus, in the artificial intelligence response output apparatus 10010 according to the second embodiment of the present invention, by reducing the number of tokens in the natural language text information transmitted between the artificial intelligence response output apparatus 10010 and the large language model server 19001 using the API, a less costly character conversation apparatus according to the artificial intelligence response output apparatus 10010 and a less costly character conversation service by the character conversation system including the artificial intelligence response output apparatus 10010 and the large language model server 19001 can be provided to the user.

For example, using the processing and configuration shown in Examples 1 to 3 in FIG. 2J makes it possible to technically reduce the number of tokens in the natural language text information transmitted between the artificial intelligence response output apparatus 10010 and the large language model server 19001 using the API.

Example 1 is an example of a method for reducing the number of tokens in the conversation history text stored in and transmitted from the setting prompt of the API, using a document summarization processing to shorten the conversation history text and reduce the number of tokens. For example, the natural language of the conversation history with the character recorded in the storage 1170 is summarized and recorded. Sentence summarization may be performed at the start of the next conversation, but is preferable to be performed at the end of the “series of conversations” to allow for more time.

In addition, the sentence summarization processing may be performed by requesting summarization directly from the large language model of the large language model server 19001. However, in this case, savings effect of the number of tokens is low. Therefore, for example, in the second server 19002, in a case where the sentence summarization processing of the natural language via the API is less costly than the large language model of the large language model server 19001, the sentence summarization processing may be requested to the second server 19002 via the API such that the sentence summarization of the conversation history may be stored in and transmitted from the setting prompt for the large language model server 19001.

In addition, if it is required to perform only the sentence summarization processing, it can be performed on the device side, and the sentence summarization may be performed by having the controller 1110 execute a document summarization program stored in the memory 1109 of the artificial intelligence response output apparatus 10010. In this case, the savings effect of the number of tokens is high. In addition, even if the conversation history becomes long, specifying an upper limit on the number of words after summarization in the sentence summarization processing makes it possible to determine the upper limit of a sentence length of the conversation history, and thus, it is possible to set an upper limit value of the token to achieve token savings.

Note that the text information of the character initial settings such as the character's role, name, conversation characteristics, or personality does not increase as much as the conversation history, and thus, it is efficient and preferable to maintain the text of the text information of the initial setting prompt of the character and reduce the number of tokens in the text information of the conversation history.

The processing described with reference to Example 1 may be performed by the character operation program executed by the controller 1110 controlling each unit.

Example 2 is another example of a method for reducing the number of tokens in the conversation history text stored in and transmitted from the setting prompt of the API. For example, the older conversation histories of the character that are recorded in the storage 1170 are deleted to reduce the number of tokens. Specifying the upper limit on the number of words of the conversation history makes it possible to determine the upper limit of the sentence length of the conversation history, and thus, it is possible to set the upper limit value of the token. Alternatively, the method may be such that a predetermined period of the conversation history is specified to delete the conversation history outside the period. In this case also, it is possible to achieve token savings. Note that, in Example 2 also, the text information of the character initial settings such as the character's role, name, conversation characteristics, or personality does not increase as much as the conversation history, and thus, it is efficient and preferable to maintain the text of the text information of the initial setting prompt of the character and reduce the number of tokens in the text information of the conversation history.

The processing described with reference to Example 2 may be performed by the character operation program executed by the controller 1110 controlling each unit.

Example 3 is an example of a method for reducing the number of tokens by reducing frequency of sending the setting prompt using the API. Specifically, after the apparatus' power is turned on or after the display character is switched, even after the image settings and synthesized audio settings for the displayed character have been completed, if the controller 1110 determines that the natural language text information contained in the user's voice captured by the microphone 1139 is text information that should use the large language model which is artificial intelligence without sending the setting prompt beforehand, the setting prompt is initially sent to the large language model server 19001 to reduce the frequency of sending the setting prompt to the large language model server 19001 to reduce the number of tokens.

Specifically, for example, after the apparatus' power is turned on or after the operation input to switch the display character, a display processing of the display 10011 is performed by the control of the character operation program executed by the controller 1110 such that the character 19051 (named “Koto”) is displayed on the display 10011 as shown in FIG. 2H. At this time, for example, if the synthesized audio corresponding to the character 19051 for when the character appears is stored and prepared in the storage 1170 or the like, the synthesized audio for when the character appears such as “Good morning. I'm Koto”, “Hello. I'm Koto”, “Good evening. I'm Koto” or the like may be output from the speaker which is the audio output unit 1140. At this time, the image of the character 19051 is already set as the image of the character displayed on the display 10011, and the synthesized audio output from the speaker which is the audio output unit 1140 is set to the synthesized audio corresponding to the character 19051.

Here, inference processing of the large language model which is the artificial intelligence in the large language model server 19001 described above would take more time as the prompt becomes longer. In particular, in a case where the setting prompt includes the text information related to past conversation history, the number of tokens would increase, and thus, the inference processing time becomes longer. The setting prompt itself and its response is not output to the user 230. In response to the user prompt after the setting prompt, the synthesized audio as the “speech” of the character is output from the speaker which is the audio output unit 1140. Then it would seem to be better to send the setting prompt from the artificial intelligence response output apparatus 10010 to the large language model server 19001 beforehand to complete the inference processing of the large language model for the setting prompt beforehand to allow a faster response for the output of the synthesized audio of the “speech” of the character 19051 after the user 230 talks to the character 19051.

However, there may be cases where the setting prompt is sent to the large language model server 19001 and the inference processing of the large language model for the setting prompt is completed before the user 230 speaks, such as a case where the user 230 turns OFF the power of the artificial intelligence response output apparatus 10010 by an operation via the operation input unit 1107 or the touch operation input sensor of the display 10011, or a case where the user 230 switches the display character from the character 19051 to another character by an operation via the operation input unit 1107 or the touch operation input sensor of the display 10011. In these cases, the number of tokens used for the inference processing of the large language model after the setting prompt is sent to the large language model server 19001 would be the number of processing tokens unnecessarily consumed, resulting in wasted usage fees. This poses an obstacle against providing a less costly character conversation apparatus according to the artificial intelligence response output apparatus 10010 and a less costly character conversation service by the character conversation system including the artificial intelligence response output apparatus 10010 and the large language model server 19001 to the user.

Therefore, after the apparatus' power is turned ON or after the operation input to switch the display character, it is desirable for the artificial intelligence response output apparatus 10010 to use controls of the character operation program executed by the controller 1110 to set the image of the character 19051 as the image of the character to be displayed on the display 10011, and maintain a state where the setting prompt is not sent to the large language model server 19001 until a point at which it is recognized that the user 230 is speaking to the character 19051, even after the synthesized audio to be output from the speaker which is the audio output unit 1140 is set as the synthesized audio corresponding to the character 19051.

Here, the point at which it is recognized that the user 230 is speaking to the character 19051 may refer to, for example, a point at which the trigger keyword described with reference to FIG. 2B is detected, or a point at which extraction of the text of the words spoken by the user 230 is performed. This makes it possible to reduce the number of processing tokens unnecessarily consumed which results in wasted usage fees, and thus, a less costly character conversation apparatus according to the artificial intelligence response output apparatus 10010 and a less costly character conversation service by the character conversation system including the artificial intelligence response output apparatus 10010 and the large language model server 19001 can be provided to the user.

In addition, even after the above-described point at which it is recognized that the user 230 is speaking to the character 19051, if the text information extracted from the audio of the user 230 captured by, for example, the microphone 1139 corresponds to a preset keyword that does not require the inference processing of the large language model, it is desirable to continue the state where the setting prompt is not sent to the large language model server 19001. Specifically, examples of preset keywords include “Jump”, “Dance”, and other keywords that the user 230 uses to request the character 19051 to perform reactions such as animation or synthesized audio of the character 19051. In this case, the character operation program executed by the controller 1110 may read the motion data, animation image, and/or synthesized audio data corresponding to the reactions corresponding to the character 19051 stored in the storage, and may use the data to perform generation processing of the image to be displayed on the display 10011 and output processing of the synthesized audio from the speaker which is the audio output unit 1140.

Such processing does not necessarily require the inference processing of the large language model of the large language model server 19001. For example, after the processing, in the case where the user 230 turns OFF the power of the artificial intelligence response output apparatus 10010 by an operation via the operation input unit 1107 or the touch operation input sensor of the display 10011, or in the case where the user 230 switches the display character from the character 19051 to another character by an operation via the operation input unit 1107 or the touch operation input sensor of the display 10011, if the setting prompt is first sent to the large language model server 19001 and is then processed using the inference processing of the large language model, the number of tokens used for the processing would be the number of processing tokens unnecessarily consumed, resulting in wasted usage fees.

Therefore, even after the above-described point at which it is recognized that the user 230 is speaking to the character 19051, it is desirable that the state where the setting prompt is not sent to the large language model server 19001 is continued until a point where it is determined whether or not the text information extracted from the audio of the user 230 captured by, for example, the microphone 1139 corresponds to the preset keyword that does not require the inference processing of the large language model. If it is determined that the inference processing of the large language model is necessary, it is desirable to send the setting prompt to the large language model server 19001 for the first time and proceed with the inference processing of the large language model.

Note that the processing described with reference to Example 3 may be performed by the character operation program executed by the controller 1110 controlling each unit.

According to the methods for reducing (saving) the number of processing tokens in the large language model described above with reference to the examples in FIG. 2J, a less costly character conversation apparatus according to the artificial intelligence response output apparatus 10010 and a less costly character conversation service including the character conversation system including the artificial intelligence response output apparatus 10010 and the large language model server 19001 can be provided to the user.

Next, an example of the display of the character conversation apparatus (artificial intelligence response output apparatus 10010) according to the second embodiment of the present invention will be described with reference to FIG. 2K. FIG. 2K shows an example in which the responses from the large language model for the prompt from the user described with reference to each of the drawings in FIGS. 2A to 2J are displayed on the display 10011 of the character conversation apparatus (artificial intelligence response output apparatus 10010). Specifically, it is an example in which the text 10063 which is the response from the large language model and the image of the character 19051 are displayed on the display 10011. The text 10063 which is the response from the large language model may be displayed overlapping the image of the character 19051 as shown in FIG. 2K. In addition, the text 10063 which is the response from the large language model may be displayed with the image of the character 19051 without overlapping the image of the character 19051.

The display of FIG. 2K is merely an example. For example, in a case where the user 230 adjusts the volume of the audio output of the audio output unit 1140 of the character conversation apparatus (artificial intelligence response output apparatus 10010) to its minimum or sets the audio output to OFF by operating the operation input unit 1107 or the touch operation input sensor of the display 10011, the user 230 will no longer be able to hear the response from the large language model.

Thus, in this case, the controller 1110 may control a display mode to start displaying the text 10063 which is the response from the large language model together with the image of the character 19051 as shown in FIG. 2K. This makes it possible for the user 230 to use the character conversation apparatus (artificial intelligence response output apparatus 10010) when the user wishes to suppress the audio output. Note that a configuration may be provided in which the user 230 can manually switch the ON/OFF of the display mode that displays the text 10063 which is the response from the large language model and the image of the character 19051 by the operation via the operation input unit 1107 or the touch operation input sensor of the display 10011.

Next, an example of the response template phrase database (response template phrase DB) in the character conversation apparatus (artificial intelligence response output apparatus 10010) that can display a plurality of characters described with reference to FIGS. 2H and 2I will be described with reference to FIG. 2L. The condition numbers and conditions in the example of FIG. 2L are the same as those of FIG. 1C. For these conditions, in the example of FIG. 2L, individual response template phrases are set for each of the plurality of characters. For example, the response template phrases for each condition are stored for each of the three characters, Character 1 named Koto, Character 2 named Tom, and Character 3 named Necco described with reference to FIGS. 2H and 2I. The output control of the response template phrases is the same as that of FIG. 1C, and thus, redundant descriptions thereof are omitted as appropriate.

In the example of FIG. 2L, the controller 1110 may select the corresponding response template phrase from the response template phrase database (response template phrase DB) based on the character displayed on the character conversation apparatus (artificial intelligence response output apparatus 10010) and the current condition, and uses it for the output control as the response of the character. For example, in the example of the response template phrase database (response template phrase DB) of FIG. 2L, even under the same conditions, the response template phrase is changed to the expression or content corresponding to the personality of the character. In this manner, the character conversation apparatus (artificial intelligence response output apparatus 10010) can provide a conversation corresponding to the personality of the displayed character. The user can feel as if each character has a more consistent personality. In this manner, it is possible to achieve the character conversation apparatus (artificial intelligence response output apparatus 10010) that gives the plurality of characters a greater sense of realism.

Note that the response template phrase database (response template phrase DB) described above with reference to FIG. 2L is stored in the storage 1170, and the controller 1110 of the artificial intelligence response output apparatus 10010 may use this database. However, the response template phrase database (response template phrase DB) shown in FIG. 2L may be provided on the large language model server 19001 side. In this case, the controller of the large language model server 19001 may generate a response using the response template phrase database (response template phrase DB). The controller of the large language model server 19001 may send the response generated using the response template phrase database (response template phrase DB), instead of the response generated by the large language model stored in each server, to the artificial intelligence response output apparatus 10010. This makes it possible generate a response using the response template phrase database (response template phrase DB) even if the artificial intelligence response output apparatus 10010 does not have a response template phrase database (response template phrase DB).

According to the above-described character conversation apparatus or the character conversation system according to the second embodiment, the user would feel less uncomfortable during the conversation with the character displayed on the artificial intelligence response output apparatus 10010. In addition, according to the character conversation apparatus or the character conversation system according to the second embodiment, a less costly character conversation service can be provided to the user.

Note that, in the above-described second embodiment, an example in which the large language model of the large language model server 19001 is used as the large language model has been described. Alternatively, the character conversation apparatus (artificial intelligence response output apparatus 10010) may be configured to comprise the local LLM processor 10028 shown in FIG. 1B, and the large language model of the local LLM processor 10028 may be used instead of the large language model of the large language model server 19001. In this case, in the above description, the large language model of the large language model server 19001 according to the second embodiment may be replaced with the large language model of the local LLM processor 10028 of the character conversation apparatus (artificial intelligence response output apparatus 10010).

In this case also, the user would feel less uncomfortable during the conversation with the character displayed on the artificial intelligence response output apparatus 10010. Note that, in a case where the large language model of the local LLM processor 10028 is used instead of the large language model of the large language model server 19001, there is less need to consider the usage fees based on the number of processing tokens. However, even when using the large language model of the local LLM processor 10028, reducing the number of processing tokens can reduce the consumption of resources such as power required for inference. In this case, a character conversation service that consumes less power can be provided to the user.

Note that, in the above-described second embodiment, an example in which the conversation history with the character is recorded and held in the storage 1170 of the character conversation apparatus (artificial intelligence response output apparatus 10010) has been described. Alternatively, the conversation history with the character may be recorded and held in the second server 19002 connected to the Internet 19000 or other cloud servers. In this case, when the user and the character start a new conversation, the character conversation apparatus (artificial intelligence response output apparatus 10010) may communicate with the second server 19002 or the cloud server, acquire (download) the past conversation history between the character and the user, hold it in the storage 1170 or the memory 1109 of the character conversation apparatus (artificial intelligence response output apparatus 10010), and use it to create the prompt for the large language model. The specific method using the past conversation history to create the prompt for the large language model is as described in the second embodiment with reference to each of the drawings, and thus, redundant descriptions thereof are omitted as appropriate.

In addition, the character conversation apparatus (artificial intelligence response output apparatus 10010) may send (upload) the conversation history of the character up to a predetermined point such as each time a conversation takes place between the user and the character, or at a point where the conversation between the user and the character ends to the above-described second server 19002 or other cloud servers. That is, the character conversation apparatus (artificial intelligence response output apparatus 10010) uploads the conversation history with the character to the second server 19002 or other cloud servers at a predetermined timing, and when the user starts a conversation with the user, the character conversation apparatus (artificial intelligence response output apparatus 10010) may download the latest conversation history from the second server 19002 or other cloud servers and may use it to generate the prompt for the large language model. This makes it possible to display the same character on different apparatuses when the character conversation apparatus (artificial intelligence response output apparatus 10010) used by the user on the previous day differs from the character conversation apparatus (artificial intelligence response output apparatus 10010) that the user is about to use. In a case where the user converses with the same character on different apparatuses at different timings, it is possible to achieve a conversation that appears as if the memory of the character from the previous conversation has been virtually carried over, making it more suitable for the user.

The above-described processing in which the character conversation apparatus (artificial intelligence response output apparatus 10010) uploads and downloads the conversation history with the character to and from the second server 19002 or other cloud servers and virtually carries over the memory of the character is also effective in a case where the database 19200 including the conversation histories of the plurality of characters described with reference to FIGS. 2H and 2I is handled. That is, providing a configuration in which the database 19200 described with reference to FIG. 2I is uploaded and downloaded to and from the second server 19002 or other cloud servers can achieve conversations with not only one character but the plurality of characters across different apparatuses, at different timings multiple times, with the memory of each character being virtually carried over from the previous conversation, making it more suitable for the user.

### Third Embodiment

Next, a third embodiment of the present invention is a modified version of the character conversation apparatus (artificial intelligence response output apparatus 10010) and the character conversation system according to the second embodiment described with reference to the drawings. In the present embodiment, only differences from the second embodiment will be described, and descriptions of configurations similar to those of the second embodiment will be omitted as appropriate.

As in the second embodiment, the character in the third embodiment can provide the service of the large language model which is artificial intelligence to the user to assist the user. Therefore, the character can be an artificial intelligence (AI) assistant for user. In this case, the character conversation apparatus or the character conversation system in the present embodiment may also be referred to as an AI assistant conversation apparatus, an AI assistant display apparatus, an AI assistant response output apparatus, an AI assistant conversation system, an AI assistant display system, or an AI assistant response output system.

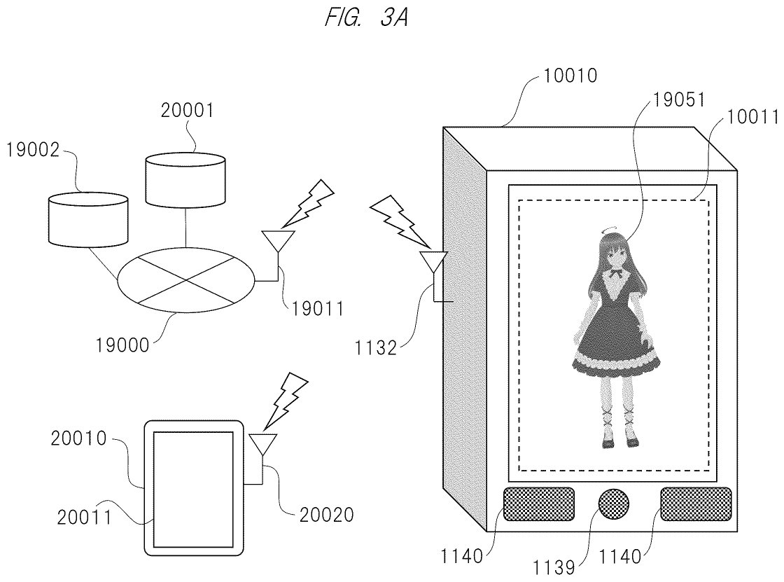

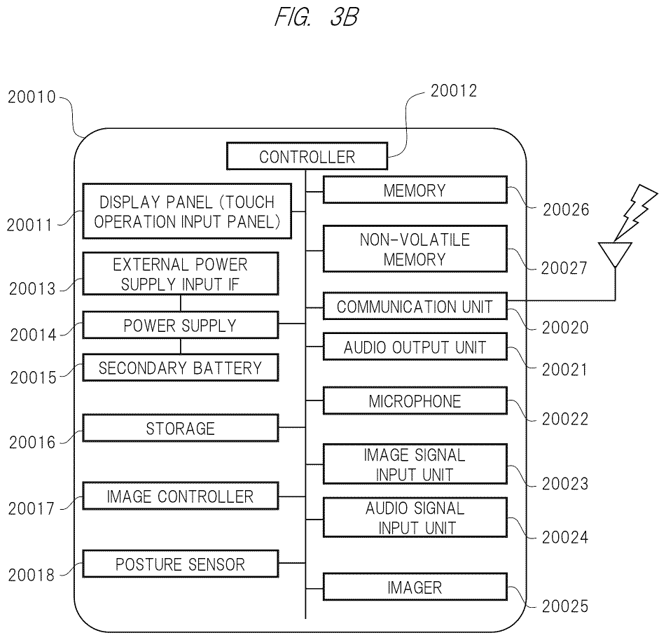

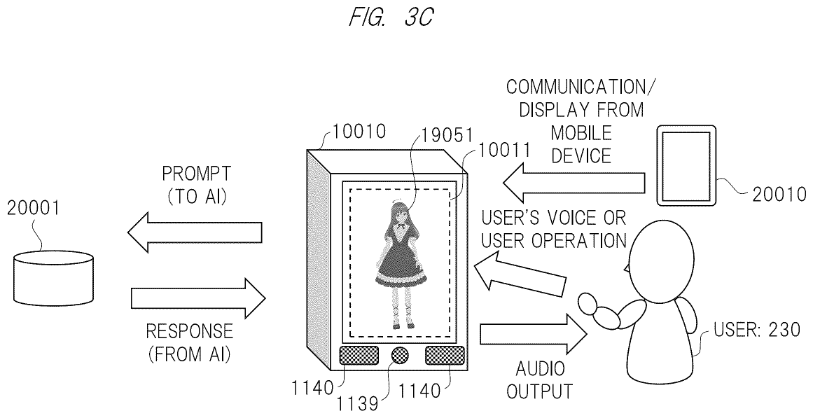

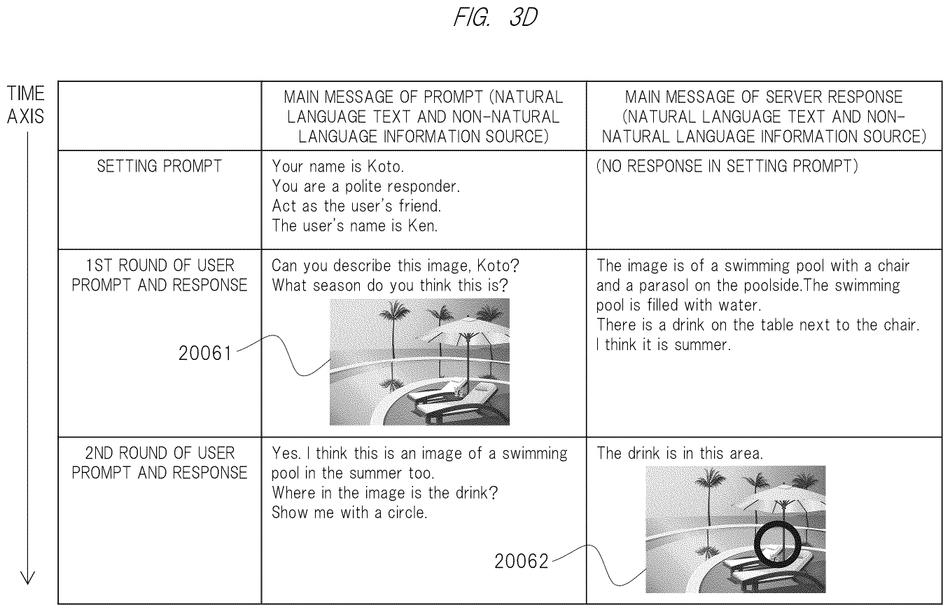

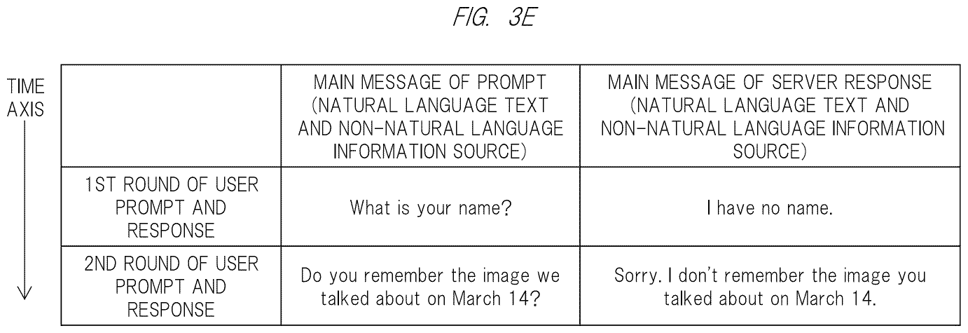

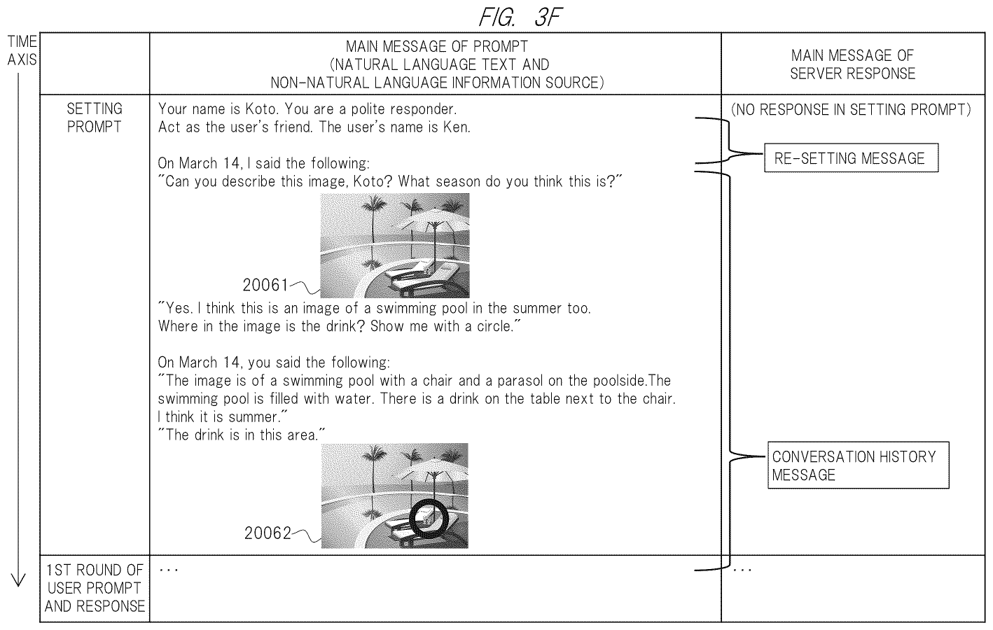

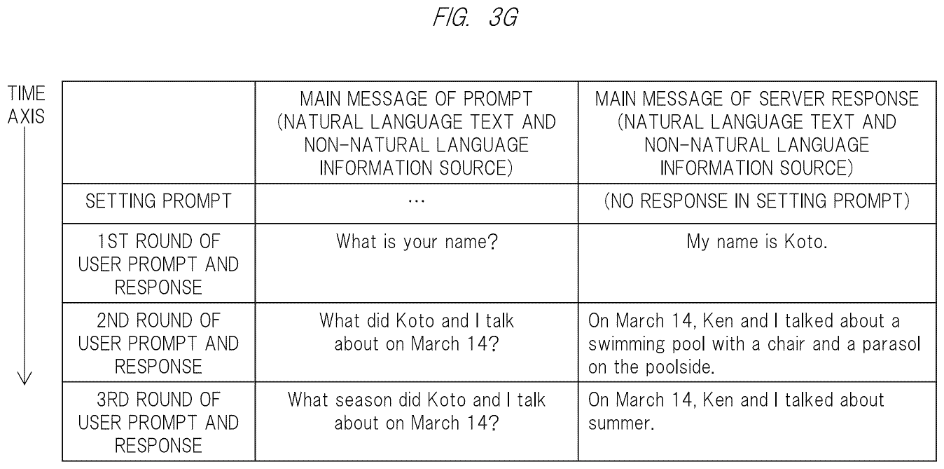

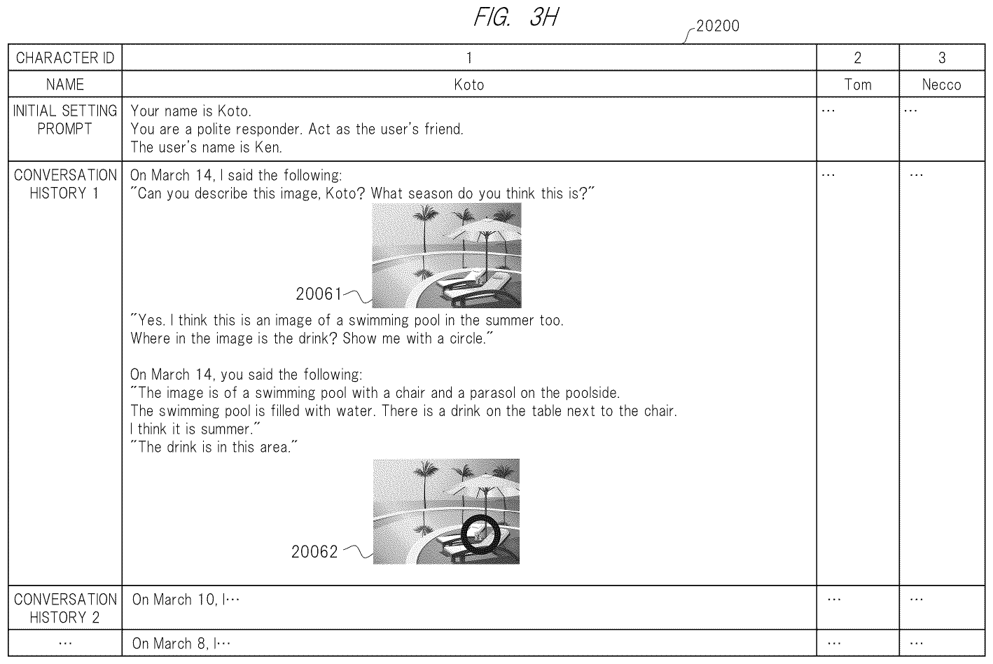

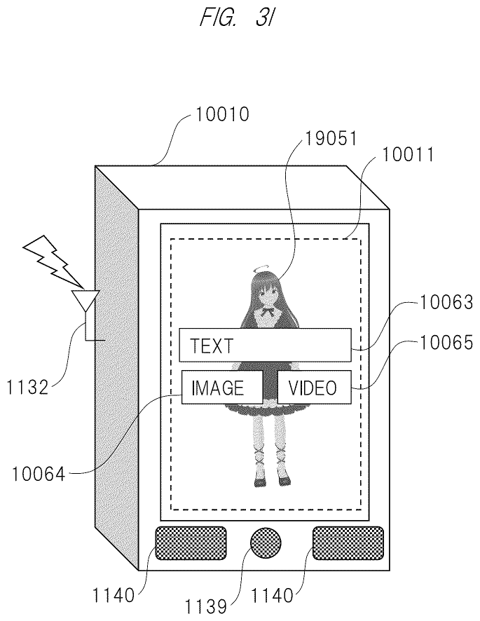

An example of the character conversation apparatus and the character conversation system according to the third embodiment of the present invention will be described with reference to FIG. 3A. The character conversation system according to the third embodiment comprises the large language model server 20001 instead of the large language model server 19001 of FIG. 2A, and is connected to the Internet 19000.

Here, the large language model server 20001 is a server having the large language model artificial intelligence. However, it is a multimodal large language model which is artificial intelligence that can process not only the natural language text information that could be processed by the large language model server 19001 but also types of information other than the natural language text information.

In addition, the artificial intelligence response output apparatus 10010 which is the character conversation apparatus will be described as having the same configuration as the character conversation apparatus (artificial intelligence response output apparatus 10010) according to the second embodiment as an example.

In the third embodiment also, the artificial intelligence response output apparatus 10010 which is the character conversation apparatus can communicate with the large language model of the large language model server 20001 via the Internet 19000 using the API.

The character conversation system according to the third embodiment includes a mobile information processing terminal 20010 to be used by the user 230. The mobile information processing terminal 20010 is a so-called smartphone or a tablet information processing terminal.

Here, an example of the mobile information processing terminal 20010 will be described with reference to FIG. 3B. The mobile information processing terminal 20010 comprises a display panel 20011 which is a touch operation input panel, a controller 20012, an external power supply input interface 20013, a power supply 20014, a secondary battery 20015, a storage 20016, an image controller 20017, a posture sensor 20018, a communication unit 20020, an audio output unit 20021, a microphone 20022, an image signal input unit 20023, an audio signal input unit 20024, an imager 20025, and the like.

The display panel 20011 comprises the touch operation input sensor, and can receive the touch operation input by a finger of the user 230. The display panel 20011 performs displaying with a liquid crystal panel or an organic EL panel and can display an image. The display panel 20011 may also be referred to as a display.

The communication unit 20020 may be configured with a Wi-Fi communication interface, a Bluetooth communication interface, a mobile communication interface such as 4G or 5G, or the like. These communication methods are used such that the communication unit 20020 of the mobile information processing terminal 20010 can communicate with the communication unit 1132 of the character conversation apparatus (artificial intelligence response output apparatus 10010). The mobile information processing terminal 20010 comprises a controller such as a CPU and a memory, and the controller controls the display panel 20011, the communication unit 20020, and the like. In addition, the communication unit 20020 can communicate with the communication apparatus 19011 connected to the Internet 19000 by using any of the communication methods of the communication unit 20020. In this manner, the mobile information processing terminal 20010 can communicate with various servers connected to the Internet 19000.

The power supply 20014 converts AC current input from an external component via the external power supply input interface 20013 into DC current and supplies the necessary DC current to each unit of the mobile information processing terminal 20010. The secondary battery 20015 stores the power supplied from the power supply 20014. In addition, the secondary battery 20015 supplies power to each unit that requires power in a case where power is not supplied from the external component via the external power supply input interface 20013.

The image signal input unit 20023 connects to an external image output apparatus to input image data. The image signal input unit 20023 may be configured with various digital image input interfaces. For example, it may be configured with an HDMI (registered trademark) (High-Definition Multimedia Interface) compliant image input interface, a DVI (Digital Visual Interface) compliant image input interface, a DisplayPort compliant image input interface, or the like. Alternatively, an analog image input interface such as an analog RGB or a composite video may be provided. The image signal input unit 20023 may also be various USB interfaces and the like.

The audio signal input unit 20024 connects to an external audio output apparatus to input audio data. The audio signal input unit 20024 may be configured with an HDMI compliant audio input interface, an optical digital terminal interface, a coaxial digital terminal interface, or the like. The audio signal input unit 20024 may also be various USB interfaces and the like. In the case of the HDMI compliant interface, the image signal input unit 20023 and the audio signal input unit 20024 may be configured as an interface with an integrated terminal and cable.

The audio output unit 20021 can output audio based on audio data input to the audio signal input unit 20024. The audio output unit 20021 can also output audio based on audio data stored in the storage 20016. The audio output unit 20021 may be configured with a speaker. In addition, the audio output unit 20021 may output a built-in operation sound or an error warning sound. Alternatively, the audio output unit 20021 may be configured to output an audio signal as a digital signal to an external device in accordance with an audio return channel function defined in the HDMI standard.

The microphone 20022 captures sound surrounding the mobile information processing terminal 20010 and converts it into a signal to generate an audio signal. The microphone may record human voice such as the user's voice, and the controller 20012 described below may perform audio recognition processing on the generated audio signal to acquire text information from the audio signal.

The imager 20025 is a camera having an image sensor. The camera may be provided on a front surface side or a rear surface side of the display panel 20011 of the mobile information processing terminal 20010. Cameras may be provided on both the front surface and the rear surface. In the present embodiment, the imager 20025 is described as having cameras on both the front surface and the rear surface.

The storage 20016 is a storage apparatus that records various types of information of various types of data such as video data, image data, and audio data. The storage 20016 may be configured with a magnetic recording media apparatus such as a hard disk drive (HDD) or a semiconductor device memory such as a solid-state drive (SSD). For example, the storage 20016 may record various types of information of various types of data such as video data, image data, and audio data prior to product shipment. In addition, the storage 20016 may record various types of information of various types of data such as video data, image data, and audio data acquired from an external device, an external server, or the like via the communication unit 20020. Video data, image data, and the like recorded in the storage 20016 is output to the display panel 20011. Video data, image data, and the like recorded in the storage 20016 may be output to an external device, an external server, or the like via the communication unit 20020.

The image controller 20017 performs various controls regarding image signals input to the display panel 20011. The image controller 20017 may also be referred to as an image processing circuit, and may be configured with, for example, hardware such as an ASIC, an FPGA, or an image processor. Note that the image controller 20017 may also be referred to as a video processor or an image processor. The image controller 20017 performs image switching controls such as determining which image signal to input to the display panel 20011 from among the image signals stored in a memory 20026 and the image signals (image data) input to the image signal input unit 20023. In addition, the image controller 20017 may perform image processing controls on the image signal input from the image signal input unit 20023, the image signal stored in the memory 20026, and the like. Image processing includes, for example, scaling processing such as enlarging, reducing, or transforming the image, brightness adjustment processing for changing brightness of the image, contrast adjustment processing for changing the contrast curve of the image, and retinex processing such as decomposing the image into a light component and changing the weighting of each component.

The posture sensor 20018 is constituted by a gravity sensor or an acceleration sensor or a combination thereof, and can detect a posture of the mobile information processing terminal 20010. The controller 20012 may control the operation of each connected unit based on a posture detection result of the posture sensor 20018.

A non-volatile memory 20027 stores various types of data used for the mobile information processing terminal 20010. The data stored in the non-volatile memory 20027 includes, for example, data for various operations displayed on the display panel 20011 of the mobile information processing terminal 20010, a display icon, data for an object operated by the user for operation, layout information, and the like. The memory 20026 stores the image data to be displayed on the display panel 20011, data for controlling the apparatus, and the like. The controller 20012 may read various software from the storage 20016 and load and store it in the memory 20026.

The controller 20012 controls the operation of each connected unit. In addition, the controller 20012 may cooperate with a program stored in the memory 20026 and perform arithmetic processing based on information acquired from each unit in the mobile information processing terminal 20010.

Next, an example of the operation of the character conversation apparatus (artificial intelligence response output apparatus 10010) according to the third embodiment of the present invention will be described with reference to FIG. 3C. This is also a description of an example of the operation of the character conversation system including the artificial intelligence response output apparatus 10010 and the large language model server 20001. In the third embodiment also, the character conversation apparatus (artificial intelligence response output apparatus 10010) loads the character operation program stored in the storage 1170 or the like to the memory 1109, and the controller 1110 executes the character operation program such that it is possible to achieve various types of processing described below.

In the second embodiment, actions performed by the user 230 for the character conversation apparatus (artificial intelligence response output apparatus 10010) were mainly prompts by the voice of the user 230. In the character conversation apparatus (artificial intelligence response output apparatus 10010) according to the second embodiment, the series of operations were performed starting from the process of capturing the voice of the user 230 with the microphone. Alternatively, in the character conversation apparatus (artificial intelligence response output apparatus 10010) according to the third embodiment, the character conversation apparatus (artificial intelligence response output apparatus 10010) performing the series of operations starting from the process of capturing the voice of the user 230 with the microphone described in the second embodiment can be executed. In addition, in the character conversation apparatus (artificial intelligence response output apparatus 10010) according to the third embodiment, the user 230 can perform actions for the character conversation apparatus (artificial intelligence response output apparatus 10010) by the user operation via the operation input unit 1107 of FIG. 1B. Here, an example of the operation input unit 1107 of FIG. 1B includes a mouse, a keyboard, a touch panel, or the like.

In addition, in the character conversation apparatus (artificial intelligence response output apparatus 10010) according to the third embodiment, the user 230 can perform an action for the character conversation apparatus (artificial intelligence response output apparatus 10010) by the touch operation of the user detectable by the touch operation input sensor of the display 10011 of FIG. 1B.

In addition, the user 230 can operate the mobile information processing terminal 20010 to perform communication with the character conversation apparatus (artificial intelligence response output apparatus 10010) from the mobile information processing terminal 20010 to allow the operation input of the user 230 to be input to the character conversation apparatus (artificial intelligence response output apparatus 10010).

In addition, the display panel 20011 of the mobile information processing terminal 20010 may display an information storage image such as a two-dimensional code in which information that the user wishes to transmit to the character conversation apparatus (artificial intelligence response output apparatus 10010) is stored, and the imager 1180 of the character conversation apparatus (artificial intelligence response output apparatus 10010) of FIG. 1B may capture the display image. The controller 1110 of the character conversation apparatus (artificial intelligence response output apparatus 10010) may extract the information from the information storage image such as the two-dimensional code captured by the imager 1180 to retrieve the information. In addition, the display panel 20011 of the mobile information processing terminal 20010 may display the image that the user wishes to transmit to the character conversation apparatus (artificial intelligence response output apparatus 10010), and the imager 1180 of the character conversation apparatus (artificial intelligence response output apparatus 10010) of FIG. 1B may capture the display image. The controller 1110 of the character conversation apparatus (artificial intelligence response output apparatus 10010) may perform image recognition processing on the image captured by the imager 1180 to acquire a result of the image recognition processing.

In this manner, the character conversation apparatus (artificial intelligence response output apparatus 10010) according to the third embodiment has more actions that can be performed by the user 230 on the character conversation apparatus (artificial intelligence response output apparatus 10010) than the character conversation apparatus (artificial intelligence response output apparatus 10010) described with reference to the second embodiment. In this manner, the character conversation apparatus (artificial intelligence response output apparatus 10010) according to the third embodiment can acquire the result of the user 230 other than the user's voice, and generate the prompt to be sent to the large language model server 20001 based on the result. In this manner, the prompt to be sent to the large language model server 20001 can suitably contain information of types other than the natural language text information extracted from the user's voice. Information of types other than the natural language text information extracted from the user's voice includes, for example, an image, video, audio, or the like.

Next, the character conversation apparatus (artificial intelligence response output apparatus 10010) according to the present embodiment sends the prompt to the large language model server 20001 using the API. In the present embodiment also, the prompt may be metadata in which information such as format such as markup format using tags in a markup language, format using a predetermined symbol such as markdown format, or object format using a predetermined script such as JSON is stored. In the present embodiment also, types of prompts include a setting prompt for storing instructions such as initial settings and a user prompt that reflect the instruction from the user. Type identification information that identifies whether the prompt is the setting prompt or the user prompt may be stored in a portion of the prompt other than its main message. At this time, the prompt contains the natural language text information as the main message. Further, in the present embodiment, it is possible to include the natural language text information and the non-natural language information source such as the image, video, or audio as information of the type other than the natural language text information in the main message of the prompt. The specific method for including the non-natural language information source in the prompt will be described below.

The large language model server 20001 according to the present embodiment has the multimodal large language model that can process the non-natural language information source together with the natural language text information. The large language model server 20001 receives the prompt from the character conversation apparatus (artificial intelligence response output apparatus 10010). Based on the prompt, the multimodal large language model executes inference and generates a response including the natural language text information based on the inference result. Here, the artificial intelligence of the large language model server 20001 is the multimodal large language model, and thus, the response can include the natural language text information and the non-natural language information source such as the image, video, or audio.

The character conversation apparatus (artificial intelligence response output apparatus 10010) receives the response from the large language model server 20001, and extracts the natural language text information stored as the main message of the response and the non-natural language information source such as the image, video, or audio. Based on the natural language text information extracted from the above-described response, the character operation program of the character conversation apparatus (artificial intelligence response output apparatus 10010) may generate natural language audio that serves as a response to the user using the audio synthesis technique, and may output it from the audio output unit 1140 which is the speaker, so that it sounds as if it is the voice of the character 19051 displayed on the display screen.

In addition, based on the natural language text information extracted from the above-described response, the character operation program of the character conversation apparatus (artificial intelligence response output apparatus 10010) may display natural language words which is the response to the user on the display screen of the character conversation apparatus (artificial intelligence response output apparatus 10010). At this time, the words may be displayed with the character 19051, or may be displayed overlapping the image of the character 19051, or may be displayed instead of the image of the character 19051. Such a specific processing may be executed by the image controller 1160.

In addition, based on the information of the image of the non-natural language information source extracted from the above-described response, the character operation program of the character conversation apparatus (artificial intelligence response output apparatus 10010) may display the image on the display screen of the character conversation apparatus (artificial intelligence response output apparatus 10010) for the user. At this time, the image may be displayed with the character 19051, or may be displayed overlapping the image of the character 19051, or may be displayed instead of the image of the character 19051. Such a specific processing may be executed by the image controller 1160.

In addition, based on the information of the video of the non-natural language information source extracted from the above-described response, the character operation program of the character conversation apparatus (artificial intelligence response output apparatus 10010) may display the video on the display screen of the character conversation apparatus (artificial intelligence response output apparatus 10010) for the user. At this time, the video may be displayed with the character 19051, or may be displayed overlapping the image of the character 19051, or may be displayed instead of the image of the character 19051. Such a specific processing may be executed by the image controller 1160.

In addition, the character operation program of the character conversation apparatus (artificial intelligence response output apparatus 10010) may output the audio generated based on the information of the audio of the non-natural language information source extracted from the above-described response to the audio output unit 1140 which is the speaker.

According to the character conversation apparatus (artificial intelligence response output apparatus 10010) or the character conversation system including the character conversation apparatus (artificial intelligence response output apparatus 10010) and the large language model server 20001 described above with reference to FIG. 3C, there is no need to install the large language model, which requires vast amounts of data and computational resources for learning, in the character conversation apparatus (artificial intelligence response output apparatus 10010) itself. Moreover, it is possible to utilize advanced natural language processing and non-natural language information processing capabilities of the multimodal large language model via the API. In addition to the response based on the natural language text, a response based on the non-natural language information source can be provided in response to the action of the user toward the character, allowing a more suitable conversation.

Next, an example of the operation of the character conversation apparatus (artificial intelligence response output apparatus 10010) according to the third embodiment of the present invention will be described with reference to FIG. 3D. This is also a description of an example of the operation of the character conversation system including the artificial intelligence response output apparatus 10010 and the large language model server 20001. Specifically, FIG. 3D shows examples of the natural language text of the main message of the prompt sent from the character conversation apparatus (artificial intelligence response output apparatus 10010) to the large language model server 20001 and the non-natural language information source such as the image, and the natural language text of the main message of the server response which is the response to the prompt and the non-natural language information source such as the image. In the present embodiment, the non-natural language information source can use an image, video, audio, or the like. FIG. 3D shows an example of an image as the non-natural language information source.

In addition, FIG. 3D shows the setting prompt and exchange of prompts and responses in chronological order from the first round of user prompt to the second round of user prompt and corresponding responses. Here, the prompts and responses shown in FIG. 3D include a non-natural language information source 20061 and a non-natural language information source 20062 that were not shown in FIG. 2D for the second embodiment. In the example of FIG. 3D, the non-natural language information source 20061 and the non-natural language information source 20062 are both images.

In FIG. 3D, the image of the non-natural language information source 20061 is shown embedded in the prompt for simplicity. However, there are a plurality of methods for transmitting or specifying data from the non-natural language information source 20061 in the prompt sent from the character conversation apparatus (artificial intelligence response output apparatus 10010) to the large language model server 20001. The character conversation apparatus (artificial intelligence response output apparatus 10010) may use any one of the plurality of methods or switch between them as appropriate. Hereinafter, an example of each method will be described.

A first method for transmitting of specifying the non-natural language information source data in the prompt is used, for example, when the non-natural language information source to be specified is located on a server or the like connected to a network such as the Internet. A specific method of the first method is for specifying a non-natural language information source file on the network such as the Internet using information such as tags or symbols in the prompt by specifying a location information (such as URL) of and file name of the non-natural language information source file.

For example, using the tag <img src=“****”> which specifies an image in the markup language, the image on the network such as the Internet may be specified by entering the location information and file name information of the image file in the “****” portion. In addition, using the tag <video src=“****”> which specifies a video in the markup language, the video on the network such as the Internet may be specified by entering the location information and file name information of the video file in the “****” portion. In addition, using the tag <audio src=“****”> which specifies audio in the markup language, the audio on the network such as the Internet may be specified by entering the location information and file name information of the audio file in the “****” portion. In addition, in a case where the JSON format is used, a key such as “img_src” is made available, and the image on the network such as the Internet may be specified by entering the location information and file name information of the image file in a respective value. The key and the value may be respectively prepared for the video file or audio file. The specific format example provided is merely an example, and other custom formats may be used. In any case, the information specifying the location information and file name information of the non-natural language information source file may be stored in the prompt.

As in the first method, in a case where the information specifying the location information and file name information of the non-natural language information source file is stored in the prompt, there is no need to store data of the non-natural language information source file in the prompt itself. Therefore, the amount of data in the prompt can be reduced. In the first method, the large language model server 20001 receiving the prompt specified by the non-natural language information source data may use the location information and file name information of the non-natural language information source file stored in the prompt to acquire the non-natural language information source file located on the server or the like connected to the network such as the Internet.

Here, the method in which the character conversation apparatus (artificial intelligence response output apparatus 10010) inputs the location information and file name information in a case where the non-natural language information source data in the prompt is specified in the first method will be described. In FIG. 3C and according to the present embodiment, the types of actions that can be performed by the user 230 on the character conversation apparatus (artificial intelligence response output apparatus 10010) have increased compared to the second embodiment, in addition to the voice of the user 230. Therefore, for example, the user 230 may input the location information such as the URL for specifying the non-natural language information source data or the file name information by the user operation (such as the mouse, keyboard, touch panel) via the operation input unit 1107 of FIG. 1B.

In addition, in the character conversation apparatus (artificial intelligence response output apparatus 10010), the controller 1110 may cooperate with the memory 1109 and execute a WEB browser program to display a GUI of the WEB browser program on the display screen of the character conversation apparatus (artificial intelligence response output apparatus 10010). The user operation for the GUI of the WEB browser program may be received by the user's touch operation that can be detected by the user operation via the operation input unit 1107 (such as a mouse, keyboard, or touch panel) or the touch operation input sensor of the display 10011, and the non-natural language information source data such as the image, video, or audio selected in a browser screen of the WEB browser program may be set as data to be specified in the prompt. In this case, the WEB browser program may acquire the location information and file name information of the non-natural language information source data and carry it over to the character operation program.

In addition, the user 230 may operate the mobile information processing terminal 20010 to perform a communication with the character conversation apparatus (artificial intelligence response output apparatus 10010) from the mobile information processing terminal 20010 to input the location information such as the URL for specifying the non-natural language information source data to the character conversation apparatus (artificial intelligence response output apparatus 10010). In addition, the information storage image such as the two-dimensional code may be displayed on the display panel 20011 of the mobile information processing terminal 20010 as described with reference to FIG. 3C to perform the image recognition processing on the image captured by the imager 1180 of the character conversation apparatus (artificial intelligence response output apparatus 10010) and to input the location information such as the URL and file name information for specifying the non-natural language information source data by acquiring the result of the image recognition processing.

Note that using the first method for transmitting or specifying the non-natural language information source data in the prompt is not limited to cases in which the non-natural language information source file is stored in advance on the server or the like connected to the network such as the Internet. For example, in a case where the non-natural language information source data such as the image, video, or audio stored in the storage 1170 of the character conversation apparatus (artificial intelligence response output apparatus 10010) is to be included in the prompt, the character conversation apparatus (artificial intelligence response output apparatus 10010) may upload the non-natural language information source data to the second server 19002 via the Internet 19000, and the prompt may include the location information on the Internet (such as the URL) and file name of the non-natural language information source data uploaded to the second server 19002. In this case, the second server 19002 functions as a so-called intermediate server.

Likewise, in a case where the non-natural language information source data such as the image, video, or audio stored in the storage 20016 of the mobile information processing terminal 20010 is to be included in the prompt, the mobile information processing terminal 20010 may upload the non-natural language information source data to the second server 19002 via the Internet 19000. The mobile information processing terminal 20010 or the second server 19002 may send the location information on the Internet (such as the URL) and file name of the non-natural language information source data from the second server 19002 to the character conversation apparatus (artificial intelligence response output apparatus 10010), and the location information on the Internet (such as the URL) and file name of the non-natural language information source data acquired by the character operation program of the character conversation apparatus (artificial intelligence response output apparatus 10010) and uploaded to the second server 19002 may be included in the prompt.

Further, the character operation program of the character conversation apparatus (artificial intelligence response output apparatus 10010) may construct a media server in the character conversation apparatus (artificial intelligence response output apparatus 10010) that can cooperate with the memory 1109 and the storage 1170 and can be accessed from other servers via the Internet 19000. In this case, in a case where the non-natural language information source data in the prompt is specified in the first method, the character conversation apparatus (artificial intelligence response output apparatus 10010) may store, in the prompt, the location information on the Internet (such as the URL) indicating the media server constructed in the character conversation apparatus (artificial intelligence response output apparatus 10010) itself and the file name of the corresponding non-natural language information source data.

Next, a second method for specifying the transmission or specifying of the non-natural language information source data in the prompt is, for example, a method in which the non-natural language information source data itself is simply stored in (attached to) the prompt. Generally, the non-natural language information source data such as the image, video, or audio has a larger data volume than the text information which is natural language. Therefore, in this case, the data volume of the prompt itself becomes larger than in the first method. The character operation program of the character conversation apparatus (artificial intelligence response output apparatus 10010) temporarily stores the non-natural language information source data to be stored in (attached to) the prompt in the memory 1109, and when sending the prompt, may store (attach) the data in the prompt and output the data from the memory 1109 to the large language model server 20001 via the communication unit 1132. The non-natural language information source data itself stored in the memory 1109 by the character operation program of the character conversation apparatus (artificial intelligence response output apparatus 10010) may be acquired by the communication unit 1132 via the Internet 19000, may be acquired from the mobile information processing terminal 20010 by the communication unit 1132, or may be read from the storage 1170 and stored in the memory 1109.

The above-described method makes it possible for the character conversation apparatus (artificial intelligence response output apparatus 10010) to transmit or specify the non-natural language information source data by the prompt.

The large language model server 20001 is the multimodal large language model that can process the non-natural language information source together with the natural language text information, and thus, as shown in the example of FIG. 3D, based on the first round of user prompt, the server acquires the image including the swimming pool and the poolside which is the non-natural language information source 20061 and the text information which is natural language and outputs the text information which is natural language as the inference result in response to the first round of user prompt as shown in FIG. 3D.

In addition, the large language model server 20001 is the multimodal large language model that can process the non-natural language information source together with the natural language text information, and thus, as shown in the example of FIG. 3D, based on the response to the second round of user prompt, the large language model server 20001 can include the non-natural language information source 20062 generated by inference of the multimodal large language model in the response and send it to the character conversation apparatus (artificial intelligence response output apparatus 10010). FIG. 3D shows an example in which the non-natural language information source 20062 is an image with a circle added to the image of the swimming pool and the poolside which is the non-natural language information source 20061. Note that the non-natural language information source 20062 stored in the response is not limited to the image shown in FIG. 3D and may be any video or audio.

In the method where the non-natural language information source other than the natural language text information is included in the response from the large language model server 20001, a method that conforms to the first method or the second method in which the above-described character conversation apparatus (artificial intelligence response output apparatus 10010) transmits or specifies the non-natural language information source data in the prompt.

Specifically, as a method conforming to the above-described first method, the large language model server 20001 may store the information specifying the location information and file name information of the non-natural language information source file in the prompt as a response. The non-natural language information source 20062 itself such as the image, video, or audio may be held by the large language model server 20001 or may be transferred to the second server 19002 functioning as the intermediate server and be held there. In both cases, the large language model server 20001 may store the information specifying the location information and file name information of the non-natural language information source file in the prompt as a response. The character conversation apparatus (artificial intelligence response output apparatus 10010) that has acquired the response may access the large language model server 20001 or the second server 19002 using the location information and file name information of the non-natural language information source file in the prompt to acquire the non-natural language information source 20062.

In addition, specifically, as a method conforming to the above-described second method, the large language model server 20001 may store (attach) file data itself of the non-natural language information source 20062 and send it to the character conversation apparatus (artificial intelligence response output apparatus 10010) as a response. The character conversation apparatus (artificial intelligence response output apparatus 10010) can acquire the data of the non-natural language information source 20062 stored in (attached to) the prompt to use it for various outputs to the user 230.

As described above with reference to FIG. 3D, according to the character conversation apparatus (artificial intelligence response output apparatus 10010) and the operation of the character conversation system according to the third embodiment, an exchange of prompts and responses for achieving a conversation using the image, video, or audio which is the non-natural language information is performed between the character displayed on the character conversation apparatus (artificial intelligence response output apparatus 10010) and the user 230. In this manner, it is possible to achieve a more advanced and natural conversation as shown in the messages of FIG. 3D.

Next, an example of the operation of the character conversation apparatus (artificial intelligence response output apparatus 10010) according to the third embodiment of the present invention will be described with reference to FIG. 3E. This is also a description of an example of the operation of the character conversation system including the artificial intelligence response output apparatus 10010 and the large language model server 20001. Specifically, FIG. 3E shows examples of the main message of the prompt sent from the artificial intelligence response output apparatus 10010 to the large language model server 20001 and the main message of the server response which is the response to the prompt. This becomes the basis of the conversation between the user 230 and the character 19051 displayed on the artificial intelligence response output apparatus 10010.

FIG. 3E shows an example of a new conversation in which the user 230 speaks to the character 19051 again after the continuation of a series of conversations shown in FIG. 3D has ended. In the example of FIG. 3E, processing using the conversation history as described for the second embodiment with reference to FIGS. 2F, 2G, and 2I is not performed. Therefore, as in FIG. 2E of the second embodiment, FIG. 3E shows responses that do not contain contents such as the name of the large language model itself, the role it should play, conversation characteristics, the user's name, the conversation history, and the like in the setting prompt.

Next, an example of the operation of the character conversation apparatus (artificial intelligence response output apparatus 10010) according to the third embodiment of the present invention will be described with reference to FIG. 3F. This is also a description of an example of the operation of the character conversation system including the artificial intelligence response output apparatus 10010 and the large language model server 20001. Specifically, FIG. 3F shows examples of the main message of the prompt sent from the artificial intelligence response output apparatus 10010 to the large language model server 20001 and the main message of the server response which is the response to the prompt. This becomes the basis of the conversation between the user 230 and the character 19051 displayed on the artificial intelligence response output apparatus 10010.

FIG. 3F shows an example of a new conversation in which the user 230 speaks to the character 19051 again after the continuation of a series of conversations shown in FIG. 3D has ended. FIG. 3F is an example in which the method for storing a message that describes the history of past conversations in the setting prompt as described for the second embodiment with reference to FIG. 2F is applied to the character conversation apparatus (artificial intelligence response output apparatus 10010) according to the third embodiment. Specifically, in FIG. 3F, the message shown in FIG. 3D which is content of the setting prompt is stored as a re-setting message, and following the re-setting message, the message that describes the history of past conversations is stored as the conversation history message.

The large language model server 20001 according to the third embodiment is the multimodal large language that can process the non-natural language information source together with the natural language text information, and thus, there may be a case where transmitting or specifying of the non-natural language information source data has been performed in the past prompts and responses. Therefore, in the example of FIG. 3F, the conversation history message reflects not only the natural language text information from the past prompts and responses but also the transmitting or specifying of the non-natural language information source data of the past prompts and responses. The specific method for transmitting or specifying the non-natural language information source data in the prompt of FIG. 3F is the same as that of FIG. 3D, and thus, redundant descriptions thereof are omitted as appropriate.

In the example of FIG. 3D, the method for transmitting or specifying the non-natural language information source data includes a case where the non-natural language information source data itself is stored in (attached to) the prompt and a case where the non-natural language information source data is not stored in (attached to) the prompt. In this regard, the same can be applied to the prompt of FIG. 3F.

Next, an example of the operation of the character conversation apparatus (artificial intelligence response output apparatus 10010) according to the third embodiment of the present invention will be described with reference to FIG. 3G. This is also a description of an example of the operation of the character conversation system including the artificial intelligence response output apparatus 10010 and the large language model server 20001. Specifically, FIG. 3G shows examples of the main message of the prompt sent from the artificial intelligence response output apparatus 10010 to the large language model server 20001 and the main message of the server response which is the response to the prompt. This becomes the basis of the conversation between the user 230 and the character 19051 displayed on the artificial intelligence response output apparatus 10010.

FIG. 3G shows an example of a series of conversations shown in FIG. 3F, from the first round of user prompt and response following the first setting prompt to the third round of user prompt and its response. In FIG. 3G, the exchange of prompts and responses is shown in chronological order. Contents of the setting prompt are the same as those shown in FIG. 3F, and thus, redundant descriptions thereof are omitted as appropriate.

As described above, in a case where the large language model server 20001 having the multimodal large language model that can process the non-natural language information source together with the natural language text information according to the third embodiment, or in a case where a new conversation in which the user 230 speaks to the character 19051 again after the continuation of a series of conversations has ended takes place, performing the generation processing and transmission processing on the setting prompt of FIG. 3F allows the response following the user prompt to reflect the settings such as the character's role, name, conversation characteristics, personality, and/or conversation characteristics from the prior conversation and the conversation history as shown in FIG. 3G. In this manner, from the perspective of the user, the consistency of the settings such as the character's role, name, conversation characteristics, or personality and memories from the prior conversations is more effectively ensured, making it more suitable.

Next, an example of the operation of the character conversation apparatus (artificial intelligence response output apparatus 10010) according to the third embodiment of the present invention will be described with reference to FIG. 3H. This is also a description of an example of the operation of the character conversation system including the artificial intelligence response output apparatus 10010 and the large language model server 20001. Specifically, FIG. 3H is an explanatory diagram of a database 20200 for managing the character settings and the conversation history of the characters regarding the plurality of characters to be displayed on the display 10011 of the character conversation apparatus (artificial intelligence response output apparatus 10010). In FIG. 3H, the settings and the like displayed on the display 10011 of the character conversation apparatus (artificial intelligence response output apparatus 10010) for the plurality of characters uses the example of the second embodiment described with reference to FIG. 2H. Therefore, redundant descriptions of the settings and the like for the plurality of characters are omitted as appropriate.

In addition, the database 20200 for managing the character settings and the conversation history of the characters shown in FIG. 3H uses a similar format as the database 19200 of the second embodiment shown in FIG. 2I, and thus, only differences from the database 19200 shown in FIG. 2I will be described for FIG. 3H. In addition, only content regarding the character “Koto” in the database will be described, and descriptions of the content of other characters are omitted as appropriate.

Here, as described above, the large language model server 20001 according to the third embodiment is the multimodal large language model that can process the non-natural language information source together with the natural language text information, and thus, the prompt from the character conversation apparatus (artificial intelligence response output apparatus 10010) and the response from the large language model server 20001 includes the natural language text information and the transmitting or specifying of the non-natural language information source data. Therefore, in the database 20200 shown in FIG. 3H, the natural language text information in these prompts and responses, and the information on the transmitting or specifying of the non-natural language information source data are recorded in the data of the conversation history. The specific method for transmitting or specifying the non-natural language information source data in the recording of the conversation history is the same as that of FIG. 3D, and thus, redundant descriptions thereof are omitted as appropriate.

In the example of FIG. 3D, the method for transmitting or specifying the non-natural language information source data includes a case where the non-natural language information source data itself is stored in (attached to) the prompt and a case where the non-natural language information source data is not stored in (attached to) the prompt. In this regard, the same can be applied to the conversation history of FIG. 3H. However, in the conversation history of FIG. 3H, in a case where the location information and file name information of the non-natural language information source file in the server (the second server 19002 functioning as the intermediate server or other cloud servers) on the network such as the Internet is specified as the method for specifying the non-natural language information source data, it is possible for the non-natural language information source file to be deleted from the server if the period of the conversation history becomes lengthy. In such a case, it may no longer be possible to acquire the non-natural language information source file at a later date even if the location information and file name information, causing a loss of conversation record information.

To prevent this, when converting the message of the prompt and response to store it in the conversation history, the character conversation apparatus (artificial intelligence response output apparatus 10010) may acquire the non-natural language information source file itself specified in the prompt and response from the server or the like on the network using the location information and file name information and store it in the storage 1170. Further, the location information and file name of the non-natural language information source file may be replaced with the location information on the Internet (such as the URL) indicating the media server among the media servers constructed by the character operation program of the character conversation apparatus (artificial intelligence response output apparatus 10010) in the character conversation apparatus (artificial intelligence response output apparatus 10010), and this may be recorded in the conversation record. This makes it possible to as long as the character conversation apparatus (artificial intelligence response output apparatus 10010) itself does not delete the non-natural language information source file from the storage 1170, the loss of the conversation record information from the non-natural language information source can be prevented, making it more suitable for preserving the conversation record.

From the perspective of the user, in a case where the character conversation apparatus (artificial intelligence response output apparatus 10010) is configured to switch from the character displayed on the display 10011 to another character among the plurality of character candidates, using the database described above with reference to FIG. 3H allows the user to feel less uncomfortable during the conversation with each character, share memories with the plurality of characters, and achieve a more enjoyable character conversation experience as in the effect of the second embodiment described with reference to FIG. 2I. This effect can be achieved even in a case where the large language model server 20001 is the multimodal large language model that can process the non-natural language information source together with the natural language text information.

Note that, in the character conversation apparatus (artificial intelligence response output apparatus 10010) and the character conversation system according to the third embodiment, the multimodal large language model artificial intelligence that can process the non-natural language information together with the natural language text information is used in the large language model server 20001.

Here, communication between the character conversation apparatus (artificial intelligence response output apparatus 10010) and the large language model server 20001 is performed using the API. In the multimodal large language model, the API usage fees may be charged based on the data volume of the non-natural language information source in addition to the natural language text information including the number of tokens which is the processing amount of word units that make up a sentence.

Thus, the following modifications can be used in order to provide a less costly character conversation service according to the character conversation system according to the present embodiment to the user.

In the first modification, when the conversation history is recorded in the database of FIG. 3H, information regarding the transmitting or specifying of the non-natural language information source data is also recorded. However, the character and the user exchange conversations regarding the non-natural language information source data in the form of natural language text information, and the content is recorded as natural language text information. Therefore, when recording the conversation history in the database of FIG. 3H, even if the recording of the information regarding the transmitting or specifying of the non-natural language information source data is omitted, the conversation itself regarding the non-natural language information source data is recorded to some extent as natural language text information. Therefore, if a certain degree of information loss is acceptable, recording of the information regarding the transmitting or specifying of the non-natural language information source data can be omitted when recording the conversation history in the database of FIG. 3H. In this case, the information regarding the transmitting or specifying of the non-natural language information source data is also omitted from the conversation history message of the setting prompt of FIG. 3F. In this manner, the amount of data in the non-natural language information source communicated using the API can be reduced.

Next, in the second modification, when the conversation history is recorded in the database of FIG. 3H, instead of recording the information regarding the transmitting or specifying of the non-natural language information source data, the natural language text information indicating the content of the non-natural language information source data is recorded. The natural language text information indicating the content of the non-natural language information source data may be acquired by, for example, initiating a conversation between the large language model of the large language model server 20001 and the character conversation apparatus (artificial intelligence response output apparatus 10010) as a separate conversation with the character, and having the large language model server 20001 specify and describe the content of the non-natural language information source data within a predetermined word limit. In addition, engaging in conversation with other large language models on other servers that are less costly to use than the large language model of the large language model server 20001 makes it possible to acquire the content of the non-natural language information source data by specifying and describing the content within the predetermined word limit. In addition, in a case where alternative text data is available at the time of acquisition of the non-natural language information source data, the alternative text data may be the natural language text information indicating the content of the non-natural language information source data. Specific examples of the alternative text data of the non-natural language information source data include the text information indicated by “****” in the tags of the markup language such as <img src=” “alt=“****”>, <video src=” “alt=“****”>, and <audio src=” “alt=“****”>.

In addition, in a case where the JSON format is used, for an object that stores the location information and file name information of the non-natural language information source data which are keys and values indicating the location information of the non-natural language information source data, it is sufficient to store a key corresponding to the alternative text and a value linked with the alternative text data itself.

In this case also, when the conversation history is recorded in the database of FIG. 3H, recording of the information regarding the transmitting or specifying of the non-natural language information source data can be omitted, and the information regarding the transmitting or specifying of the non-natural language information source data can be omitted from the conversation history message of the setting prompt of FIG. 3F. In this manner, the amount of data in the non-natural language information source communicated using the API can be reduced.

Next, in a third modification, at the time of the first round of user prompt of FIG. 3D, the information regarding the transmitting or specifying of the non-natural language information source data is not stored in user prompt, and is replaced with the natural language text information indicating the content of the non-natural language information source data. For example, in the first round of user prompt of FIG. 3D, the information regarding the transmitting or specifying of the non-natural language information source data 20061 is replaced with the user prompt “The image is of a swimming pool with a chair and a parasol on the poolside. The swimming pool is filled with water. There is a drink on the table next to the chair”. This description may be stored as the natural language text information. At this time, the description may be acquired by having other large language models of other servers that are less costly to use than the large language model of the large language model server 20001 specify and describe the content of the non-natural language information source data within the predetermined word limit. In addition, the description may be acquired from other servers of various services that can acquire an overview or description of the non-natural language information source data such as the image, video, or audio. In addition, in a case where alternative text data is available at the time of acquisition of the non-natural language information source data, the alternative text data may be the natural language text information indicating the content of the non-natural language information source data.

Next, a display example of the character conversation apparatus (artificial intelligence response output apparatus 10010) according to the third embodiment of the present invention will be described with reference to FIG. 3I. In the example of FIG. 3I, the response from the large language model for the prompt from the user described with reference to the drawings of FIGS. 3A to 3H is displayed on the display 10011 of the character conversation apparatus (artificial intelligence response output apparatus 10010). Specifically, FIG. 3I is an example in which the text 10063 of the natural language information source data which is the response from the large language model, the image 10064 of the non-natural language information source data, and/or the video 10065 of the non-natural language information source data are displayed on the display 10011 together with the image of the character 19051. The text 10063 which is the response from the large language model, the image 10064, and/or the video 10065 may be displayed overlapping the image of the character 19051 as shown in FIG. 3I.

In addition, the text 10063 which is the response from the large language model, the image 10064, and/or the video 10065 may be displayed together with the image of the character 19051 without overlapping the image of the character 19051. The display of FIG. 3I is merely an example. For example, in a case where the user 230 adjusts the volume of the audio output of the audio output unit 1140 of the character conversation apparatus (artificial intelligence response output apparatus 10010) to its minimum or sets the audio output to OFF by operating the operation input unit 1107 or the touch operation input sensor of the display 10011, the user 230 will no longer be able to hear the response from the large language model. Thus, in this case, the controller 1110 may control a display mode to start displaying the text 10063 which is the response from the large language model, the image 10064, and/or the video 10065 together with the image of the character 19051 as shown in FIG. 3I.

This makes it possible for the user 230 to use the character conversation apparatus (artificial intelligence response output apparatus 10010) when the user wishes to suppress the audio output. Note that a configuration may be provided in which the user 230 can manually switch the ON/OFF of the display mode that displays the text 10063 which is the response from the large language model, the image 10064, and/or the video 10065 together with the image of the character 19051 by the operation via the operation input unit 1107 or the touch operation input sensor of the display 10011. According to the display example of FIG. 3I, in the multimodal character conversation apparatus (artificial intelligence response output apparatus 10010), it is possible to output a more suitable response from the large language model.

According to the above-described character conversation apparatus and character conversation system according to the third embodiment, in addition to the effects of the character conversation apparatus and character conversation system according to the second embodiment, a more advanced conversation experience including the information regarding the natural language and non-natural language can be provided to the user using the multimodal large language model. In addition, according to the character conversation apparatus and the character conversation system according to the third embodiment, a less costly character conversation service can be provided to the user.

Note that, in the third embodiment, an example of using the large language model of the large language model server 20001 as the large language model has been described. Alternatively, the character conversation apparatus (artificial intelligence response output apparatus 10010) may comprise the local LLM processor 10028 shown in FIG. 1B and may use the multimodal large language model of the local LLM processor 10028. In this case, the multimodal large language model of the local LLM processor 10028 may be used instead of the multimodal large language model of the large language model server 20001.

In this case, in the above description, the multimodal large language model of the large language model server 20001 according to the third embodiment may be replaced with the multimodal large language model of the local LLM processor 10028 of the character conversation apparatus (artificial intelligence response output apparatus 10010). In this case also, a more advanced conversation experience including the information of the natural language and non-natural language can be provided to the user using the multimodal large language model. Note that, in a case where the multimodal large language model of the local LLM processor 10028 is used instead of the multimodal large language model of the large language model server 20001, there is less need to consider the usage fees based on the number of processing tokens and the data volume of the non-natural language information source. However, even when using the multimodal large language model of the local LLM processor 10028, reducing the number of processing tokens and the data volume of the non-natural language information source can reduce the consumption of resources such as power required for inference. In this case, the character conversation service that consumes less power can be provided to the user.

Note that the configuration of the second embodiment in which the conversation history with the character and data from the database including the conversation history with the character is uploaded and downloaded to and from the second server 19002 or other cloud servers can be applied to example of the third embodiment that uses the multimodal large language model. In this case also, when conversations with one character or a plurality of characters are to take place across different apparatuses, at different timings multiple times, it is possible to achieve conversations with the characters with the memory of each character being virtually carried over from the previous conversation, making it more suitable for the user.

### Fourth Embodiment

Next, a fourth embodiment of the present invention is a modified version of the artificial intelligence response output apparatus 10010, the character conversation apparatus, or systems thereof according to the second embodiment or the third embodiment described with reference to the drawings. In the present embodiment, only differences from the second embodiment or the third embodiment will be described, and descriptions of configurations similar to those of the embodiments will be omitted as appropriate.

As in the above-described embodiments, the artificial intelligence response output apparatus 10010 may also be referred to as an artificial intelligence response output apparatus, an AI assistant apparatus, an AI assistant display apparatus, or an artificial intelligence interface apparatus. The system including the artificial intelligence response output apparatus 10010 and the large language model server may also be referred to as an artificial intelligence response output system, an AI assistant system, an AI assistant display system, or an artificial intelligence interface system.

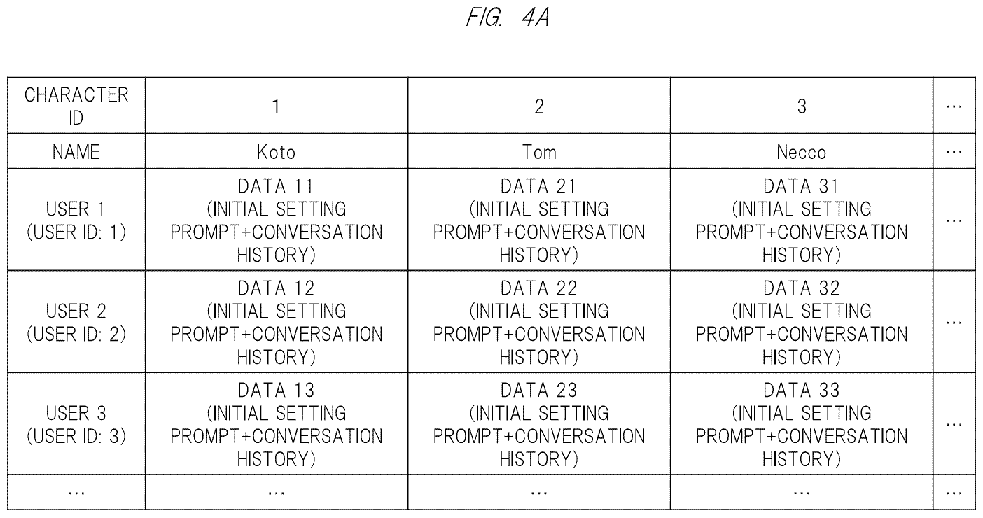

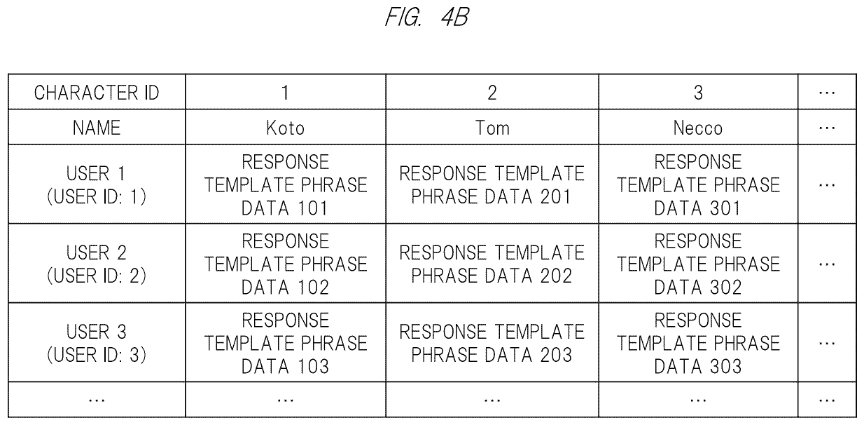

An example of the operation using the database in the character conversation apparatus (artificial intelligence response output apparatus 10010) according to the fourth embodiment of the present invention will be described with reference to FIG. 4A. The database according to the fourth embodiment shown in FIG. 4A is an extension of the database described with reference to FIG. 2I or 3I. Specifically, the database shown in FIG. 4A is designed for a case where multiple users use the same character conversation apparatus (artificial intelligence response output apparatus 10010) or the same character conversation system, and the initial setting prompt and conversation history corresponding to each user and character is stored in the database.

In the example of FIG. 4A, for User 1 whose user ID is 1, the initial setting prompt and conversation history is stored for each character: character Koto whose character ID is 1, character Tom whose character is ID 2, and character Necco whose character ID is 3. In addition, for User 2 whose user ID is 2 and User 3 whose user ID is 3, the initial setting prompt and conversation history is stored for each character: character Koto whose character ID is 1, character Tom whose character is ID 2, and character Necco whose character ID is 3.

Data of these initial setting prompts and conversation histories are stored as separate data in different areas for each combination of user and character. In FIG. 4A, for explanatory purposes, the data stored in each area is indicated as Data 11, 12, 13, 21, 22, 23, 31, 32, or 33. The controller 1110 of the character conversation apparatus (artificial intelligence response output apparatus 10010) uses the initial setting prompts and conversation histories stored in different areas for each combination of user and character based on the user currently using (logged into) the character conversation apparatus (artificial intelligence response output apparatus 10010) or its system to maintain the consistency of the character's personality and continuity of its memory in a manner more suitable for each user.

Specifically, consider a situation where User 1 is conversing with character Tom using the character conversation apparatus (artificial intelligence response output apparatus 10010), and User 2 is unaware of that conversation and starts a conversation with character Tom. At this time, if the artificial intelligence response output apparatus 10010 uses the initial setting prompt or the conversation history database that does not identify the user, the response output generated by the artificial intelligence response output apparatus 10010 would be based on conversation history that User 2 has no memory of, and the conversation between User 2 and the character of the artificial intelligence response output apparatus 10010 would contain inconsistencies.

Alternatively, even under a similar situation, by using the database shown in FIG. 4A, the controller 1110 of the character conversation apparatus (artificial intelligence response output apparatus 10010) identifies the user by ID, stores the initial setting prompt and conversation history in different areas for each user, and uses the initial setting prompt and conversation history stored in different areas for each user to generate an artificial intelligence response. In this manner, the initial setting prompt and conversation history used to generate the artificial intelligence response for each user are based on the user's operation or conversation and are managed separately from those of other users. In this manner, a more consistent conversation history between each user and each character of the artificial intelligence response output apparatus 10010 can be achieved.

Note that the database for the initial setting prompt and/or conversation history described with reference to FIG. 4A may be stored in the storage 1170 of the artificial intelligence response output apparatus 10010 and may be used by the controller 1110. In addition, the database for the initial setting prompt and/or conversation history may be stored in the server on the network. For example, in a case where the artificial intelligence response output apparatus 10010 uses the large language model of the large language model server 19001 or the multimodal large language model of the large language model server 20001 when generating the artificial intelligence response, the database for the initial setting prompt and/or conversation history described with reference to FIG. 4A may be stored in the server itself. This makes it possible to omit the processing of including the initial setting prompt and conversation history in the prompt and resending them from the artificial intelligence response output apparatus 10010 to the server and achieve token savings regarding the large language model usage.

In a case where the database for the initial setting prompt and/or conversation history described with reference to FIG. 4A is stored, the user ID, character ID, and the user prompt for subsequent conversations may be sent from the artificial intelligence response output apparatus 10010 to the server. The large language model on the server uses the user ID and character ID acquired from the artificial intelligence response output apparatus 10010, and acquires the corresponding initial setting prompt and conversation history from the database for the initial setting prompt and/or conversation history of FIG. 4A. The large language model on the server may use the initial setting prompt and conversation history and the user prompt for subsequent conversations sent from the artificial intelligence response output apparatus 10010 to execute inference, generate the artificial intelligence response, and send it to the artificial intelligence response output apparatus 1001. This makes it possible to achieve an effect of maintaining the consistency of the character's personality and continuity of its memory in a manner more suitable for each user while achieving token savings regarding the large language model usage.

Next, an example of the operation using the database in the character conversation apparatus (artificial intelligence response output apparatus 10010) according to the fourth embodiment of the present invention will be described with reference to FIG. 4B. The database according to the fourth embodiment shown in FIG. 4B is an extension of the database described with reference to FIG. 1C or 2L. Specifically, the database shown in FIG. 4B is designed for a case where multiple users use the same character conversation apparatus (artificial intelligence response output apparatus 10010) or the same the character conversation system, and data of the response template phrase corresponding to each user and character is stored in the database.

In the example of FIG. 4B, for User 1 whose user ID is 1, response template phrase data is stored for each character: character Koto whose character ID is 1, character Tom whose character is ID 2, and character Necco whose character ID is 3. In addition, for User 2 whose user ID is 2 and User 3 whose user ID is 3, the response template phrase data is stored for each character: character Koto whose character ID is 1, character Tom whose character is ID 2, and character Necco whose character ID is 3.

Data of these response template phrases are stored as separate data in different areas for each combination of user and character. In FIG. 4B, for explanatory purposes, the data stored in each area is indicated as Response Template Phrase Data 101, 102, 103, 201, 202, 203, 301, 302, or 303. For example, Response Template Phrase Data 101 stores the database including a table corresponding to the response template phrases for Conditions 1 to 7 for Character 1 named Koto shown in FIG. 2L. Data 201 of FIG. 4B stores the database including a table corresponding to the response template phrases for Conditions 1 to 7 for Character 2 named Tom shown in FIG. 2L.

Data 301 of FIG. 4B stores the database including a table corresponding to the response template phrases for Conditions 1 to 7 for Character 3 named Necco shown in FIG. 2L. Data 102, 202, and 302 of FIG. 4B use a similar format and are stored with response template phrases changed for User 2. Data 103, 203, and 303 of FIG. 4B use a similar format and are stored with response template phrases changed for User. The controller 1110 of the character conversation apparatus (artificial intelligence response output apparatus 10010) uses the response template phrase data stored in different areas for each combination of user and character based on the user currently using (logged into) the character conversation apparatus (artificial intelligence response output apparatus 10010) or its system.

This makes it possible for the same character to respond with a different response template phrase for each user. That is, even if the same character is used, varying the content of the response template phrase may be more suitable depending on the relationship between the character and the user. For example, depending on the relationship between the age set for the character and the age of the user registered in the artificial intelligence response output apparatus 10010 or system, the user may be older than the character, the same age as the character, or younger than the character. At this time, it is preferable to vary the content of the character's response template phrase for older users, same-age users, and younger users for a more suitable or more natural conversation between the user and the character. That is, performing an operation using the database of FIG. 4B makes it possible to vary the content of the response template phrase in accordance with the relationship between the character and the user and create a more suitable or more natural conversation.

Note that the response template phrase database (response template phrase DB) described above with reference to FIG. 4B is stored in the storage 1170, and the controller 1110 of the artificial intelligence response output apparatus 10010 may use this database. However, the response template phrase database (response template phrase DB) shown in FIG. 4B may be provided on the large language model server 19001 side or the large language model server 20001 side. In this case, the controller of the large language model server 19001 or the controller of the large language model server 20001 may generate a response using the response template phrase database (response template phrase DB). The controller of the large language model server 19001 or the controller of the large language model server 20001 may send the response generated using the response template phrase database (response template phrase DB), instead of the response generated by the large language model stored in each server, to the artificial intelligence response output apparatus 10010. This makes it possible to generate a response using the response template phrase database (response template phrase DB) even if the artificial intelligence response output apparatus 10010 does not have a response template phrase database (response template phrase DB).

According to the above-described character conversation apparatus and character conversation system according to the fourth embodiment, it is possible to create a more suitable or more natural conversation in accordance with the relationship or the conversation history between the character and the user.

### Fifth Embodiment

Next, a fifth embodiment of the present invention is a modified version of the artificial intelligence response output apparatus 10010 or the artificial intelligence response output system of the first embodiment, the second embodiment, and the third embodiment described with reference to the drawings. Specifically, it is an example in which a process is performed where a response generation processing of the artificial intelligence response output apparatus 10010 is switched from the response generation processing of the large language model on the network to the response generation processing by the local large language model of the artificial intelligence response output apparatus 10010 (such as the local LLM processor 10028) or to the response generation processing by the response template phrase database. In the present embodiment, only differences from the above-described embodiments will be described, and descriptions of configurations similar to those of the embodiments will be omitted as appropriate.

As in the above-described embodiments, the artificial intelligence response output apparatus 10010 may also be referred to as an artificial intelligence response output apparatus, a character conversation apparatus, an AI assistant apparatus, an AI assistant display apparatus, or an artificial intelligence interface apparatus. The system including the artificial intelligence response output apparatus 10010 and the large language model server may also be referred to as an artificial intelligence response output system, a character conversation system, an AI assistant system, an AI assistant display system, or an artificial intelligence interface system.

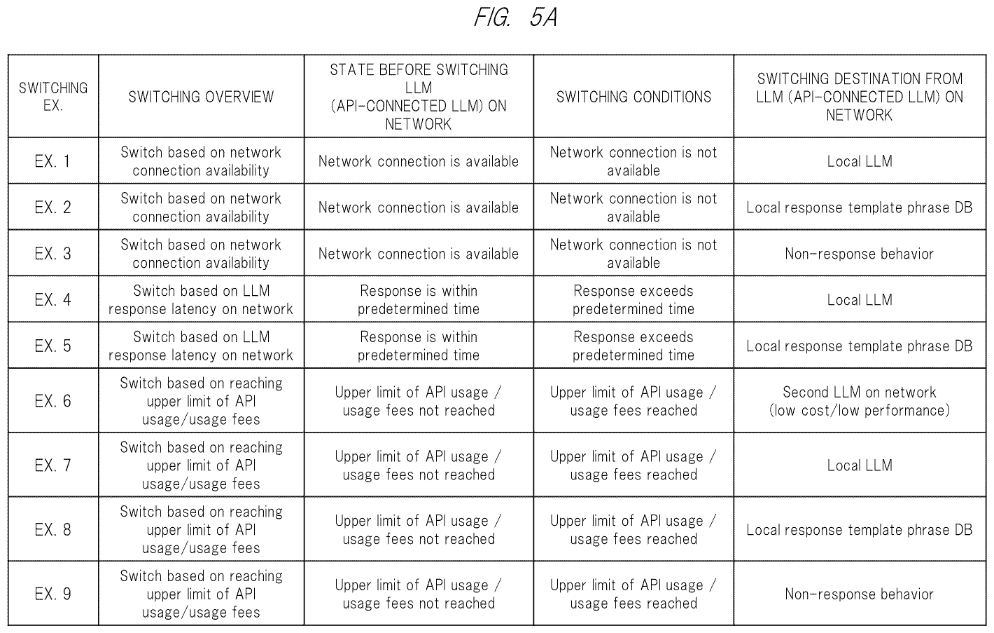

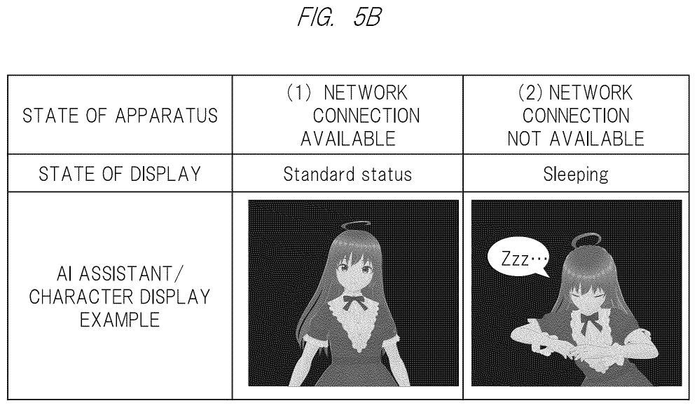

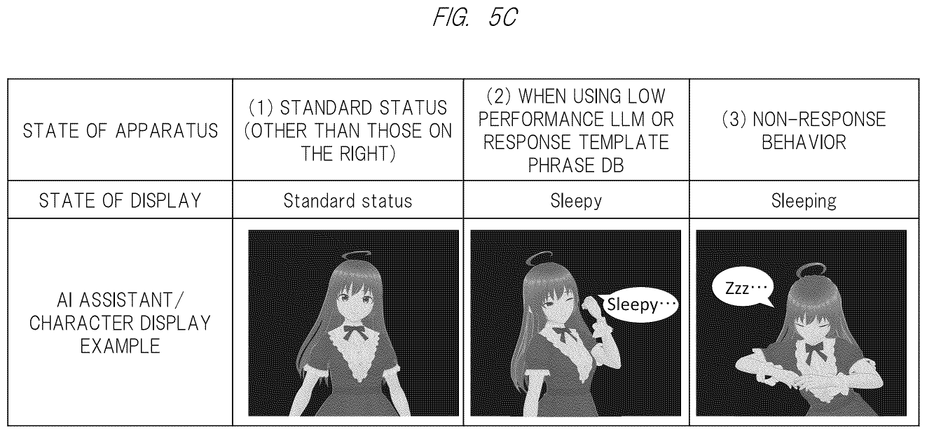

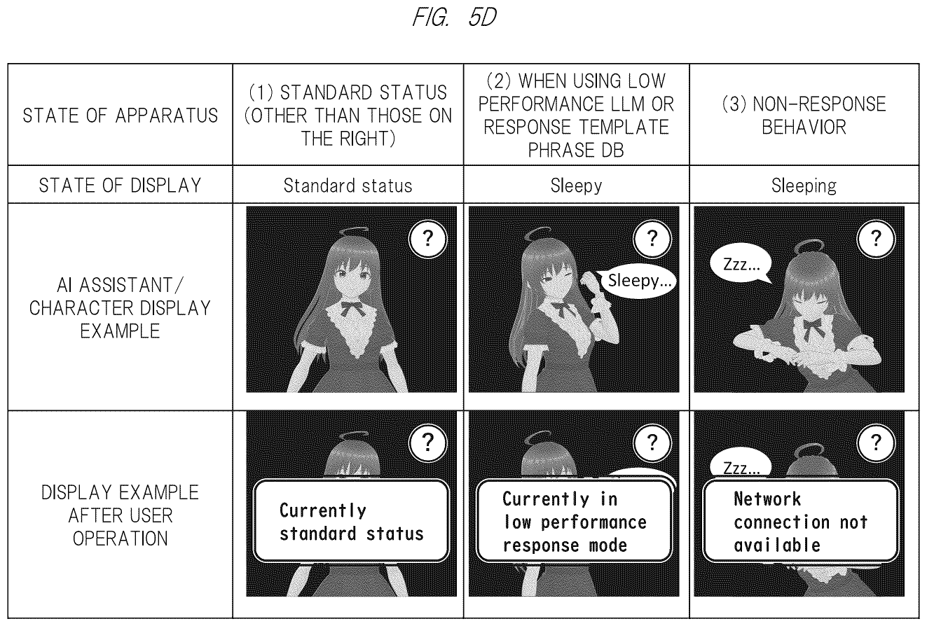

An example of switch processing of the response generation processing in the artificial intelligence response output apparatus 10010 according to the fifth embodiment of the present invention will be described with reference to FIG. 5A. The table of FIG. 5A shows Examples 1 to 9 as examples of the switch processing of the response generation processing in the artificial intelligence response output apparatus 10010. In the table of FIG. 5A, the column “SWITCHING OVERVIEW” shows an overview of the switch processing for each example. The column “STATE BEFORE SWITCHING LLM (API-CONNECTED LLM) ON NETWORK” shows the state before the response generation processing is switched to another response generation processing by the large language model of the large language model server 19001 of FIG. 1 and the large language model on the network (large language model connected using the API) such as the multimodal large language model of the large language model server 20001 for each example. The column “SWITCHING CONDITIONS” shows the condition at which the switch processing of the response generation processing occurs for each example. The column “SWITCHING DESTINATION FROM LLM (API-CONNECTED LLM) ON NETWORK” shows the switching destination to which the response generation processing of the artificial intelligence response output apparatus 10010 is switched from the large language model of the large language model server 19001 and the large language model on the network (large language model connected using the API) such as the multimodal large language model of the large language model server 20001. In a case where the condition shown in “SWITCHING CONDITIONS” of FIG. 5A occurs while in the state shown in “STATE BEFORE SWITCHING LLM (API-CONNECTED LLM) ON NETWORK”, The controller 1110 of the artificial intelligence response output apparatus 10010 may perform controls to switch to the large language model, the database, or the behavior shown in “SWITCHING DESTINATION FROM LLM (API-CONNECTED LLM) ON NETWORK”.

Hereinafter, examples shown in the table of FIG. 5A will be described. As shown in “SWITCHING OVERVIEW”, Example 1 is an example in which switching is performed depending on network connection availability of the artificial intelligence response output apparatus 10010. In Example 1, “STATE BEFORE SWITCHING LLM (API-CONNECTED LLM) ON NETWORK” shows that network connection of the artificial intelligence response output apparatus 10010 is available. Here, in Example 1, “SWITCHING CONDITIONS” shows a case where the network connection is not available. This means that the connection between the artificial intelligence response output apparatus 10010 and the large language model on the network (large language model connected using the API) via the network is not available. Specifically, the connection may not be available when communication in a connection path between the artificial intelligence response output apparatus 10010 to the Internet 19000 is not available. Alternatively, the connection may not be available when communication with the Internet 19000 itself is not available. Alternatively, the connection may not be available when the large language model on the network (large language model connected using the API) itself cannot connect to the Internet 19000. In addition, in Example 1, “SWITCHING DESTINATION FROM LLM (API-CONNECTED LLM) ON NETWORK” shows “Local LLM”. This specifically means that the switch processing to the response generation processing is performed by the local LLM processor 10028 of the artificial intelligence response output apparatus 10010. That is, in Example 1, even if the connection with the large language model on the network (large language model connected using the API) is not available for some reason, and the response generation processing by the large language model on the network (large language model connected using the API) cannot be used, switching to the response generation processing is performed by the local LLM processor 10028 of the artificial intelligence response output apparatus 10010. In this manner, despite differences in performance as large language models, it is possible to continue the response generation processing using the large language model.

Next, Example 2 of FIG. 5A will be described. Example 2 is an example in which “SWITCHING DESTINATION FROM LLM (API-CONNECTED LLM) ON NETWORK” of Example 1 is changed from “Local LLM” to “Response template phrase DB (database)”. The response generation processing by the response template phrase DB (database) is the same as those of FIG. 1C, 2L, or 4B, and thus, redundant descriptions thereof are omitted as appropriate. That is, in Example 2, if the connection with the large language model on the network (large language model connected using the API) is not available for some reason, and the response generation processing by the large language model on the network (large language model connected using the API) cannot be used, switching to the response generation processing using the response template phrase database makes it is possible to generate a response and output the response to the user through simpler processing.

Next, Example 3 of FIG. 5A will be described. Example 3 is an example in which “SWITCHING DESTINATION FROM LLM (API-CONNECTED LLM) ON NETWORK” of Example 1 is changed from “Local LLM” to “Non-response behavior”. Non-response behavior means that, even if the user input by the user requesting a response to the large language model is received via the touch panel, the microphone 1139, or the operation input unit 1107, no response for this input is generated, or a response for this input is not output. That is, in Example 3, it is possible to simplify the processing in a case where the connection with the large language model on the network (large language model connected using the API) is not available for some reason, and the response generation processing by the large language model on the network (large language model connected using the API) cannot be used.

Next, Example 4 of FIG. 5A will be described. As shown in “SWITCHING OVERVIEW”, Example 4 is an example in which switching is performed by response latency of the LLM on the network. In Example 4, “STATE BEFORE SWITCHING LLM (API-CONNECTED LLM) ON NETWORK” shows that the response from the LLM on the network is acquired within a predetermined time. Here, in Example 4, “SWITCHING CONDITIONS” shows a case where the response from the LLM on the network is not acquired within the predetermined time and exceeds the predetermined time. In addition, in Example 4, “SWITCHING DESTINATION FROM LLM (API-CONNECTED LLM) ON NETWORK” shows “Local LLM”. The local LLM of the switching destination is the same as that of Example 1, and thus, redundant descriptions thereof are omitted as appropriate. That is, in Example 4, even if the response from the LLM on the network (large language model connected using the API) exceeds the predetermined time for some reason and the response generation processing by the LLM on the network (large language model connected using the API) cannot be used smoothly, switching to the response generation processing is performed by the local LLM processor 10028 of the artificial intelligence response output apparatus 10010. In this manner, despite differences in performance as large language models, it is possible to continue the response generation processing using the large language model.

Next, Example 5 of FIG. 5A will be described. Example 2 is an example in which “SWITCHING DESTINATION FROM LLM (API-CONNECTED LLM) ON NETWORK” of Example 4 is changed from “Local LLM” to “Response template phrase DB (database)”. The response generation processing by the response template phrase DB (database) is the same as those of FIG. 1C, 2L, or 4B, and thus, redundant descriptions thereof are omitted as appropriate. That is, in Example 5, if the response from the LLM on the network (large language model connected using the API) exceeds the predetermined time for some reason and the response generation processing by the LLM on the network (large language model connected using the API) cannot be used smoothly, switching to the response generation processing is performed using the response template phrase database makes it is possible to generate a response and output the response to the user through simpler processing.

Next, Examples 6 to 9 of FIG. 5A will be described. As shown in “SWITCHING OVERVIEW”, Examples 6 to 9 are examples in which switching is performed depending on whether the upper limit of the API usage or usage fees has been reached. Here, as described in the second embodiment, the provider of the large language model often recovers the costs incurred in the training of the large language model from the user of the terminal as API usage fees. At this time, in the natural language model, the API usage fees may be charged based on the number of tokens which is the processing amount of word units that make up a sentence. Here, various billing methods and restrictions can be considered for API usage fees. One option is to use token processing counts to specify the upper limit of the service of the large language model that the user can receive in a standard status.

In this case, the user can use the service that utilizes the large language model at the predetermined API usage fee until the predetermined usage amount (or corresponding usage fee) is reached. Once the upper limit of the usage amount (or corresponding usage fee) is reached, certain restrictions may apply, such as the inability to receive the service of the large language model in the standard status (performance or frequency).

Examples 6 to 9 of FIG. 5A are examples in which controls to switch the response generation processing are performed by the controller 1110 of the artificial intelligence response output apparatus 10010 when the above-described restrictions are applied in the service of the large language model. Specifically, In Example 6, “STATE BEFORE SWITCHING LLM (API-CONNECTED LLM) ON NETWORK” shows a state where the predetermined upper limit of the API usage or usage fees is not reached. This means that upper limit of the usage of the LLM on the network (API-connected LLM) is not yet reached. At this time, the user can use the LLM on the network (API-connected LLM) in the standard status.

Here, in Example 6, “SWITCHING CONDITIONS” shows a case where the predetermined upper limit of the API usage or API usage fees has been reached. This means that the predetermined upper limit of the usage of the LLM on the network (API-connected LLM) has been reached. In addition, in Example 6, “SWITCHING DESTINATION FROM LLM (API-CONNECTED LLM) ON NETWORK” shows a second LLM on the network that differs from the LLM (also referred to as first LLM) used in the standard status. An example of the second LLM on the network is an LLM that is less costly than the first LLM used in the standard status. As the second LLM is less costly, its performance is likely to be lower than that of the first LLM. However, even in this case, there is still a significant advantage if the second LLM allows for the continued use of the large language model at a lower cost after reaching the upper limit of the usage/usage fees of the first LLM.

Next, Example 7 of FIG. 5A will be described. In Example 7, “SWITCHING DESTINATION FROM LLM (API-CONNECTED LLM) ON NETWORK” has been changed from the second LLM on the network of Example 6 that differs from the LLM (also be referred to as first LLM) used in the standard status to “Local LLM”. In Example 7, even if the predetermined upper limit of the API usage or the API usage fees has been reached, that is, even if the predetermined upper limit of the usage of the LLM on the network (API-connected LLM) has been reached, switching to the response generation processing using the local LLM to which restrictions on the usage of the LLM on the network, the API usage, or the API usage fees does not apply makes it possible to continue with the response generation processing using the large language model.

Next, Example 8 of FIG. 5A will be described. In Example 8, “SWITCHING DESTINATION FROM LLM (API-CONNECTED LLM) ON NETWORK” has been changed from “Local LLM” of Example 7 to “Response template phrase DB (database)”. The response generation processing by the response template phrase DB (database) is the same as those of FIG. 1C, 2L, or 4B, and thus, redundant descriptions thereof are omitted as appropriate. In Example 8, even if the predetermined upper limit of the API usage or the API usage fees has been reached, that is, even if the predetermined upper limit of the usage of the LLM on the network (API-connected LLM) has been reached, switching to the response generation processing using the response template phrase database to which restrictions on the usage of the LLM on the network, the API usage, or the API usage fees does not apply is performed. In this manner, it is possible to generate a response and output the response to the user through simpler processing.

Next, Example 9 of FIG. 5A will be described. In Example 9, “SWITCHING DESTINATION FROM LLM (API-CONNECTED LLM) ON NETWORK” has been changed from “Local LLM” of Example 7 to “Non-response behavior”. Non-response behavior means that no response for the user is generated, or a response for the user is not output. In Example 9, it is possible to simplify the processing in a case where the predetermined upper limit of the API usage or the API usage fees, that is, the predetermined upper limit of the usage of the LLM on the network (API-connected LLM) is reached and the response generation processing by the large language model on the network (large language model connected using the API) cannot be used.

As described above, according to the switching controls of the response generation processing of the artificial intelligence response output apparatus 10010 shown in Examples 1 to 9 of FIG. 5A, even when the response generation processing by the LLM on the network (large language model connected using the API) cannot be used as usual, it is possible to perform switching or response that is more suitable for each situation.

Note that switching controls of Examples 1 to 9 of FIG. 5A may be performed by combining a plurality of examples. For example, the switching controls of Examples 1 to 3 may be combined with any of the controls of Examples 4 to 9. Likewise, the control of Example 4 or 5 may be combined with any of the controls of Examples 1 to 3 or 6 to 9. Likewise, the controls of Examples 6 to 9 may be combined with any of the controls of Examples 1 to 5.

Next, display examples of the AI assistant or character in a case where the artificial intelligence response output apparatus 10010 according to the fifth embodiment is configured as the AI assistant apparatus or character conversation apparatus will be described with reference to FIGS. 5B to 5D.

First, FIG. 5B shows display examples of the AI assistant or character in the artificial intelligence response output apparatus 10010 in a case where the switching control shown in Example 3 of FIG. 5A is performed. In the example of FIG. 5B, a display state of the AI assistant or character is changed depending on the availability state of the network connection of the artificial intelligence response output apparatus 10010. The network availability of the artificial intelligence response output apparatus 10010 is as described with reference to FIG. 5A, and thus, redundant descriptions thereof are omitted as appropriate.

In the example shown in FIG. 5B, the artificial intelligence response output apparatus 10010 displays (1) the AI assistant or character awake in the standard status when the network connection is available, and (2) the AI assistant or character in a “sleeping” state when the network connection is not available. In the switching control of Example 3 of FIG. 5A, when the artificial intelligence response output apparatus 10010 is unable to connect to the network, no response is generated even if the user inputs a prompt, or the response is not output. At this time, the user may feel uncomfortable if the AI assistant or character displayed by the artificial intelligence response output apparatus 10010 is awake in the standard state. However, if the AI assistant or character displayed by the artificial intelligence response output apparatus 10010 is displayed in the sleeping state, the user can understand that “the AI assistant or character is not responding because it is sleeping”, allowing the user to feel less uncomfortable.

Note that, in (2) of FIG. 5B, prior to the user input by the user requesting a response from the large language model via the touch panel, the microphone 1139, or the operation input unit 1107 of the artificial intelligence response output apparatus 10010, it is desirable that the user can understand that “the AI assistant or character is not responding because it is sleeping”. Therefore, in a case where the network connection not available as shown in (2) of FIG. 5B, it is desirable that a timing for starting the state in which the AI assistant or character is displayed in the “sleeping” state is immediately after the point where the controller 1110 of the artificial intelligence response output apparatus 10010 determines that the network connection is not available, but before the user input by the user requesting a response from the large language model.

Next, other display examples will be described with reference to FIG. 5C. The display examples of FIG. 5C are examples in which the display state of the AI assistant or character is changed by the switching control of FIG. 5A depending on the state of “SWITCHING DESTINATION FROM LLM (API-CONNECTED LLM) ON NETWORK” in the table. Specifically, FIG. 5C shows (1) a display example of the AI assistant or character when connection between the artificial intelligence response output apparatus 10010 and the large language model on the network (large language model connected using the API) is available and when the response generation processing by the large language model on the network is available (standard status in the drawing), (2) a display example of the AI assistant or character when the artificial intelligence response output apparatus 10010 has switched to the response generation processing by the LLM or response template phrase database with a lower performance than the large language model on the network (large language model connected using the API), and (3) a display example of the AI assistant or character when the artificial intelligence response output apparatus 10010 is switched to the non-response behavior described with reference to FIG. 5A.

In the example of FIG. 5C, for example, when the artificial intelligence response output apparatus 10010 is in the “standard status” (1), the artificial intelligence response output apparatus 10010 displays the AI assistant or character in a state where there are no particular issues. Note that “standard status” in FIG. 5C may be considered to be any state other than states (2) and (3). In addition, for example, when the artificial intelligence response output apparatus 10010 has switched to the response generation processing by the LLM or response template phrase database with a lower performance than the large language model on the network (large language model connected using the API) (2), the artificial intelligence response output apparatus 10010 displays the AI assistant or character in a “sleepy” state. Note that “displaying the AI assistant or character in a “sleepy” state” may also be referred to as “display showing the AI assistant or character in a sleepy state”.

The response generation processing of (2) is lower in performance than the response generation processing in the standard status by the large language model on the network (large language model connected using the API) of (1). Therefore, displaying the AI assistant or character in a “sleepy” state makes it possible to implicitly inform the user that the response performance of the AI assistant or character is low. In this manner, the user would feel less uncomfortable toward the low performance. Note that the switching condition in which the artificial intelligence response output apparatus 10010 switches to the response generation processing by the LLM or response template phrase database with a lower performance than the large language model on the network (large language model connected using the API) is as described with reference to FIG. 5A, and thus, redundant descriptions thereof are omitted as appropriate.

In addition, in (2) of FIG. 5C, prior to the user input by the user requesting a response from the large language model via the touch panel, the microphone 1139, or the operation input unit 1107 of the artificial intelligence response output apparatus 10010, it is desirable that the user is implicitly informed that the response performance of the AI assistant or character is low. Therefore, it is desirable that a timing for starting the state in which the AI assistant or character is displayed in a “sleepy” state as shown in (2) of FIG. 5C is immediately after the point where the artificial intelligence response output apparatus 10010 switches to the response generation processing by the LLM or response template phrase database with a lower performance than the large language model on the network (large language model connected using the API), but before the user input by the user requesting a response from the large language model.

In addition, for example, in a state where the artificial intelligence response output apparatus 10010 has switched to the non-response behavior described with reference to FIG. 5A, the artificial intelligence response output apparatus 10010 displays the AI assistant or character in the “sleeping” state (3). As described with reference to FIG. 5B, by allowing the artificial intelligence response output apparatus 10010 to display the AI assistant or character in the “sleeping” state, the user can understand that “the AI assistant or character is not responding because it is sleeping”, allowing the user to feel less uncomfortable. Note that the switching condition in which the artificial intelligence response output apparatus 10010 switches to non-response behavior described with reference to FIG. 5A is as described for Example 3 or 9 of FIG. 5A, and thus, redundant descriptions thereof are omitted as appropriate. Note that, in (3) of FIG. 5C, prior to the user input by the user requesting a response from the large language model via the touch panel, the microphone 1139, or the operation input unit 1107 of the artificial intelligence response output apparatus 10010, it is desirable that the user can understand that “the AI assistant or character is not responding because it is sleeping”. Therefore, as shown in (3) of FIG. 5C, it is desirable that a timing for starting the state in which the AI assistant or character is displayed in the “sleeping” state is immediately after the point where the artificial intelligence response output apparatus 10010 switches to the non-response behavior described with reference to FIG. 5A, but before the user input by the user requesting a response from the large language model.

Note that, in the display examples of FIG. 5C, the artificial intelligence response output apparatus 10010 displays the technical description of the state of the artificial intelligence response output apparatus 10010 regarding the response generation processing to the user by implicitly reflecting it as a change in the state of the AI assistant or character instead of directly providing the description to the user. In this manner, the user would feel less uncomfortable compared to directly providing the technical description of the state of the artificial intelligence response output apparatus 10010 regarding the response generation processing. In addition, the user would feel less uncomfortable compared to a case where the display state of the AI assistant or character is maintained in the standard status even if the state of the artificial intelligence response output apparatus 10010 regarding the response generation processing has changed.

However, some users may want a more accurate technical description of each state. Thus, display examples for such users will be described with reference to FIG. 5D. The rows in the table shown in FIG. 5D corresponding to the state of the apparatus and the state of display are the same as those of FIG. 5C, and thus, redundant descriptions thereof are omitted as appropriate. In addition, the display examples of the AI assistant or character shown in the respective row are nearly identical to those of FIG. 5C, with the exception of a question mark (?) displayed in each display example. The question mark (?) is a mark that the user operates when requesting an explanation from the artificial intelligence response output apparatus 10010, and may also be referred to as a help mark.

In the example of FIG. 5D, the user selects the question mark (?) through the user operation via the touch panel or the like of the operation input unit 1107 or the display 10011 of FIG. 1B to change the display of the AI assistant or character on the artificial intelligence response output apparatus 10010 to the display examples shown in the row “DISPLAY EXAMPLE AFTER USER OPERATION”. Specifically, the technical description of the state is displayed even if the state of apparatus is in (1), (2), or (3). For example, in the example of FIG. 5D, when the state of the apparatus is the standard status (1), “Standard status” may be displayed describing that the state is in the standard status where no particular technical restrictions are applied. In addition, when the apparatus is in a state where the low performance LLM or response template phrase database is being used (2), “Currently in low performance response mode” may be displayed technically describing that it is in the low performance state. This display may also be considered a description of why the AI assistant or character is displayed in the “sleepy” state.

In this case, a more detailed technical description may be provided. Specifically, “Currently in low performance LLM mode” or “Currently in template phrase response mode” or the like may be displayed. In addition, when the state of the apparatus is the non-response behavior (3), “Network connection not available” may be displayed technically describing that the reason for switching to the non-response behavior. If the reason for switching to the non-response behavior is that the response from the LLM on the network (large language model connected using the API) exceeds the predetermined time, “Response from LLM is delayed” or the like may be displayed. In addition, if the reason for switching to the non-response behavior is that the upper limit of the usage of the LLM on the network, the API usage, or the API usage fees have been reached, “Upper limit of LLM usage reached”, “Upper limit of API usage reached”, “the API usage fees as reached predetermined amount” or the like may be displayed. This display may also be considered a description of why the AI assistant or character is displayed in the “sleeping” state.

According to the display examples described above with reference to FIG. 5D, even if there are technical restrictions on the response generation processing in the artificial intelligence response output apparatus 10010, the user would feel less uncomfortable by first not providing a direct description to the user but instead implicitly indicating the state of the apparatus through changes in the display state of the AI assistant or character. This display is more suitable for users who do not require technical descriptions. Further, displaying the operation mark for the technical description of the state makes it possible to provide a display technically describing the state of the response generation processing (standard status or with technical restrictions) in the artificial intelligence response output apparatus 10010 to the user who has operated the mark. In this manner, it is possible to provide a more suitable display for the user who requires a more accurate technical description of each state.

Note that, in the examples of FIGS. 5B, 5C, and 5D, the display state of the AI assistant or character when in the “non-response behavior” is shown as being in the “sleeping” state. However, this is merely an example and the embodiments of the present invention are not limited to this. Instead of the “sleeping” state, other display states that implicitly indicate an unresponsive situation “resting” may also be used. In addition, in the examples shown in FIGS. 5C and 5D, the display state of the AI assistant or character when using the low performance LLM or response template phrase database is shown as being in the “sleepy” state. However, this is merely an example and the embodiments of the present invention are not limited to this. Other display states that implicitly indicate a low response performance of the AI assistant or character such as “hungry” may also be used.

According to the above-described artificial intelligence response output apparatus and artificial intelligence response output system according to the fifth embodiment, it is possible to switch the response generation processing used by the artificial intelligence response output apparatus more suitably depending on the connection state between the large language model on the network and the artificial intelligence response output apparatus, the response latency state from the large language model on the network, or the usage of the large language model on the network. In addition, in a case where the artificial intelligence response output apparatus according to the fifth embodiment is configured as the AI assistant apparatus or character conversation apparatus, it is possible to provide a display that is less uncomfortable for the user.

### Sixth Embodiment

Next, a sixth embodiment of the present invention is a modified version of the artificial intelligence response output apparatus 10010 or the artificial intelligence response output system according to the first to fifth embodiments described with reference to the drawings. Specifically, this example combines the response generation processing of the artificial intelligence response output apparatus 10010 and the response generation processing by the large language model on the network or the response generation processing by the local large language model of the artificial intelligence response output apparatus 10010 (local LLM processor 10028 or the like) and the response generation processing by the response template phrase database to generate a more suitable response output. In the present embodiment, only differences from the above-described embodiments will be described, and descriptions of configurations similar to those of the embodiments will be omitted as appropriate.

As in the above-described embodiments, the artificial intelligence response output apparatus 10010 may also be referred to as an artificial intelligence response output apparatus, a character conversation apparatus, an AI assistant apparatus, an AI assistant display apparatus, or an artificial intelligence interface apparatus. The system including the artificial intelligence response output apparatus 10010 and the large language model server may also be referred to as an artificial intelligence response output system, a character conversation system, an AI assistant system, an AI assistant display system, or an artificial intelligence interface system.

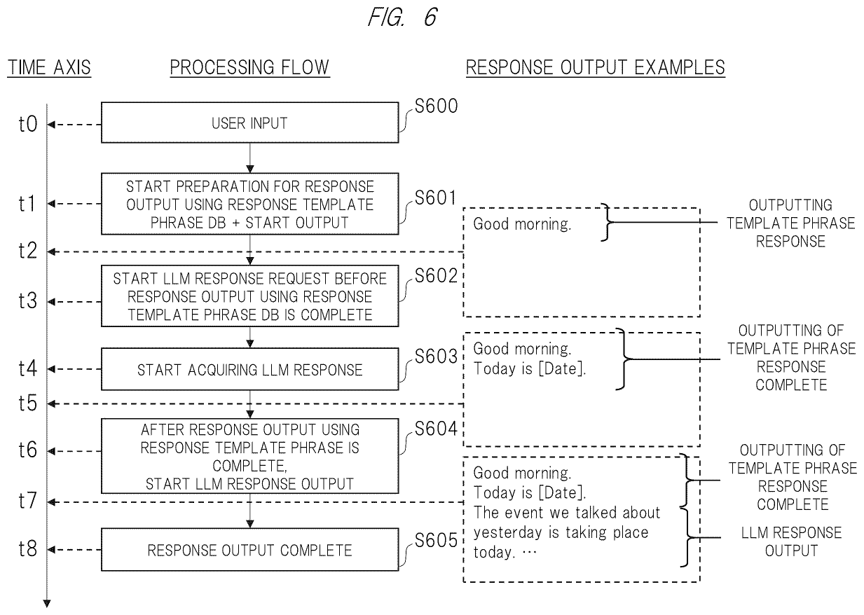

An example of the response generation processing in the artificial intelligence response output apparatus 10010 according to the sixth embodiment of to the present invention will be described with reference to FIG. 6. FIG. 6 shows an example of a flowchart of the response generation processing in the artificial intelligence response output apparatus 10010 according to the sixth embodiment of the present invention. Specifically, the drawing shows a time axis where time progresses from top to bottom, a processing flow, and response output examples. The output of the responses shown in the response output examples may be displayed on the display 10011 of the artificial intelligence response output apparatus 10010 or may be output as audio via the audio output unit 1140.

In the example of FIG. 6, first, at time t0, the user input by the user requesting a response from the large language model via the touch panel, the microphone 1139, or the operation input unit 1107 of the artificial intelligence response output apparatus 10010 is performed, and the controller 1110 of the artificial intelligence response output apparatus 10010 acquires the user input (step 600). Next, at time t1, the controller 1110 starts preparation for the response output using the response template phrase database stored in the storage 1170 and starts the response output using the response template phrase database (step 601). In the example of FIG. 6, at time t2, the response output using the response template phrase database is started, and as shown in the drawing, the template phrase response is being output which is not yet completed. “Good morning” in the drawing indicates the output of part of the sentence that continues with “Good morning. . . . ”.

At time t3, before the response output using the response template phrase database is completed, the controller 1110 generates a prompt based on the user input acquire in step 600, sends the generated prompt to the large language model on the network or the local large language model of the artificial intelligence response output apparatus 10010 (local LLM processor 10028 or the like), and starts a request for a response from the large language model (step 602). Further, at time t4, before the response output using the response template phrase database is completed, the controller 1110 starts acquiring the response from the large language model (step 603).

At time t5, an example of the completed response output using the response template phrase database is shown. For example, FIG. 6 shows an example of the response output “Good morning. Today is [Date]” completed at time t5 using the template phrases stored in the response template phrase database and date information stored in the memory. Here, at time t4 before the response output using the response template phrase database is completed, the control unit 1110 has already started acquiring the response from the large language model. Therefore, the controller 1110 starts the response output from the large language model at time t6 which follows time t5 when the display of the response output using the response template phrase database is completed following the response output using the response template phrase database (step 604). Thereafter, at time t7, the response from the large language model is output following the response output using the response template phrase database. When the response output from the large language model is completed, the response output according to the processing flow shown in FIG. 6 is completed (step 605).

Next, effects of the processing flow of the present invention shown in FIG. 6 will be described. Processing large language models requires a significant amount of computational resources. Even if inference which generally requires fewer computational resources than training is processed using the GPU (graphics processing unit), it may take several seconds to tens of seconds from the time the controller starts a response request to the large language model until the response is received from the large language model. This period corresponds to the period from time t3 to time t4 shown in FIG. 6. In addition, from the time t0 when user input is received until time t4, the controller 1110 has not yet acquired the response output from the large language model, and thus, it cannot output the response from the large language model to the user.

Therefore, in the processing flow where there is no start of preparation for response output using the response template database shown in step 601 of FIG. 6 and no start of response output using the response template database, the user may have to wait for several seconds to tens of seconds from the time t0 when the user input was made until the time t4 without receiving any response from the artificial intelligence response output apparatus 10010. For example, in a case where the artificial intelligence response output apparatus 10010 is configured as the AI assistant apparatus or character conversation apparatus, such waiting time may cause discomfort to the user.

Alternatively, in the processing flow according to the sixth embodiment of the present invention shown in FIG. 6, the controller 1110 starts processing of the response output using the response template phrase database which requires fewer computational resources than the processing of the large language model, before acquiring the response from the large language model. In this manner, the user does not have to wait without receiving a response from the artificial intelligence response output apparatus 10010 from time t0 to time t4. For the user, whether the response output is from the response output using the response template phrase database or from the large language model, it is still a response from the artificial intelligence response output apparatus 10010.

Therefore, in the processing flow shown in FIG. 6, by providing step 601 before step 603, it is possible to provide a virtually earlier response from the artificial intelligence response output apparatus 10010 to the user. In this manner, it possible to further reduce discomfort to the user caused by long waiting times. In addition, by outputting the response from the large language model following the response using the response template phrase database in step 604, the user can feel as if these outputs are a series of more natural outputs.

According to the above-described artificial intelligence response output apparatus and artificial intelligence response output system according to the sixth embodiment, it is possible to shorten the response waiting time from the artificial intelligence response output apparatus for the user and further reduce discomfort to the user.

### Seventh Embodiment

Next, a seventh embodiment of the present invention is a modified version of the artificial intelligence response output apparatus 10010 or the artificial intelligence response output system according to the first to sixth embodiments described with reference to the drawings. Specifically, this example combines the response generation processing by the large language model on the network or the response generation processing by the local large language model (local LLM processor 10028 or the like) within the artificial intelligence response output apparatus 10010 and the response generation processing by the response template phrase database to generate a more suitable response output in the response generation processing of the artificial intelligence response output apparatus 10010. In the present embodiment, only differences from the above-described embodiments will be described, and descriptions of configurations similar to those of the embodiments will be omitted as appropriate.

As in the above-described embodiments, the artificial intelligence response output apparatus 10010 may also be referred to as an artificial intelligence response output apparatus, a character conversation apparatus, an AI assistant apparatus, an AI assistant display apparatus, or an artificial intelligence interface apparatus. The system including the artificial intelligence response output apparatus 10010 and the large language model server may also be referred to as an artificial intelligence response output system, a character conversation system, an AI assistant system, an AI assistant display system, or an artificial intelligence interface system. The same applies to the artificial intelligence response output apparatus according to each of the embodiments described below.

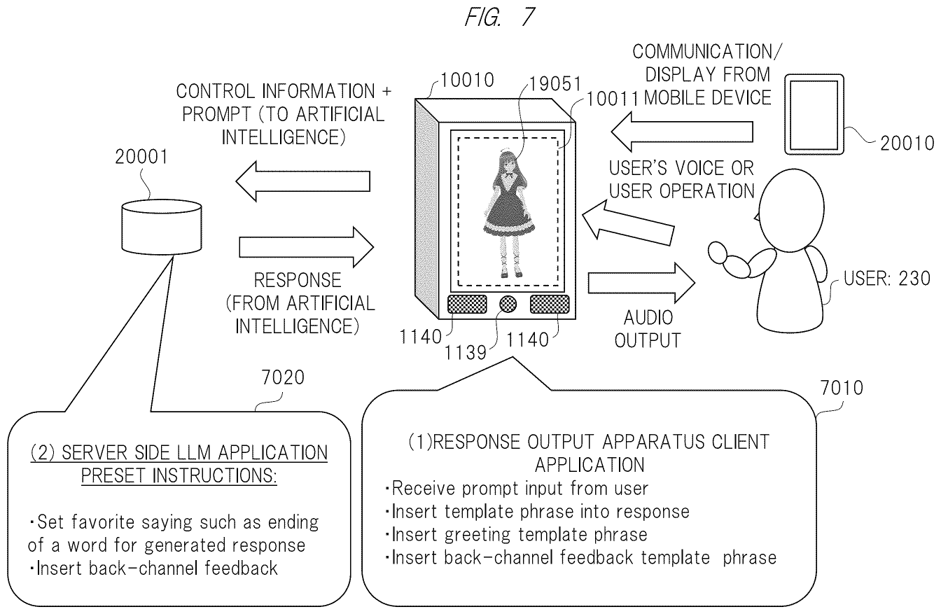

First, an example of the artificial intelligence response output apparatus and artificial intelligence response output system according to the seventh embodiment of the present invention will be described with reference to FIG. 7. A configuration of the artificial intelligence response output system of FIG. 7 is a modified version of the character conversation system shown in FIG. 3C. The configuration having the same reference sign as FIG. 3C is the same as that of FIG. 3C, and thus, redundant descriptions thereof are omitted as appropriate.

In the example of FIG. 7, as shown in a description 7010, the artificial intelligence response output apparatus 10010 comprises, for example, a client application as software that is loaded in the memory 1109 shown in FIG. 1B and executed by the controller 1110.

The client application is capable of controlling the input of the user prompt as described in first to sixth embodiments described with reference to the drawings. In addition, the client application exchanges information with the large language model using the user prompt. The client application acquires the response from the large language model. Based on this, the client application can control each unit shown in FIG. 1B including the display 10011 and the audio output unit 1140 and output the response to the user. Note that the user prompt may be generated by the client application based on the input from the user. As described with reference to FIG. 3C, examples of user input interfaces that can receive input from the user include examples of the operation input unit 1107 of FIG. 1B such as a mouse, keyboard, or touch panel. In addition, the microphone 1139 that captures the user's voice can also be considered one of the user input interfaces. In addition, the communication unit 1132 that communicates with a smartphone or tablet information processing terminal which is the mobile information processing terminal 20010 used by the user can also be considered one of the user input interfaces. In addition, as examples of output interface that can output the response to the user, the client application can include the display 10011 that outputs the response from the large language model in media such as words, images, or video, and the audio output unit 1140 that outputs the response from the large language model as audio.

Here, the client application can control the insertion of template phrases into the response output generated by the artificial intelligence response output apparatus 10010. This includes the output control of the template phrases described with reference to FIG. 1C, 2L, 4B, 5A, or 6. Examples of inserting the template phrases include inserting greeting template phrases and inserting template phrases of back-channel feedback. These template phrases are stored in the storage 1170 of the artificial intelligence response output apparatus 10010 of FIG. 1B, and may be loaded in the memory 1109 to be used by the client application.

In addition, in the example of FIG. 7 and as shown in a description 7020, there is an LLM (large language model) application on the large language model side that controls the input and output of information to and from the large language model. As shown in the example of FIG. 7, when an LLM application (abbreviation for large language model application; the same applies hereinafter) is present on the large language model server 20001 side, the LLM application is loaded in the memory of the large language model server 20001 and executed by the controller of the large language model server 20001. The LLM application can receive preset instructions to match the output of the large language model with specific specifications. While the user prompt is a prompt whose content changes each time the user input is provided, the above-described preset instructions for matching the output of the large language model with specific specifications are instructions whose content remains constant and are provided consistently for each individual user input, and thus, the preset instructions may also be referred to as stationary instructions. In addition, this may also be referred to as instructions for customizing the output of the large language model. For example, it is possible to set a preset instruction to set the ending of the response phrase of natural language generated by the large language model to a predetermined favorite saying. In addition, it is possible to set a preset instruction to insert the predetermined back-channel feedback in the response phrase of natural language generated by the large language model. The preset instructions for the LLM application may be sent from the client application of the artificial intelligence response output apparatus 10010 to the LLM application. In addition, the preset instructions for the LLM application may be communicated to the LLM application via the communication unit of the information terminal such as a smartphone or a personal computer used separately by the user.

Note that, in the example of FIG. 7, there is an LLM application on the large language model side that controls the input and output of information to and from the large language model. Alternatively, in another modification, the artificial intelligence response output apparatus 10010 may be configured to comprise an LLM application that controls the input and output of information to and from the local LLM processor 10028 of the artificial intelligence response output apparatus 10010. In this case, the LLM application may be software that is loaded in the memory 1109 and executed by the controller 1110. In this case, the LLM application that controls the input and output of information to and from the local LLM processor 10028 and the above-described client application may be separate applications or may be the same application.

Here, in the example of FIG. 7, the artificial intelligence response output apparatus 10010 can send not only the prompt but also control information to the large language model server 20001. The control information may be sent together with the prompt. The control information may be sent before the prompt is sent. The control of the sending of the control information and the prompt may be performed by the client application.

Hereinafter, a detailed example of the control information will be described. First, the control information may include authentication information for logging into the LLM application. For example, the user may create an account in advance in the LLM application and generate authentication information including identification information and a password. The creation of the account may be performed by communicating with the LLM application via the communication unit 1132 of the artificial intelligence response output apparatus 10010. In addition, the creation of the account may be performed by communicating with the LLM application via the communication unit of the information terminal such as a smartphone or personal computer used separately by the user. The authentication information is sent from the communication unit 1132 of the artificial intelligence response output apparatus 10010 to the LLM application, and login is performed through authentication processing. If authentication is successful, the artificial intelligence response output apparatus 10010 and the LLM application establish communication as the user corresponding to the authentication information. In this manner, the user can use information stored in the memory of the LLM application that is accessible by the user's account. Note that, in a case of the LLM application on the large language model server 20001 side, the storage area of the LLM application may be prepared in the memory or storage of the large language model server 20001. In addition, when there is an LLM application that controls the input and output of information to and from the local LLM processor 10028 of the artificial intelligence response output apparatus 10010, the storage area of the LLM application may be prepared in the storage 1170 or the memory 1109 of FIG. 1B.

The information available to the user's account includes the above-described preset instruction and the like. In addition, as shown in FIG. 2H, 2I, 2L, 4A, or 4B, when the artificial intelligence response output apparatus 10010 is capable of switching and displaying the plurality of characters, the storage area of the LLM application on may store information corresponding to the preset instructions for each of the plurality of characters. In this case, if the control information sent from the artificial intelligence response output apparatus 10010 to the LLM application includes a character ID that identifies the character, the LLM application can determine which preset instructions the user wants to apply to which character. That is, this involves including information for switching between preset instructions for each character in the control information, thereby enabling the LLM application to switch between preset instructions in accordance with the switching information. In addition, when the user sets preset instructions for each character in the LLM application, the control information sent from the artificial intelligence response output apparatus 10010 to the LLM application may include and transmit the setting information for the preset instructions. In addition, the setting information for the preset instruction may be sent to the LLM application via the communication unit of the information terminal such as a smartphone or personal computer used separately by the user. Upon receiving the preset instruction setting information, the LLM application stores information regarding the preset instructions based on the setting information in the storage area. As described above, the preset instruction information may be stored for each character. In addition, it may be stored for each user account. Once the preset instruction settings are complete, the user can transmit the character ID identifying the desired character from the artificial intelligence response output apparatus 10010 to the LLM application. The LLM application then selects the appropriate preset instruction for the character and applies it to the large language model. In this case, there is no need to transmit the information corresponding to the preset instruction to the LLM application each time an instruction is sent, and thus, the amount of communication data can be reduced.

In addition, as another example, each time the prompt is sent, information corresponding to the preset instruction may be stored in the control information sent from the artificial intelligence response output apparatus 10010 to the LLM application. In this case, the transmission frequency of information corresponding to the preset instruction increases, but it is possible to omit preparations such as prior user account registration and prior setting of preset instructions. In addition, each time the prompt is sent, information corresponding to the preset instruction may be information corresponding to the preset instruction may be stored and transmitted in the setting prompt area instead of the user prompt area. In this case also, preparations such as prior user account registration or pre-setting of preset instructions can be omitted.

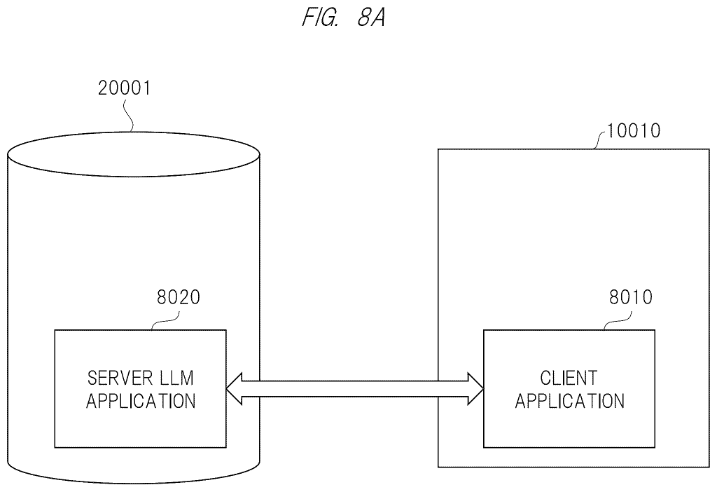

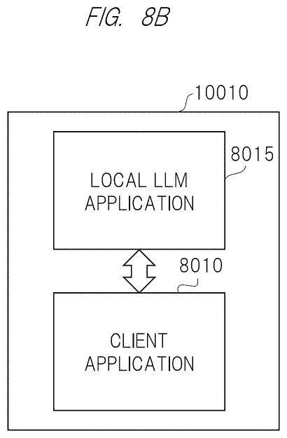

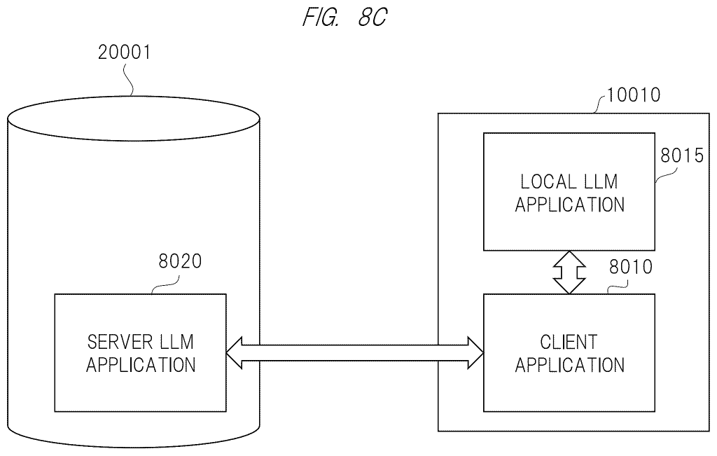

Next, several examples of how the client application and the LLM application are loaded and executed in the artificial intelligence response output system will be described with reference to FIGS. 8A, 8B, and 8C. The examples of FIGS. 8A, 8B, and 8C are schematic diagrams that focus on the loading, execution, and communication of the client application and the LLM application in the configuration of the artificial intelligence response output system including the artificial intelligence response output apparatus 10010 and the large language model server 20001. Other configurations besides the client application and the LLM application are omitted from the description for simplicity.

First, in the example of FIG. 8A, a client application 8010 is executed in the artificial intelligence response output apparatus 10010. Specifically, the client application 8010 is loaded in the memory 1109 shown in FIGS. 1B and 1s executed by the controller 1110. In addition, a server LLM application 8020 is executed in the large language model server 20001. Specifically, the server LLM application 8020 is loaded in the memory of the large language model server 20001 and is executed by the controller of the large language model server 2000. The server LLM application 8020 may be an application that controls the entire large language model of the large language model server 20001. The server LLM application 8020 may be an application that controls the input and output of information to and from the large language model of the large language model server 20001. The client application 8010 and the server LLM application 8020 communicate with each other via the communication unit 1132 shown in FIG. 1B, the communication apparatus 19011 shown in FIG. 1A, or a network such as the Internet 19000, and communicates via the communication unit of the server. In the example of the artificial intelligence response output system of FIG. 8A, the client application 8010 and the server LLM application 8020 cooperate to output a more suitable artificial intelligence response to the user. Here, the large language model of the large language model server 20001 may also be referred to as a server large language model. The server LLM application 8020 may also be referred to as a server large language model application.

Next, in another example shown in FIG. 8B, the client application 8010 is executed in the artificial intelligence response output apparatus 10010. As in FIG. 8A, the client application 8010 is loaded in the memory 1109 shown in FIGS. 1B and 1s executed by the controller 1110. In addition, a local LLM application 8015 is executed in the artificial intelligence response output apparatus 10010. Specifically, the local LLM application 8015 is loaded in the memory shown in FIGS. 1B and 1s executed by the controller in the artificial intelligence response output apparatus 10010. The local LLM application 8015 may be an application that controls the entire large language model of the local LLM processor 10028 shown in FIG. 1B. The local LLM application 8015 may be an application that controls the input and output of information to and from the large language model of the local LLM processor 10028. The client application 8010 and the local LLM application 8015 communicate with each other via a communication path such as a bus in the artificial intelligence response output apparatus 10010. In the example of the artificial intelligence response output system of FIG. 8B, the client application 8010 and the local LLM application 8015 cooperate to output a more suitable artificial intelligence response to the user. Here, the large language model of the local LLM processor 10028 may also be referred to as a local large language model. The local LLM application 8015 may also be referred to as a local large language model application.

Next, in another example shown in FIG. 8C, the client application 8010 and the local LLM application 8015 are executed in the artificial intelligence response output apparatus 10010. Details of the client application 8010 and the local LLM application 8015 are as described with reference to FIGS. 8A and 8B, and thus, redundant descriptions thereof are omitted as appropriate. In addition, the server LLM application 8020 is executed in the large language model server 20001. Details of the server LLM application 8020 are as described with reference to FIG. 8A, and thus, redundant descriptions thereof are omitted as appropriate. The client application 8010 and the server LLM application 8020 communicate with each other via the communication unit 1132 shown in FIG. 1B, the communication apparatus 19011 shown in FIG. 1A, the network such as the Internet 19000, and the communication unit of the server. The client application 8010 and the local LLM application 8015 communicate with each other via a communication path such as a bus in the artificial intelligence response output apparatus 10010. In the example of the artificial intelligence response output system of FIG. 8C, the client application 8010, the local LLM application 8015, and the server LLM application 8020 cooperate with one another to output a more suitable artificial intelligence response to the user.

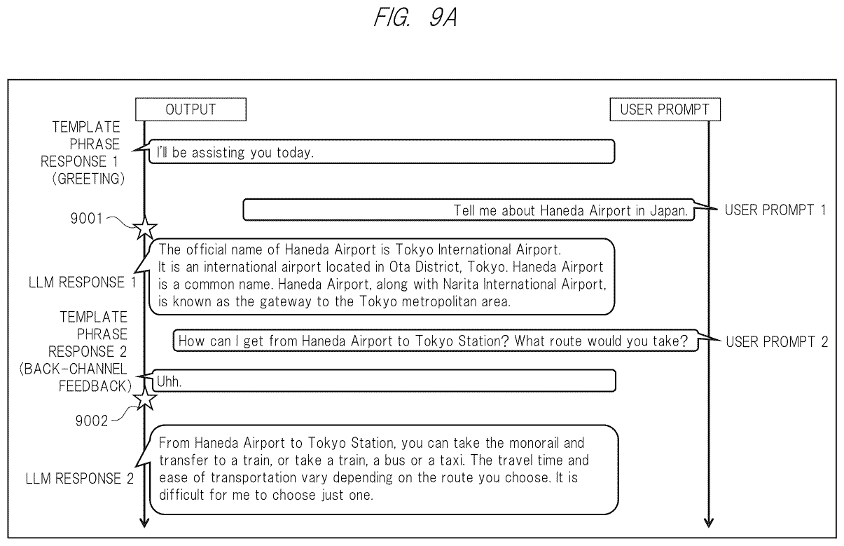

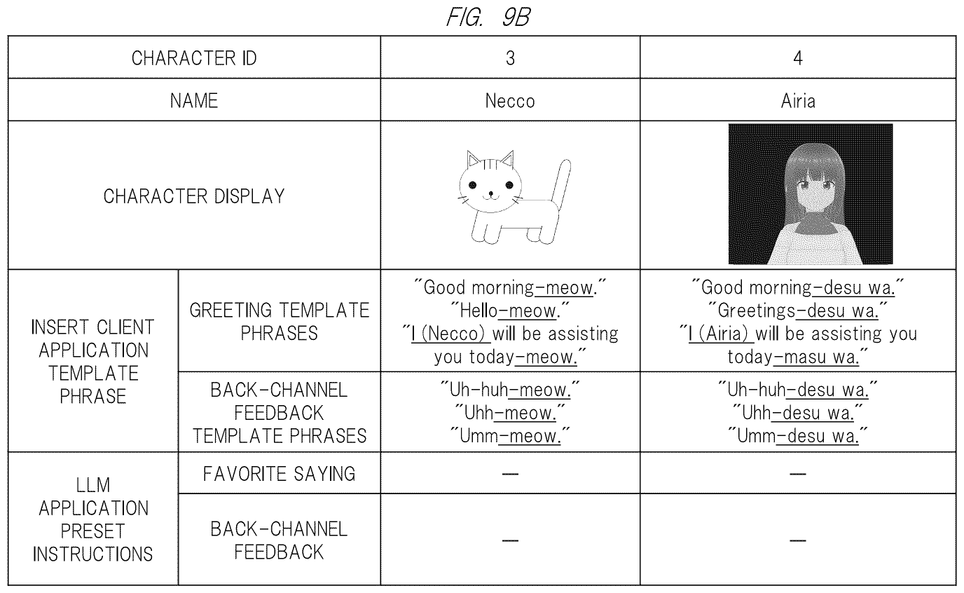

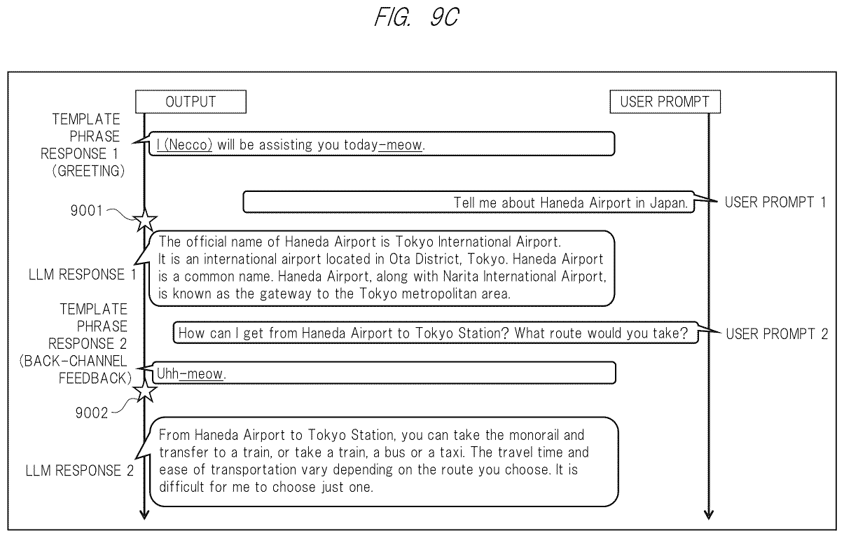

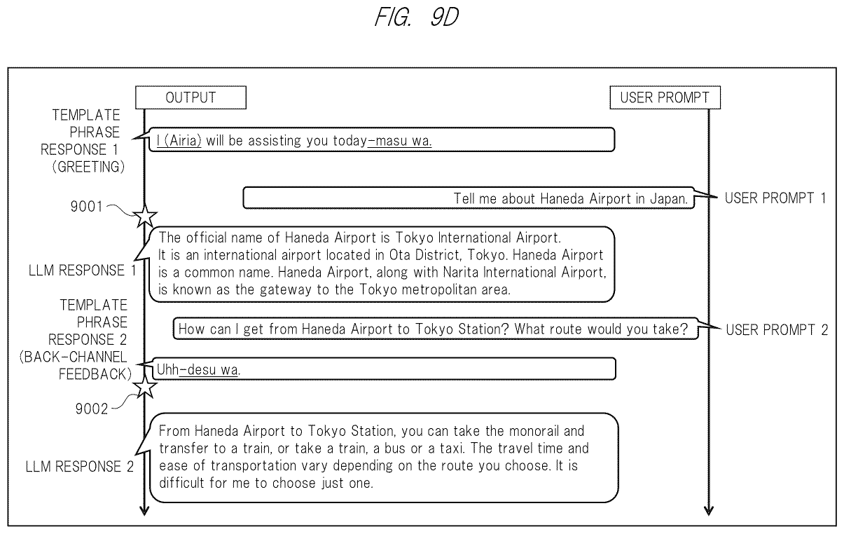

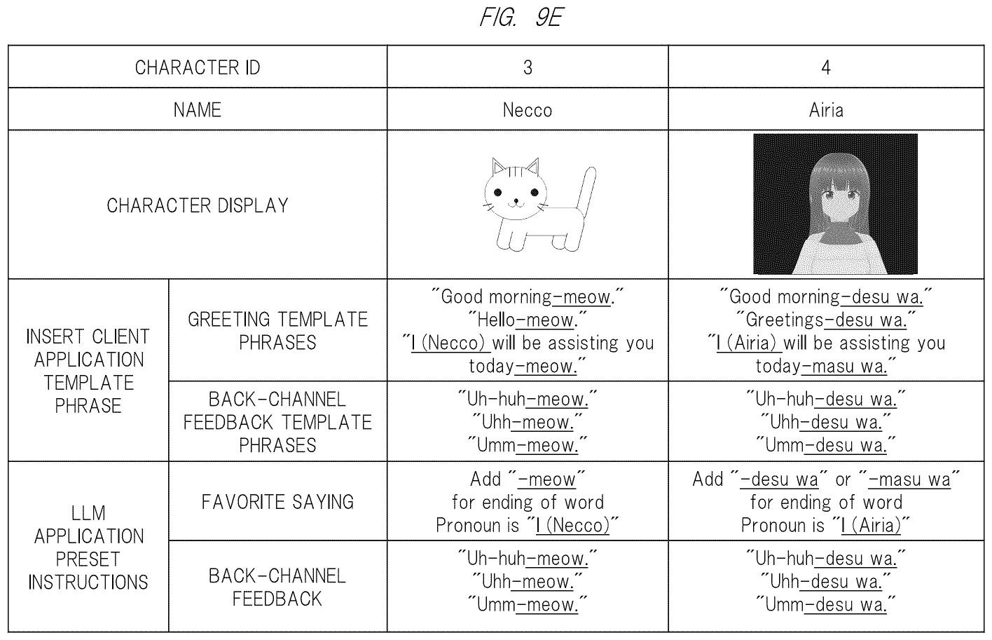

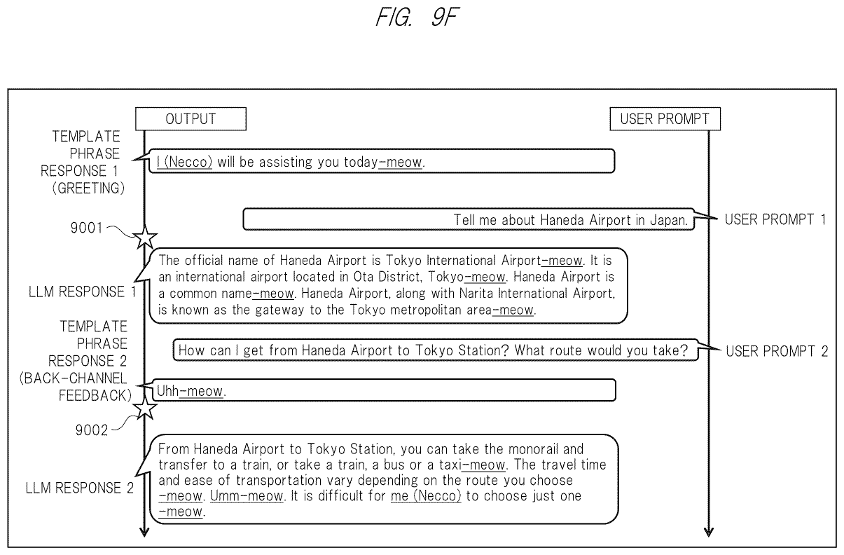

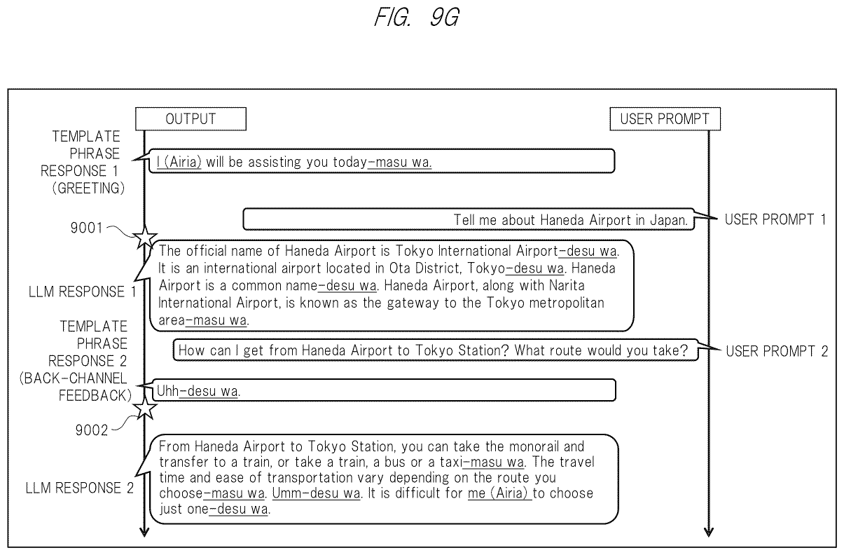

Next, an example of the artificial intelligence response output processing in the artificial intelligence response output system according to the seventh embodiment of the present invention will be described with reference to FIGS. 9A to 9G.

First, the right side of FIG. 9A shows examples of user prompt input by the user. Details of the input method of the user prompt are as described in the first to sixth embodiments, and thus, redundant descriptions thereof are omitted as appropriate. The left side of FIG. 9A shows examples of the output from the artificial intelligence response output apparatus 10010 of the artificial intelligence response output system. The input of the user prompt on the right side and the output from the artificial intelligence response output apparatus 10010 shown in chronological order from top to bottom.

Here, an example of the output from the artificial intelligence response output apparatus 10010 on the left side shows a Template Phrase Response 1 (greeting). This is an example in which the greeting of the template phrase is output from the artificial intelligence response output apparatus 10010 using the output control of the template phrases described with reference to FIG. 1C, 2L, 4B, 5A, or 6. The output control of the template phrases may be performed by the client application 8010. Next, when a User Prompt 1 is input to the artificial intelligence response output apparatus 10010, the client application 8010 acquires the prompt and sends the User Prompt 1 and control information to the large language model. The large language model that received the User Prompt 1 executes inference at a timing indicated by a star 9001 and generates an LLM Response 1. The large language model may be the large language model of the large language model server 20001. In this case, according to the state of FIG. 8A, the input and output of information to and from the large language model is controlled by the server LLM application 8020. In addition, the large language model may be the large language model of the local LLM processor 10028. In this case, according to the state of FIG. 8B, the input and output of information to and from the large language model is controlled by the local LLM application 8015. The LLM Response 1 generated by the large language model is sent to the client application 8010 by these LLM applications and is output as an artificial intelligence response from the artificial intelligence response output apparatus 10010. In a case where the artificial intelligence response output apparatus 10010 is the character conversation apparatus, the artificial intelligence response output is recognized as the displayed character's response by the user.

Next, an example in which a User Prompt 2 is input to the artificial intelligence response output apparatus 10010 for the LLM Response 1 is shown. Here, an example in which the client application 8010 that acquired the User Prompt 2 outputs the Template Phrase Response 2 (back-channel feedback) is shown. This is an example in which the back-channel feedback is output from the artificial intelligence response output apparatus 10010 using the output control of the template phrases described with reference to FIG. 1C, 2L, 4B, 5A, or 6. Multiple types of template phrases for the back-channel feedback may be prepared in advance, and a control may be performed such that they are output randomly at intervals longer than a predetermined period to avoid unnaturally high frequencies. On the other hand, as described with reference to FIG. 6, the client application 8010 sends the User Prompt 2 and control information to the above-described LLM application (server LLM application 8020 or local LLM application 8015) while outputting the template phrase. The LLM application that acquired the User Prompt 2 performs a control to cause the large language model (large language model of large language model server 20001 or large language model of local LLM processor 10028) to execute inference at a timing indicated by a star 9002. The LLM Response 2 is generated by the inference of the large language model. The LLM Response 2 generated by the large language model is sent to the client application 8010 by these LLM applications and is output as the artificial intelligence response from the artificial intelligence response output apparatus 10010. In a case where the artificial intelligence response output apparatus 10010 is the character conversation apparatus, the artificial intelligence response output is recognized as the displayed character's response by the user.

The above-described series of processing enables conversation between the artificial intelligence response output system and the user. FIG. 9A shows an example of a series of conversations between the user and the artificial intelligence regarding Haneda Airport in Japan, with greetings and back-channel feedback mixed therein. The series artificial intelligence response output from the artificial intelligence response output apparatus 10010 are recognized as a series of responses with a certain degree of consistency from the perspective of the user. However, these series of responses are configured by combining responses generated by the large language model controlled by the output control of the template phrases by the client application and controls of the input and output of information by the LLM application. That is, through the cooperation between the client application and the LLM application, an artificial intelligence response output that is more suitable for the user is provided.

Next, an example of controls regarding the character's conversation characteristics in a case where the client application and the LLM application cooperate with each other to provide a series of artificial intelligence response outputs in the artificial intelligence response output system will be described with reference to FIGS. 9B to 9G. Specifically, an example of controls for the template phrases including greetings and back-channel feedback, and for the response phrases including the favorite saying and back-channel feedback output from the large language model will be described.

The example of FIG. 9B is an example in which the artificial intelligence response output system is the character conversation system or the AI assistant system. In addition, the example of FIG. 9B is an example in which the artificial intelligence response output system is capable of switching and displaying the plurality of characters or AI assistants as shown in FIG. 2H, 2I, 2L, 4A, or 4B. Here, the example of FIG. 9B will be described using two characters. The use of only two characters is for the sake of simplicity, and it is possible to switch and display three or more characters, including those described in the previous embodiments. The two characters include the character named Necco whose character ID is 3. This character is the same as the character described in the previous embodiments. In addition, the two characters include a new character named Airia whose character ID is 4.

Here, the table of FIG. 9B shows the character IDs, names, and display examples of these two characters. Further, the table of FIG. 9B shows examples of the greeting template phrases and back-channel feedback template phrases that the client application inserts for each character. The processing in which the client application inserts the template phrases of the greeting and back-channel feedback has been described with reference to FIG. 7, and thus, redundant descriptions thereof are omitted as appropriate.

In the table of FIG. 9B, characteristic expressions (keywords) are used in both the greeting template phrases and the back-channel feedback template phrases to give these characters a personality. For example, Necco is a cat-like character, and thus, the template phrases end with “-meow”. In addition, Necco's pronoun is “I (Necco)”. For example, Airia's template phrases end with “-desu wa” or “-masu wa”. That is, the ending of a phrase is set to “-wa”. In addition, Airia's pronoun is “I (Airia)”. These keywords may also be referred to as keywords indicating the character's personality. By using these keywords consistently in each character's conversations, the character's personality can be expressed. When performing the switch processing of the character as described with reference to FIG. 2H, the client application may switch the keyword in accordance with the setting information or the like in the table of FIG. 9B.

Further, rows have been added to the table of FIG. 9B to allow users to set preset instructions for the LLM application regarding these characters such as favorite sayings and back-channel feedback. However, the example of FIG. 9B shows a case where these settings are not specified. The processing of preset instructions for the LLM application has been described with reference to FIG. 7, and thus, redundant descriptions thereof are omitted as appropriate.

The information shown in the table of FIG. 9B may be stored as table information in the storage unit 1170 or memory 1109 of the artificial intelligence response output apparatus 10010 shown in FIG. 1B. This information can then be used by the client application. The information shown in the table of FIG. 9B may also be referred to as information of settings related to conversation characteristics of a character.

Next, a conversation example in which the client application performs processing to insert the greeting template phrases and back-channel feedback template phrases shown in the table of FIG. 9B will be described with reference to FIGS. 9C and 9D. For the sake of simplicity, the conversation examples of FIGS. 9C and 9D are based on the conversation example of FIG. 9A, with only the parts that change by the processing of inserting the greeting template phrases and back-channel feedback template phrases shown in the table of FIG. 9B being replaced.

First, FIG. 9C shows a conversation example in which the client application controls the output of the artificial intelligence response from the artificial intelligence response output apparatus 10010 as the response of the character Necco. The client application reads the information of the greeting template phrases and back-channel feedback template phrases for the character Necco from the table information shown in FIG. 9B and uses it for the template phrase output of the artificial intelligence response. Note that when the client application reads the setting information for each character from the table information, it may identify the information using the character ID or the like. As shown in the conversation example of FIG. 9C, the Template Phrase Response 1 uses the greeting template phrase for the character Necco, with the pronoun “I (Necco)” and ending the phrase with “-meow”. In addition, the Template Phrase Response 2 uses the back-channel feedback template phrase for the character Necco, ending the phrase with “-meow”. However, in the table of FIG. 9B, no settings for the favorite saying or back-channel feedback by the LLM application preset instructions are provided. Therefore, the LLM Response 1 and LLM Response 2 remain unchanged from the original text in FIG. 9A, with no phrase ending with “-meow” and no pronoun using “I (Necco)”. Thus, the user engaging in a series of conversations may feel a lack of consistency in the character's personality when receiving content output from the artificial intelligence response output apparatus 10010 as the response of the character Necco.

Likewise, FIG. 9D shows a conversation example in which the client application controls the output of the artificial intelligence response from the artificial intelligence response output apparatus 10010 as the response of the character Airia. At this time, the client application reads the information of the greeting template phrases and back-channel feedback template phrases for the character Airia from the table information shown in FIG. 9B and uses it for the template phrase output of the artificial intelligence response. In the example of FIG. 9D, the Template Phrase Response 1 uses the greeting template phrase for the character Airia, with the pronoun “I (Airia)” and ending the phrase with “-wa”. In addition, the Template Phrase Response 2 uses the back-channel feedback template phrase for the character Airia, ending the phrase with “-wa”. However, in the table of FIG. 9B, no settings for the favorite saying or back-channel feedback by the LLM application preset instructions are provided. Therefore, the LLM Response 1 and LLM Response 2 remain unchanged from the original text in FIG. 9A, with no phrase ending with “-wa” and no pronoun using “I (Airia)”. Thus, even in the conversation example of FIG. 9D, the user engaging in a series of conversations may feel a lack of consistency in the character's personality when receiving content output as the response of the character Airia from the artificial intelligence response output apparatus 10010.

In this manner, when the client application and the LLM application cooperate with each other to perform a series of artificial intelligence response outputs, it is difficult to provide the user with a consistent impression on the character's personality by setting the character's personality only for the template phrase output control of the client application.

Thus, examples of improved control to solve this problem will be described with reference to FIGS. 9E to 9G.

FIG. 9E is an example of a modified version of the table information in the table of FIG. 9B. In the example of FIG. 9E, the character IDs, names, images of the character display, and inserting of the greeting template phrases and back-channel feedback template phrases of the client application are the same as those on the table information in the table of FIG. 9B, and thus, redundant descriptions thereof are omitted as appropriate. Here, in the example of FIG. 9E, favorite sayings and back-channel feedback not set in the table information in the table of FIG. 9B are set in the preset instructions for the LLM application. The preset instructions for the LLM application may be set by sending control information from the client application to the LLM application. This processing is as described with reference to FIG. 7, and thus, redundant descriptions thereof are omitted as appropriate. The information shown in the table of FIG. 9E is also information of the settings related to conversation characteristics of a character. Here, in the example of FIG. 9E, the settings for the favorite saying or back-channel feedback of the preset instructions for the LLM application include the instructions to output the characteristic expressions (keywords) contained in the greeting template phrases and back-channel feedback template phrases and common characteristic expressions (keywords) inserted by the client application in the response by the large language model. In this manner, the character's personality can be reflected in the response output of the large language model. Specifically, Necco is a cat-like character, and thus, as in the settings for the greeting template phrases and back-channel feedback template phrases inserted by the client application, the instruction is set in the settings for the favorite saying and back-channel feedback of the preset instructions for the LLM application such that the phrases end with “-meow”. In addition, as in the settings for the greeting template phrases and back-channel feedback template phrases inserted by the client application, the instruction is set in the settings for the favorite saying of the preset instructions for the LLM application such that Necco's pronoun is “I (Necco)”. Likewise, for the character Airia, as in the settings for the greeting template phrases and back-channel feedback template phrases inserted by the client application, the instruction is set in the settings for the favorite saying and back-channel feedback of the preset instructions for the LLM application such that the phrases end with “-wa”. In addition, as in the greeting template phrases and back-channel feedback template phrases inserted by the client application, the instruction is set in the settings for the favorite saying of the preset instructions for the LLM application such that Airia's pronoun is “I (Airia)”. That is, in the example of the table information shown in FIG. 9E, the characteristic expressions (keywords) indicating each character's personality contained in the settings for the greeting template phrases and back-channel feedback template phrases and the characteristic expressions (keywords) inserted by the client application are also included in the settings for the favorite saying and back-channel feedback of the preset instructions for the LLM application. Note that, in a case where the switch processing of the character as described with reference to FIG. 2H is performed, the client application may switch the settings for the greeting template phrases, the settings for the back-channel feedback template phrases, and the settings for the favorite saying and back-channel feedback of the preset instructions for the LLM application which are the settings related to the conversation characteristics of a character shown in FIG. 9E depending on the switch processing of the character.

The conversation examples that apply the control of the template phrases and preset prompts for the table information shown in FIG. 9E showing improvements to the settings will be described with reference to FIGS. 9F and 9G. For the sake of simplicity, the conversation examples in FIGS. 9F and 9G are based on the conversation example in FIG. 9A with the control of the template phrases and preset prompts for the table information shown in FIG. 9E applied.

FIG. 9F shows an example of a conversation to which the control of the template phrases and preset prompts for the table information shown in FIG. 9E has been applied. FIG. 9F shows a conversation example in which the client application controls the output of the artificial intelligence response from the artificial intelligence response output apparatus 10010 as the response of the character Necco. The client application reads the information of the greeting template phrases and back-channel feedback template phrases for the character Necco from the table information shown in FIG. 9E and uses it for the template phrase output of the artificial intelligence response. As shown in the conversation example of FIG. 9F, the Template Phrase Response 1 uses the greeting template phrase for the character Necco, with the pronoun “I (Necco)” and ending the phrase with “-meow”. In addition, the Template Phrase Response 2 uses the back-channel feedback template phrase for the character Necco, ending the phrase with “-meow”. Here, in the table of FIG. 9E, the settings for the favorite saying and back-channel feedback by the LLM application preset instructions contain characteristic expressions (keywords) that overlap the characteristic expressions (keywords) indicating the character Necco's personality, that is, the ending of a phrase and back-channel feedback contained in the settings such as “-meow” and the pronoun “I (Necco)”. In this manner, in the conversation example of FIG. 9F, the LLM Response 1 ends the phrase with “-meow”. In addition, the LLM Response 2 ends the phrase with “-meow” and uses the pronoun “I (Necco)”. In addition, the LLM Response 2 contains “Umm-meow” which is the back-channel feedback generated by the large language model in accordance with the LLM application preset instructions. This back-channel feedback also ends with the phrase “-meow”. In a series of conversations, the content output from the artificial intelligence response output apparatus 10010 as the response of the character Necco consistently uses the common characteristic expressions (keywords) regardless of whether the output is the template phrase output generated by the client application or is the response output of the large language model controlled by the LLM application. In this manner, the user can be provided with a more consistent impression for the character's personality for the content output from the artificial intelligence response output apparatus 10010 as the response of the character Necco.

Likewise, FIG. 9G shows another example of a conversation to which the control of the template phrases and preset prompts for the table information shown in FIG. 9E has been applied. FIG. 9G shows a conversation example in which the client application controls the output of the artificial intelligence response from the artificial intelligence response output apparatus 10010 as the response of the character Airia. The client application reads the information of the greeting template phrases and back-channel feedback template phrases for the character Airia from the table information shown in FIG. 9E and uses it for the template phrase output of the artificial intelligence response. As shown in the conversation example of FIG. 9G, the Template Phrase Response 1 uses the greeting template phrase for the character Airia, with the pronoun “I (Airia)” and ending the phrase with “-wa”. In addition, the Template Phrase Response 2 uses the back-channel feedback template phrase for the character Airia, ending the phrase with “-wa”. Here, in the table of FIG. 9E, the settings for the favorite saying and back-channel feedback by the LLM application preset instructions contain characteristic expressions (keywords) that overlap the characteristic expressions (keywords) indicating the character Airia's personality, that is, the ending of a phrase and back-channel feedback contained in the settings such as “-wa” and the pronoun “I (Airia)”. In this manner, in the conversation example of FIG. 9G, the LLM Response 1 ends the phrase with “-wa”. In addition, the LLM Response 2 ends the phrase with “-wa” and uses the pronoun “I (Airia)”. In addition, the LLM Response 2 contains “Umm-desu wa” which is the back-channel feedback generated by the large language model in accordance with the LLM application preset instructions. This back-channel feedback also ends with the phrase “-wa”. In a series of conversations, the content output from the artificial intelligence response output apparatus 10010 as the response of the character Airia consistently uses the common characteristic expressions (keywords) regardless of whether the output is the template phrase output generated by the client application or is the response output of the large language model controlled by the LLM application. In this manner, the user can be provided with a more consistent impression for the character's personality regarding the content output from the artificial intelligence response output apparatus 10010 as the response of the character Airia.

As described above with reference to FIGS. 9A to 9G, in the artificial intelligence response output system of the present embodiment, the client application and the LLM application cooperate with each other to perform a series of artificial intelligence response outputs. In addition, as described with reference to FIGS. 9A to 9G, in the artificial intelligence response output system of the present embodiment, controls are performed such that consistent and common characteristic expressions (keywords) are used for each character in the template phrase output generated by the client application and the response output of the large language model controlled by the LLM application. In this manner, an effect can be achieved in which the user can be provided with a more consistent impression for the character's personality regarding the content output from the artificial intelligence response output system. In addition, In this system, the artificial intelligence response output apparatus 10010 controls the client application to exchange control information with the LLM application, making it possible to perform controls such that consistent and common characteristic expressions (keywords) are used for each character in the template phrase output generated by the client application and the response output of the large language model controlled by the LLM application. The controls of the client application executed by the artificial intelligence response output apparatus 10010 allows an effect to be achieve in which the user can be provided with a more consistent impression for the character's personality regarding the content output from the artificial intelligence response output system.

Note that, in the conversation examples shown in FIGS. 9F, 9G, and the like, output of the Template Phrase Response 2 which is the back-channel feedback template phrase is started after the User Prompt 2 is received and before the LLM Response 2 which is the response output of the large language model controlled by the LLM application. Since the inference of the large language model takes a certain amount of time, the client application controls the timing of inserting the back-channel feedback template phrase to prevent an unnatural gap between the response output from the artificial intelligence response output apparatus 10010 and the user's response. This is the same method used in the control shown in FIG. 6 where the output of the template phrase response is started first, followed by the generation of the response by the large language model. That is, the timing immediately before the start of inference the large language model is one of the suitable timings for outputting the template phrase response.

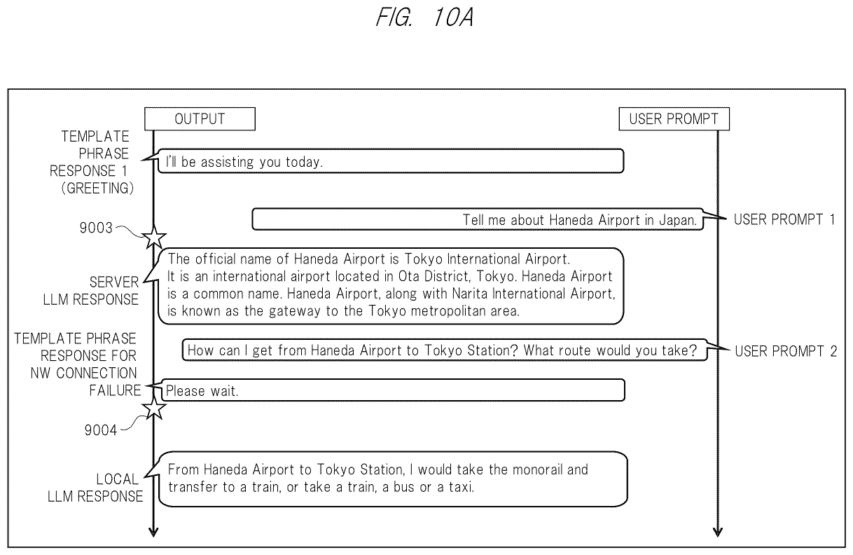

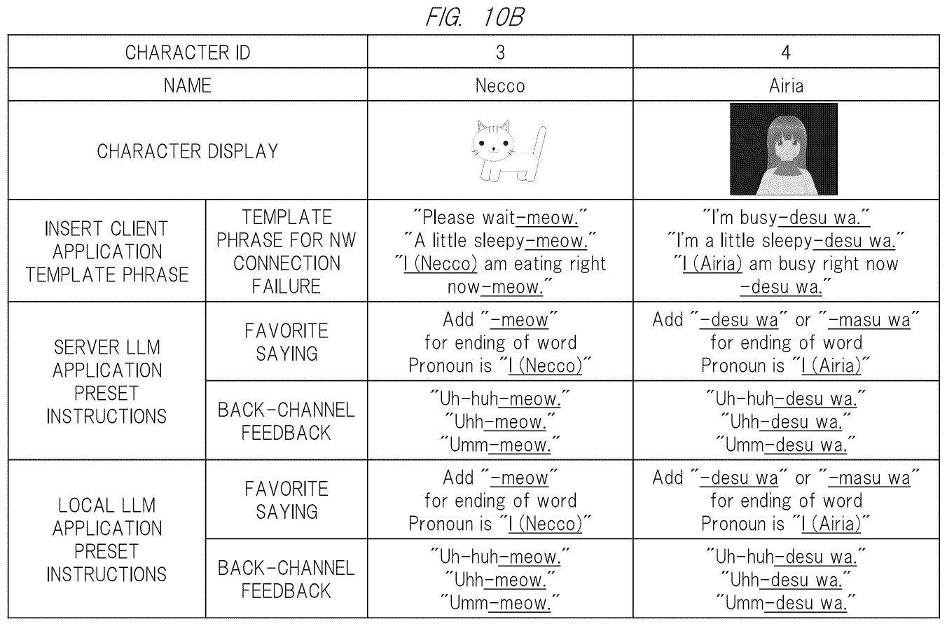

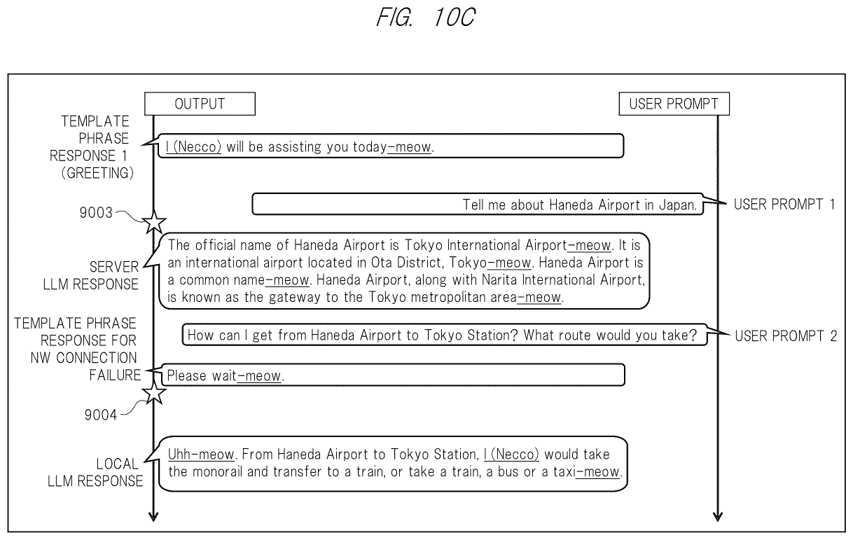

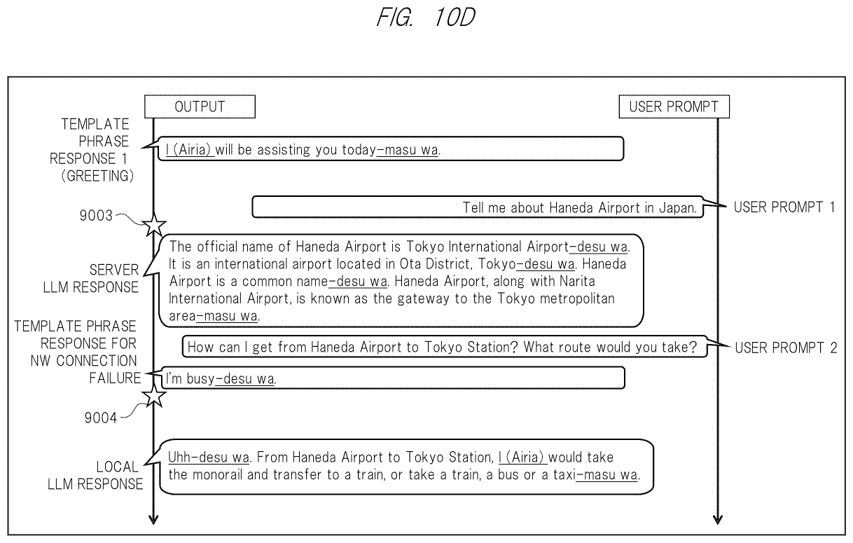

Next, an example in which the client application, the local LLM application, and the server LLM application cooperate with one another to output the artificial intelligence response to the user will be described with reference to FIGS. 10A to 10D. The state corresponds to that of FIG. 8C.

The conversation example of FIG. 10A shows an example in which the client application, the local LLM application, and the server LLM application cooperate with one another to output the artificial intelligence response to the user. For the sake of simplicity, most of the contents in the conversation example of FIG. 10A are the same as those of FIG. 9A. Therefore, in FIG. 10A, only differences from the conversation example of FIG. 9A will be mainly described. In the conversation example of FIG. 10A, the various settings expressing the character's personality using the table information described with reference to FIG. 9E is not performed. In the conversation example of FIG. 10A, the Template Phrase Response 1 and User Prompt 1 are the same as those of FIG. 9A. Next, a server LLM response of FIG. 10A has the same content as the LLM Response 1 of FIG. 9A. However, the server LLM response is a response output based on the response of the large language model on the server side controlled by the server LLM application 8020. Therefore, the inference executed at a timing indicated by a star 9003 is the inference by the large language model of the large language model server 20001.

Here, the conversation example of FIG. 10A shows an example in which, after the server LLM response, the network connection is not available between the artificial intelligence response output apparatus 10010 and the large language model server 20001. In the artificial intelligence response output system, the control for switching between the response of the large language model on the server side and the response of the local large language model of the artificial intelligence response output apparatus 10010 is as described in, for example, the fifth embodiment (FIG. 5A and the like), and thus, redundant descriptions thereof are omitted as appropriate. The User Prompt 2 of FIG. 10A is the same as that of FIG. 9A. However, since the network connection is not available, the client application 8010 sends the User Prompt 2 to the local LLM application 8015 instead of the server LLM application 8020. In addition, the client application 8010 outputs a template phrase response for NW connection failure, that is, template phrase response for when the network connection is not available. Thus, the inference is executed by the large language model of the local LLM processor 10028 controlled by the local LLM application 8015 at a timing indicated by a star 9004. In the example of FIG. 10A, the local LLM response based on the inference by the large language model of the local LLM processor 10028 is output. That is, in the conversation example of FIG. 10A, the output from the artificial intelligence response output apparatus 10010 of the artificial intelligence response output system to the user includes the template phrase output generated by the client application 8010, output base on the response of the large language model on the server side controlled by the server LLM application 8020, and output base on the response of the large language model of the local LLM processor 10028 controlled by the local LLM application 8015.

Next, an example in which controls of various settings that express the character's personality are performed for a series of conversation examples of FIG. 10A according to the present embodiment will be described with reference to FIGS. 10B to 10D.

First, FIG. 10B shows a modified version of the table information for the various settings of FIG. 9E. FIG. 10B is an example of a modified version of the table information in the table of FIG. 9E. In the example of FIG. 10B, the character IDs, names, and images of the character display are the same as those on the table information in the table of FIG. 9E, and thus, redundant descriptions thereof are omitted as appropriate.

In the example of FIG. 10B, the settings regarding the greeting template phrases and back-channel feedback template phrases inserted by the client application has been omitted for the sake of simplicity, but it is assumed to be the same as those of FIG. 9E. FIG. 10B further shows the settings for template phrases inserted by the client application when the network connection is not available. The processing in which the artificial intelligence response output apparatus 10010 locally inserts the template phrases when the network connection is not available is as described for Example 2 and the like of FIG. 5A, and thus, redundant descriptions thereof are omitted as appropriate. In addition, in the example of FIG. 10B, the preset instructions for the LLM application set in the table of FIG. 9E are stored in both the server LLM application preset instructions and the local LLM application preset instructions as preset instructions. In the example of FIG. 10B, it is possible to set the favorite saying and back-channel feedback for each of the two preset instructions. These are set as shown in FIG. 10B. The preset instructions for the server LLM application may be set by sending the control information from the client application to the server LLM application. The preset instructions for the local LLM application may be set by sending the control information from the client application to the local LLM application. The processing is as described with reference to FIG. 7, and thus, redundant descriptions thereof are omitted as appropriate. Note that the information shown in the table of FIG. 10B is also information of the settings related to the conversation characteristics of a character.

Here, in the table information of various settings of FIG. 10B, the favorite saying or back-channel feedback of the preset instructions for the server LLM application and local LLM application are set such that the character's personality indicated by the characteristic expressions (keywords) contained in the template phrases inserted by the client application when the network connection is not available is reflected to the response output of the large language model controlled by the server LLM application and the response output of the large language model controlled by the local LLM application. Here, in the example of FIG. 10B, instructions to output the characteristic expressions (keywords) contained in the template phrases and the common characteristic expressions (keywords) inserted by the client application to the response of the large language model controlled by the server LLM application are included in the settings for the favorite saying and back-channel feedback of the preset instructions for the server LLM application. Likewise, instructions to output the characteristic expressions (keywords) contained in the template phrases and the common characteristic expressions (keywords) inserted by the client application to the response of the large language model controlled by the local LLM application are included in the settings for the favorite saying and back-channel feedback the preset instructions for the local LLM application. That is, the characteristic expressions (keywords) contained in the template phrases and the common characteristic expressions (keywords) inserted by the client application are contained in the settings for the favorite saying and back-channel feedback of the server LLM application and in the settings for the favorite saying and back-channel feedback of the preset instructions in the local LLM application. Specifically, Necco is a cat-like character, and thus, the settings for template phrases inserted by the client application when the network connection is not available ends the phrase with “-meow”. In addition, in these template phrases, Necco's pronoun is set to “I (Necco)”. Here, in the example of FIG. 10B, in the settings for the favorite saying and back-channel feedback of the preset instructions in the server LLM application, the instructions are set such that the phrase ends with “-meow” and Necco's pronoun is “I (Necco)”. Likewise, in the settings for the favorite saying and back-channel feedback of the preset instructions in the local LLM application, the instructions are set such that the phrase ends with “-meow” and Necco's pronoun is “I (Necco)”. The specific settings for the favorite saying and back-channel feedback of the preset instructions in the server LLM application and the specific settings for the favorite saying and back-channel feedback of the preset instructions in the local LLM application do not need to be completely identical as long as they share common characteristic expressions (keywords). Likewise, in the example of FIG. 10B, for the character Airia, the settings for template phrases inserted by the client application when the network connection is not available ends the phrase with “-wa”. In addition, these template phrases, Airia's pronoun is set to “I (Airia)”. Here, in the example of FIG. 10B, in the settings for the favorite saying and back-channel feedback of the preset instructions in the server LLM application, the instructions are set such that the phrase ends with “-wa” and Airia's pronoun is “I (Airia)”. Likewise, in the settings for the favorite saying and back-channel feedback of the preset instructions in the local LLM application, the instructions are set such that the phrase ends with “-wa” and Airia's pronoun is “I (Airia)”. Note that, in a case where the switch processing of the character is performed as described with reference to FIG. 2H, the client application switches the settings related to the conversation characteristics of a character shown in FIG. 10B including various settings for template phrases, the settings for a favorite saying and back-channel feedback of the preset instructions for the server LLM application, and the settings for a favorite saying and back-channel feedback of the preset instructions for the local LLM application based on the switch processing of the character.

The conversation examples that apply the control of the template phrases and preset prompts for the table information shown in FIG. 10B will be described with reference to FIGS. 10C and 10D. For the sake of simplicity, the conversation examples in FIGS. 10C and 10D are based on the conversation example in FIG. 10A with the control of the template phrases and preset prompts for the table information shown in FIG. 10B applied.

FIG. 10C shows a conversation example to which the control of the template phrases and preset prompts for the table information shown in FIG. 10B has been applied. FIG. 10C shows a conversation example in which the client application controls the output of the artificial intelligence response from the artificial intelligence response output apparatus 10010 as the response of the character Necco. As shown in the conversation example of FIG. 10C, the control of the greeting template phrases by the client application shown in FIG. 9E is applied to the Template Phrase Response 1. The server LLM application preset instructions shown in FIG. 10B are applied to the server LLM response. The control of the template phrase for NW connection failure shown in FIG. 10B is applied to the template phrase response for NW connection failure. In addition, the local LLM application preset instructions shown in FIG. 10B is applied to the local LLM response. In the example shown in FIG. 10C, the local LLM response includes “Uh-huh-meow” which is the back-channel feedback generated by the large language model of the local LLM processor 10028 controlled by the local LLM application. As a result, in a series of conversations, the content output from the artificial intelligence response output apparatus 10010 as the response of the character Necco ends with the phrase “-meow” and uses Necco's pronoun “I (Necco)” regardless of whether the output is the template phrase output generated by the client application, or is the response output of the large language model controlled by the server LLM application, or is the response output of the large language model of the local LLM processor 10028 controlled by the local LLM application. That is, the common characteristic expressions (keywords) are consistently used. In this manner, the user can be provided with a more consistent impression for the character's personality regarding the content output from the artificial intelligence response output apparatus 10010 as the response of the character Necco.

Likewise, FIG. 10D shows another example of a conversation to which the control of the template phrases and preset prompts for the table information shown in FIG. 10B has been applied. FIG. 10D shows a conversation example in which the client application controls the output of the artificial intelligence response from the artificial intelligence response output apparatus 10010 as the response of the character Airia. As shown in the conversation example of FIG. 10D, the control of the greeting template phrases by the client application shown in FIG. 9E is applied to the Template Phrase Response 1. The server LLM application preset instructions shown in FIG. 10B are applied to the server LLM response. The control of the template phrase for NW connection failure shown in FIG. 10B is applied to the template phrase response for NW connection failure. In addition, the local LLM application preset instructions shown in FIG. 10B is applied to the local LLM response. In the example shown in FIG. 10D, the local LLM response includes “Uhh-desu wa” which is the back-channel feedback generated by the large language model of the local LLM processor 10028 controlled by the local LLM application. As a result, in a series of conversations, the content output from the artificial intelligence response output apparatus 10010 as the response of the character Airia ends with the phrase “-wa” and uses Airia's pronoun “I (Airia)” regardless of whether the output is the template phrase output generated by the client application, or is the response output of the large language model controlled by the server LLM application, or is the response output of the large language model of the local LLM processor 10028 controlled by the local LLM application. That is, the common characteristic expressions (keywords) are consistently used. In this manner, the user can be provided with a more consistent impression for the character's personality regarding the content output from the artificial intelligence response output apparatus 10010 as the response of the character Airia.

As described above with reference to FIGS. 10A to 10D, in the artificial intelligence response output system of the present embodiment, the client application, the server LLM application, and the local LLM application cooperate with one another to perform the series of artificial intelligence response outputs. In addition, in the artificial intelligence response output system of the present embodiment described with reference to FIGS. 10A to 10D, controls are performed such that consistent and common characteristic expressions (keywords) are used for each character in the template phrase output generated by the client application, the response output of the large language model controlled by the server LLM application, and the response output of the large language model controlled by the local LLM application. In this manner, an effect can be achieved in which the user can be provided with a more consistent impression for the character's personality regarding the content output from the artificial intelligence response output system. In addition, in this system, the artificial intelligence response output apparatus 10010 controls the client application to exchange control information with the server LLM application, and exchange control information with the local LLM application, making it possible to perform controls such that consistent and common characteristic expressions (keywords) are used for each character in the template phrase output generated by the client application, the response output of the large language model controlled by the server LLM application, and the response output of the large language model controlled by the local LLM application. By the control of the client application executed by the artificial intelligence response output apparatus 10010, an effect can be achieved in which the user can be provided with a more consistent impression for the character's personality regarding the content output from the artificial intelligence response output system.

### Eighth Embodiment

Next, an eighth embodiment of the present invention is a modified version of the artificial intelligence response output apparatus 10010 or artificial intelligence response output system according to the first to seventh embodiments described with reference to the drawings. Specifically, this example performs a more suitable output control of the template phrases such as back-channel feedback in the response generation processing of the artificial intelligence response output apparatus 10010. In the present embodiment, only differences from the above-described embodiments will be described, and descriptions of configurations similar to those of the embodiments will be omitted as appropriate. Note that the LLM application in the present embodiment may be a server LLM application or a local LLM application.

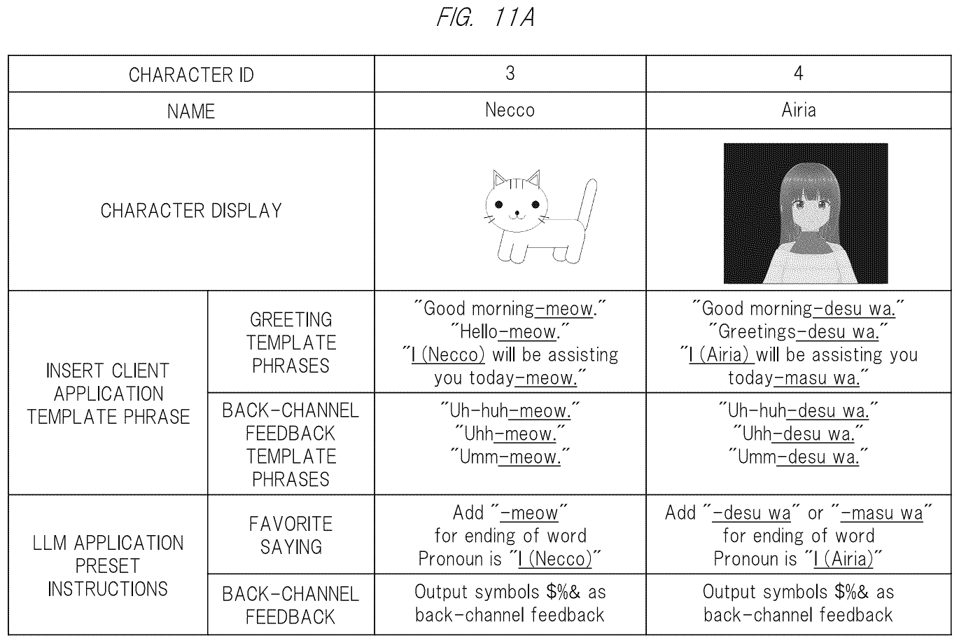

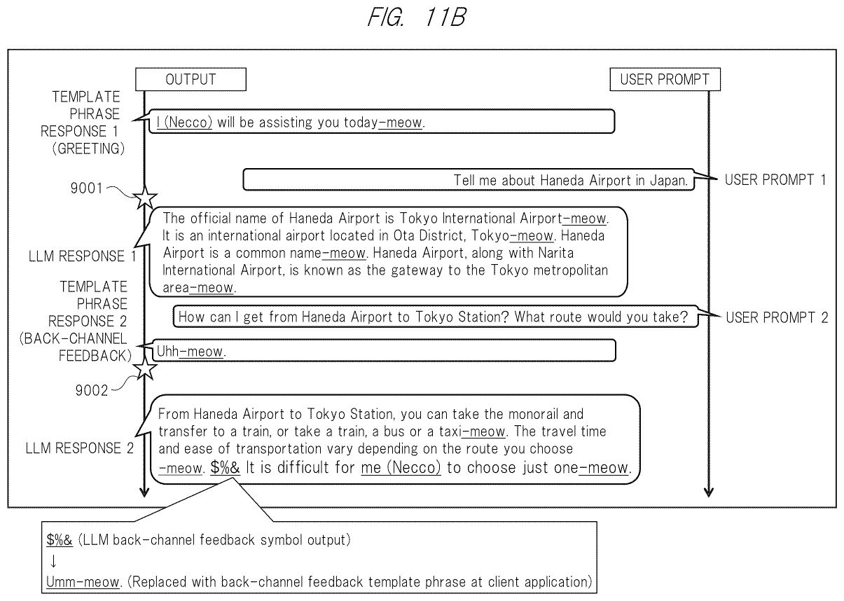

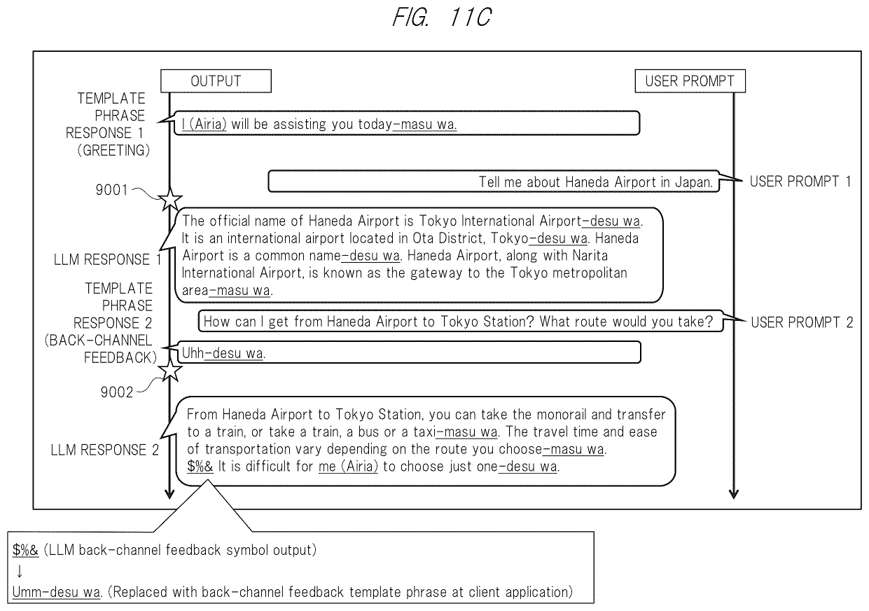

In the example of FIG. 9E according to the seventh embodiment, a control is performed using the table information of FIG. 9E to include the characteristic expressions (keywords) for each character contained in the template phrases inserted by the client application in the preset instructions for the LLM application regarding a response such as back-channel feedback of the character. However, the response output of the large language model controlled by the LLM application is generated by inference, and thus, there may be a case where the desired response output for a response such as back-channel feedback is not obtained probabilistically due to random numbers used in the inference or due to the performance of the large language model. Thus, in the artificial intelligence response output system according to the eighth embodiment of the present invention, the client application of the artificial intelligence response output apparatus 10010 performs a control using the table information shown in FIG. 11A to solve this issue.

The table information shown in FIG. 11A is an example of modifying part of the table information shown in FIG. 9E. Note that the information stored in the table information shown in FIG. 11A is information of settings related to the conversation characteristics of a character. In a case where the switch processing of the character as described with reference to FIG. 2H is performed, the client application may switch the settings related to the conversation characteristics of a character shown in FIG. 11A including various settings for template phrases and the settings for a favorite saying and back-channel feedback of the preset instructions for the LLM application in accordance with the switch processing of the character. For the sake of simplicity, only differences from the table information shown in FIGS. 11A and 9E will be described, and descriptions of portions similar to that of FIG. 9E are omitted as appropriate. Specifically, in the example of table information shown in FIG. 11A, the preset instructions for the LLM application specifies “Output back-channel feedback with symbols $%&” which differs from the table information in FIG. 9E. That is, in the present embodiment, the client application sends a preset instruction to the LLM application to output back-channel feedback not as natural language but as predetermined symbols. When using the table information shown in FIG. 11A, the large language model controlled by the LLM application that receives the preset instruction outputs “$%&” as the response of the back-channel feedback. The response symbol “$%&” of the back-channel feedback is sent from the LLM application to the client application. When the client application receives the response symbol “$%&” of the back-channel feedback, it randomly replaces the response symbol “$%&” of the back-channel feedback with one of the plurality of back-channel feedback template phrases corresponding to each character in the table information shown in FIG. 11A as the response output from the artificial intelligence response output apparatus 10010 to the user. This makes it possible for both the back-channel feedback template phrases inserted by the client application and the back-channel feedback template phrases replaced by the client application for the response symbol “$%&” of the back-channel feedback output by the large language model controlled by the LLM application to include common expressions corresponding to the character's personality, regardless of the large language model controlled by the LLM application. In this manner, the user can be provided with a more consistent impression for the character's personality regarding the back-channel feedback output from artificial intelligence response output system. Note that the symbol “$%&” shown in FIG. 11A is merely an example, and other symbols may be used. However, it is desirable that the symbol be set using special symbols or combinations of letters so that it does not match any words commonly used in everyday conversation. In addition, it is preferable that the symbol not include any characters from a natural language that represent vowels. This is because, in the unlikely event that the client application fails to perform the above replacement, including natural language words that represent vowels in the symbol could result in those words being pronounced as part of the character's voice during audio output. If the symbol does not include natural language words that represent vowels, even if the replacement fails as described above, the symbol cannot be spoken, and thus, it is suitable that the artificial intelligence response output apparatus 10010 ignores the symbol for audio output.

Next, a conversation example using the table information of FIG. 11A will be described with reference to FIGS. 11B and 11C. The conversation examples of FIGS. 11B and 11C are respectively based on the conversation examples of FIGS. 9F and 9G. For the sake of simplicity, only differences from FIGS. 9F and 9G will be described, and descriptions of similar portions are omitted as appropriate. Note that the LLM application in the conversation examples of FIGS. 11B and 11C may be an LLM application or a local LLM application.

FIG. 11B shows a conversation example in which the client application controls the output of the artificial intelligence response from the artificial intelligence response output apparatus 10010 as the response of the character Necco. The conversation example of FIG. 11B differs from that of FIG. 9F in that the back-channel feedback “umm-meow” generated by the large language model controlled by the LLM application in the conversation of FIG. 9F is replaced with the LLM back-channel feedback response symbol “$%&”. In the example of FIG. 11B, the client application replaces the LLM back-channel feedback response symbol “$%&” output from the LLM application with “Umm-meow” selected from the back-channel feedback template phrases of the character Necco in FIG. 11A using a random number, and outputs the result to the user. As a result, in a series of conversations, the content output from the artificial intelligence response output apparatus 10010 as the response of the character Necco ends the phrase with “-meow” and uses Necco's pronoun “I (Necco)”. That is, the common characteristic expressions (keywords) are consistently used. In this manner, the user can be provided with a more consistent impression for the character's personality regarding the content output from the artificial intelligence response output apparatus 10010 as the response of the character Necco even if the LLM back-channel feedback response symbol “$%&” of FIG. 11B is used.

Next, FIG. 11C shows a conversation example in which the client application controls the output of the artificial intelligence response from the artificial intelligence response output apparatus 10010 as the response of the character Airia. The conversation example of FIG. 11C differs from that of FIG. 9G in that the back-channel feedback “umm-desu wa” generated by the large language model controlled by the LLM application in the conversation of FIG. 9G is replaced with the LLM back-channel feedback response symbol “$%&”. In the example of FIG. 11C, the client application replaces the LLM back-channel feedback response symbol “$%&” output from the LLM application with “umm-desu wa” selected from the back-channel feedback template phrases of the character Airia in FIG. 11A using a random number, and outputs the result to the user. As a result, in a series of conversations, the content output from the artificial intelligence response output apparatus 10010 as the response of the character Airia ends the phrase with “-wa” and uses Airia's pronoun “I (Airia)”. That is, the common characteristic expressions (keywords) are consistently used. In this manner, the user can be provided with a more consistent impression for the character's personality regarding the content output from the artificial intelligence response output apparatus 10010 as the response of the character Airia even if the LLM back-channel feedback response symbol “$%&” of FIG. 11B is used.

As described above with reference to FIGS. 11A to 11C, in the artificial intelligence response output system of the present embodiment, the preset instructions for the LLM application instructs the output of the back-channel feedback with a predetermined symbol, and the client application replaces the LLM back-channel feedback response symbol which is the predetermined symbol generated by the large language model with the back-channel feedback template phrase. In this manner, an effect can be achieved in which the user can be provided with a more consistent impression for the character's personality regarding the content output from the artificial intelligence response output system.

In addition, in this system, the artificial intelligence response output apparatus 10010 controls the client application to instruct the back-channel feedback to be output with the predetermined symbol in the preset instructions sent to the LLM application, receive the LLM back-channel feedback response symbol which is the predetermined symbol generated by the large language model, and replace it with the back-channel feedback template phrases. In this manner, an effect can be achieved in which the user can be provided with a more consistent impression for the character's personality regarding the content output from the artificial intelligence response output system.

### Ninth Embodiment

Next, a ninth embodiment of the present invention is a modified version of the artificial intelligence response output apparatus 10010 or artificial intelligence response output system according to the first to eighth embodiments described with reference to the drawings. Specifically, this example performs a more suitable control for controlling the client application to insert the back-channel feedback into a natural language text of the response output of the large language model controlled by the LLM application during the response generation processing of the artificial intelligence response output apparatus 10010. In the present embodiment, only differences from the above-described embodiments will be described, and descriptions of configurations similar to those of the embodiments will be omitted as appropriate. Note that the LLM application in the present embodiment may be a server LLM application or a local LLM application.

In the conversation examples shown in FIGS. 9F and 9G, client application, output of the back-channel feedback template phrase response is started immediately before starting the inference of the large language model. In addition, in the conversation examples shown in FIGS. 10C and 10D, the client application outputs the template phrase response for when the network connection is not available to respond to the user that the network connection is not available. The timing for outputting the template phrase response that differs from the above can be such that the client application inserts the template phrase response in the middle of a natural language text of the response output of the large language model. For example, if the natural language text of the response output of the large language model exceeds a predetermined number of words, inserting a back-channel feedback template phrase at that point may make the response output feel more natural to the user. At this time, the timing at which the back-channel feedback template phrase is inserted into the natural language text of the response output of the large language model becomes an issue. Thus, the client application of the artificial intelligence response output apparatus 10010 in the artificial intelligence response output system according to the present embodiment determines the timing based on a newline symbol contained in the natural language text of the response output of the large language model. Specifically, the timing for inserting the back-channel feedback template phrase is at least the position of the newline symbol. In natural language, commas and periods are used to separate sentences. Since commas are used in the middle of a sentence, inserting the back-channel feedback at that position may not be natural. A period indicates the end of a sentence, so it is more suitable than a comma. However, there are cases where the sentence with a period and the next sentence after the period are closely related and form a coherent meaning in context. In such a case, inserting the back-channel feedback at the position of the period between the two sentences may not seem natural. Alternatively, when a plurality of sentences are consecutive, the position where the newline symbol is inserted indicates that the continuity of the series of sentences is temporarily interrupted. Therefore, the position where the newline symbol is inserted is a more natural and suitable timing for inserting the back-channel feedback. In addition, the positions where two newline symbols appear consecutively is where the continuity of a series of sentences is temporarily interrupted, followed by an empty line. As a result, the continuity of the series of sentences is more strongly interrupted compared to the position where one newline symbol is inserted. Therefore, the positions where two or more newline symbols are inserted are more natural and appropriate timings for inserting the back-channel feedback.

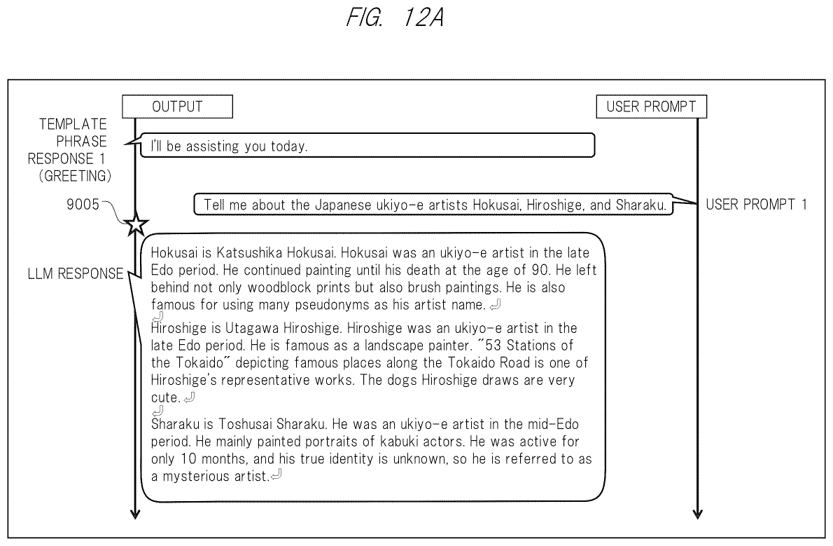

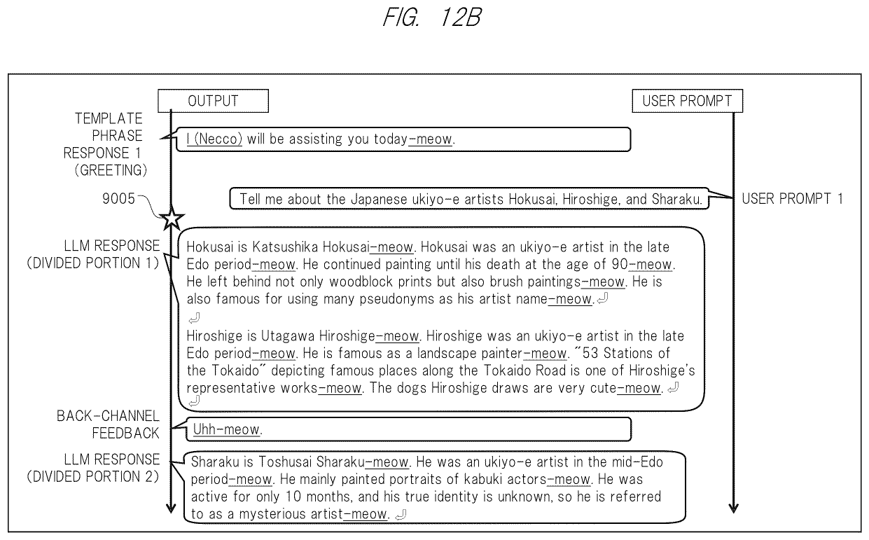

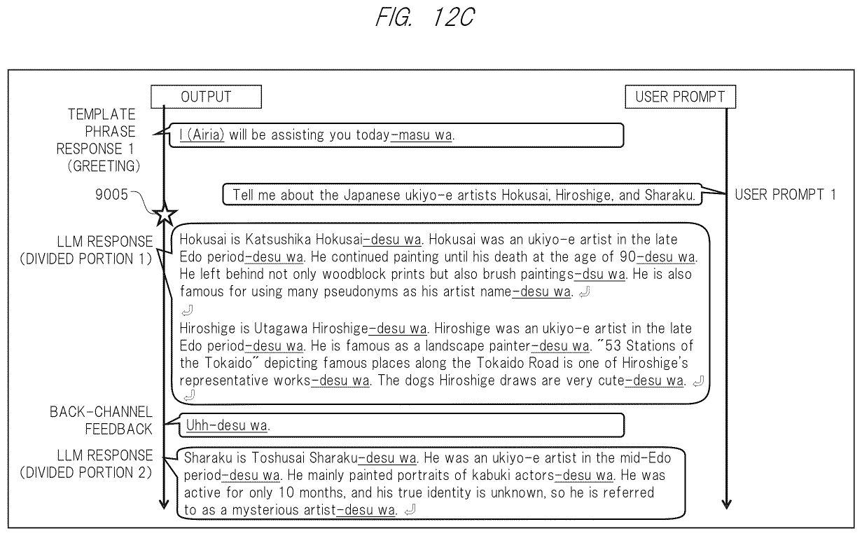

A specific example of the response generation processing of the artificial intelligence response output apparatus 10010 according to the ninth embodiment of the present invention will be described with reference to FIGS. 12A to 12C.

FIG. 12A shows a conversation example in which the response generation processing of the artificial intelligence response output apparatus 10010 does not interrupt the natural language text of the response output of the large language model with the template phrase response. First, the client application outputs the Template Phrase Response 1 of a greeting. Next, the user inputs the User Prompt 1 containing a question about Japanese ukiyo-e artists into the artificial intelligence response output apparatus 10010. The client application sends the input User Prompt 1 to the LLM application. The LLM application having received the User Prompt 1 executes inference in the large language model based on the User Prompt 1 at a timing indicated by a star 9005. The natural language text of the LLM response generated by the large language model in the inference is sent from the LLM application to the client application. The client application outputs the natural language text of the LLM response to the user. Note that, in the present embodiment, for the sake of simplicity, newline symbols that were omitted in previous embodiments are shown in the drawing. The newline symbol is a symbol that indicates a new line in the natural language text.

Next, a conversation example in which, using the conversation example in FIG. 12A as the original text, the client application of the artificial intelligence response output apparatus 10010 performs controls using various setting information stored in the table information of FIG. 9E, and performs insertion processing of the template phrase response on the natural language text of the response output of the large language model will be described with reference to FIGS. 12B and 12C.

First, FIG. 12B shows a conversation example in which the client application controls the output of the artificial intelligence response from the artificial intelligence response output apparatus 10010 as the response of the character Necco. First, in FIG. 12B, the Template Phrase Response 1 is the greeting template phrase of the character Necco. The User Prompt 1 is the same as that of FIG. 12A. Here, in the example of FIG. 12B, the LLM application preset instructions shown in the table information of FIG. 9E are applied to the LLM application. Here, when the LLM application receives the User Prompt 1, the inference is executed by the large language model based on the User Prompt 1 at a timing indicated by a star 9005, as in FIG. 12A. The inference applies the LLM application preset instructions shown in the table information in FIG. 9E, and thus, the response generation text produced by this inference uses characteristic expressions (keywords) that reflect the character Necco's personality. For example, this includes the ending a phrase with “-meow”. Here, the LLM response (Divided Portion 1) and the LLM response (Divided Portion 2) shown in FIG. 12B are assumed to be generated in a single inference by the large language model executed at the timing indicated by a star 9005 without being divided. The LLM application sends the response phrase containing the LLM response (Divided Portion 1) and the LLM response (Divided Portion 2) to the client application. The client application that receives the response phrase determines the position at which to insert the response phrase from the back-channel feedback template phrases. The client application divides the response phrase into the LLM response (Divided Portion 1) and LLM response (Divided Portion 2) at the position shown in the drawing.

The client application first outputs the LLM response (Divided Portion 1) to the user. Next, the client application inserts the back-channel feedback template phrase “Uhh-meow” for the character Necco at the divided position and outputs it to the user. Next, the client application outputs the LLM response (Divided Portion 2) to the user. In this manner, the user can recognize that the back-channel feedback is contained in the series of response outputs from the client application of the artificial intelligence response output apparatus 10010. In addition, since the back-channel feedback also uses the characteristic expressions (keywords) indicating the character Necco's personality, the user can feel as if it is natural back-channel feedback.

Here, an example of determination processing in which the client application divides LLM response and determines the position to insert the back-channel feedback template phrase will be described. First, the client application that acquires the full text of the LLM response from the LLM application determines the length of the full text of the LLM response. If the length is equal to or shorter than the predetermined length, the client application decides not to divide the LLM response and not to insert the back-channel feedback template phrases. This is to avoid making the response sound unnatural by dividing short LLM responses and inserting back-channel feedback template phrases. The predetermined length used as the threshold for this determination may also be referred to as a template phrase non-insertion period of the LLM response phrase. Note that the unit of length used in this determination process can be characters, words, or tokens. Next, if the length of the entire LLM response exceeds the predetermined length, the client application determines that it is permissible to insert the back-channel feedback template phrase LLM response. Next, the client application analyzes the text from the beginning of the entire LLM response and determines the position at which to divide the entire LLM response using the predetermined conditions. As an example of the predetermined conditions, positions where two newline symbols appear consecutively may be used. Once the client application has identified the candidate position, it can determine whether to randomly split the entire LLM response using a probability processing involving a random number. For example a random number can be generated, and if the remainder when dividing the generated random number by a predetermined number (e.g., 3) is 1, the client application can decide to divide the entire LLM response. This allows the full text of the LLM response to be randomly divided with a probability of one-third. The client application divides the full text of the LLM response into two divided portions and outputs the first divided portion. Thereafter, the back-channel feedback template phrase is inserted into the divided position and is output. Next, the client application performs the determination processing for determining the position to insert the back-channel feedback template phrase for the remaining divided portion of the LLM response. This processing may change the target of the above-described determination processing for determining the position to insert the back-channel feedback template phrase for the entire LLM response from the entire LLM response to the remaining divided portion of the LLM response. When the client application repeats this processing, the segmented processing of the LLM response and the output of the next divided portion of the LLM response are repeated. Thereafter, when the length of the remaining divided portion of the LLM response becomes shorter than the above-described template phrase non-insertion period, the client application ends the determination processing for whether dividing is necessary and outputs the remaining LLM response. In this manner, the full text of the LLM response initially acquired by the client application is divided into multiple portions, with back-channel feedback template phrases inserted in between, and is output as a series of responses from the client application. An example of this result is shown in FIG. 12B.

Note that, in the description above, the portion “the client application analyzes the text from the beginning of the entire LLM response and determines the position at which to divide the entire LLM response using the predetermined conditions. As an example of the predetermined conditions, positions where two newline symbols appear consecutively may be used” may be modified. For example, it may be modified to “the client application analyzes the text from the beginning of the entire LLM response and determines the position at which to divide the entire LLM response using the predetermined conditions. As an example of the predetermined conditions, a position where one newline symbol appears may be used”. In addition, it may be modified to “the client application analyzes the text from the beginning of the entire LLM response and determines the position at which to divide the entire LLM response using the predetermined conditions. As an example of the predetermined conditions, a position where a newline symbol followed with a space symbol appears may be used”.

Note that the template phrase non-insertion period which is one of the conditions for determining whether to insert the back-channel feedback template phrase may be set with different lengths. Specifically, a first template phrase non-insertion period used to determine the length of the entire LLM response may differ from the subsequent template phrase non-insertion periods used to determine the length of the remaining divided portions of the LLM response during the second and subsequent iterations of the processing. In addition, the template phrase non-insertion period itself may be set to a variable length using a random number-based processing.

Next, FIG. 12C shows a conversation example in which the client application controls the output of the artificial intelligence response from the artificial intelligence response output apparatus 10010 as the response of the character Airia. In the conversation example of FIG. 12C also, using the conversation example in FIG. 12A as the original text, the client application of the artificial intelligence response output apparatus 10010 performs controls using various setting information for the character Airia stored in the table information of FIG. 9E, and further performs insertion processing of the back-channel feedback template phrase response on the natural language text of the response output of the large language model. The various control examples of the client application of FIG. 12C are the same as the series of processes and controls of the client application in the conversation example of FIG. 12B, with the exception of the various settings stored in the table information of FIG. 9E being switched from the various settings for the character Necco to the various settings for the character Airia, and thus, redundant descriptions thereof are omitted as appropriate. In the conversation example of FIG. 12C also, the user can recognize that the back-channel feedback is contained in the series of response outputs from the client application of the artificial intelligence response output apparatus 10010. In addition, since the back-channel feedback also uses the characteristic expressions (keywords) indicating the character Airia's personality, the user can feel as if it is natural back-channel feedback.

As described above with reference to FIGS. 12A to 12C, in the artificial intelligence response output system of the present embodiment, natural language text of the response output of the large language model controlled by the LLM application is divided by the client application of the artificial intelligence response output apparatus 10010 under the predetermined conditions, and the template phrase is inserted into the divided position. In this manner, the user can recognize that the back-channel feedback is naturally contained in the series of response outputs from the client application of the artificial intelligence response output apparatus 10010.

### Tenth Embodiment

Next, a tenth embodiment of the present invention will be described. In the seventh to ninth embodiments of the present invention, an example has been described in which various controls are performed in the artificial intelligence response output system such that the client application and the LLM application cooperate with each other to ensure that consistent and common characteristic expressions (keywords) that constitute the personality of each character are used to perform the series of artificial intelligence response outputs. These controls are intended to achieve an effect in which the user is provided with a more consistent impression for the character's personality regarding the content output from the artificial intelligence response output system. Here, in addition to the characteristic expressions (keywords) in the above-described embodiments, a speaking speed can also become a consistent and common characteristic that constitutes the personality of each character. Thus, in the tenth embodiment of the present invention, in the artificial intelligence response output system, the client application of the artificial intelligence response output apparatus 10010 suitably controls the speaking speed for each character.

The tenth embodiment is a modified version of the artificial intelligence response output apparatus 10010 or artificial intelligence response output system according to the first to ninth embodiments described with reference to the drawings. Specifically, in the response output processing of the artificial intelligence response output apparatus 10010, the client application performs a speed adjustment control to adjust the speaking speed of the natural language text of the response output of the large language model controlled by the LLM application to bring it closer to the speaking speed of the template phrases read from the storage and played back by the client application. In the present embodiment, only differences from the above-described embodiments will be described, and descriptions of configurations similar to those of the embodiments will be omitted as appropriate.

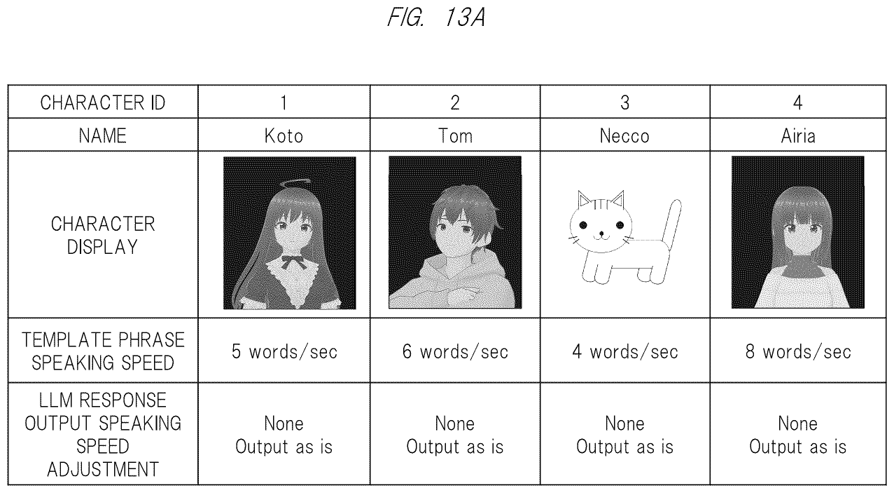

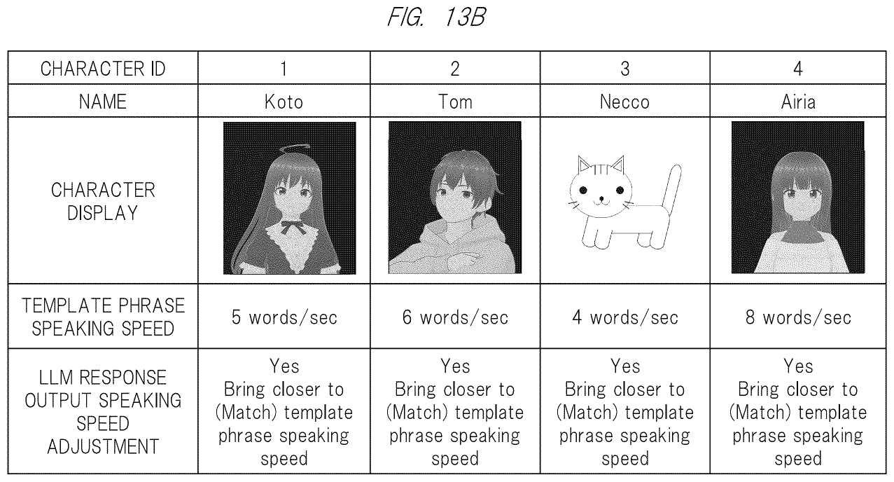

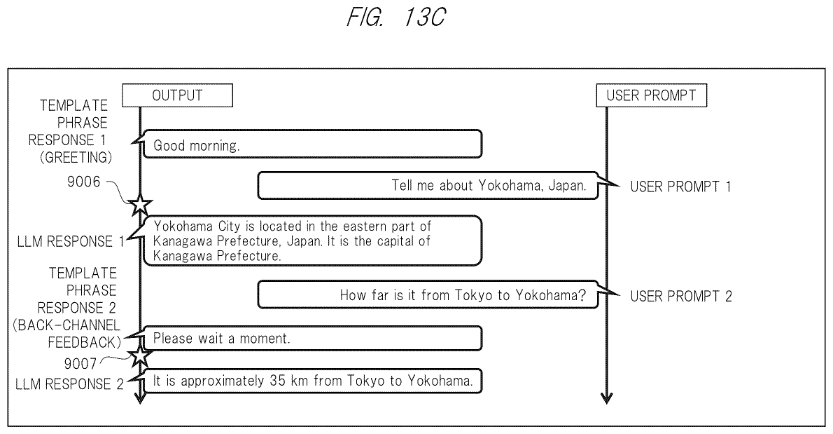

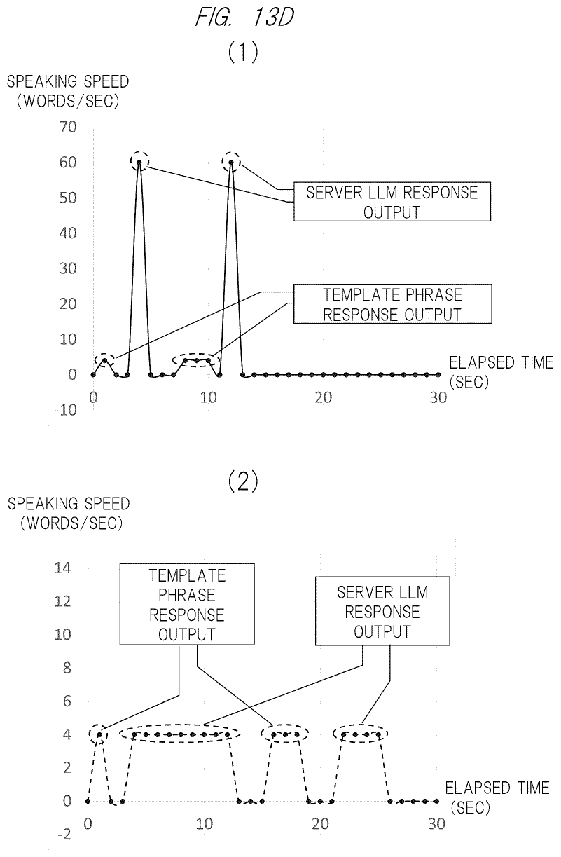

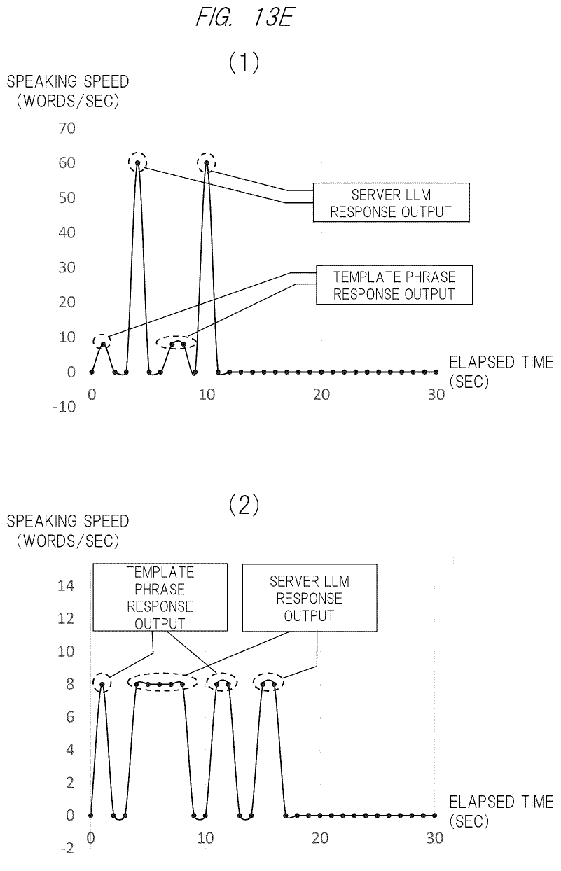

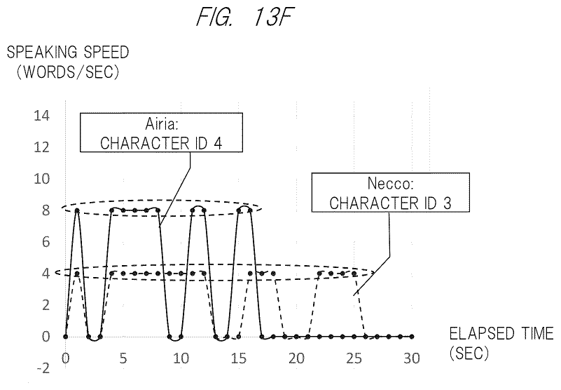

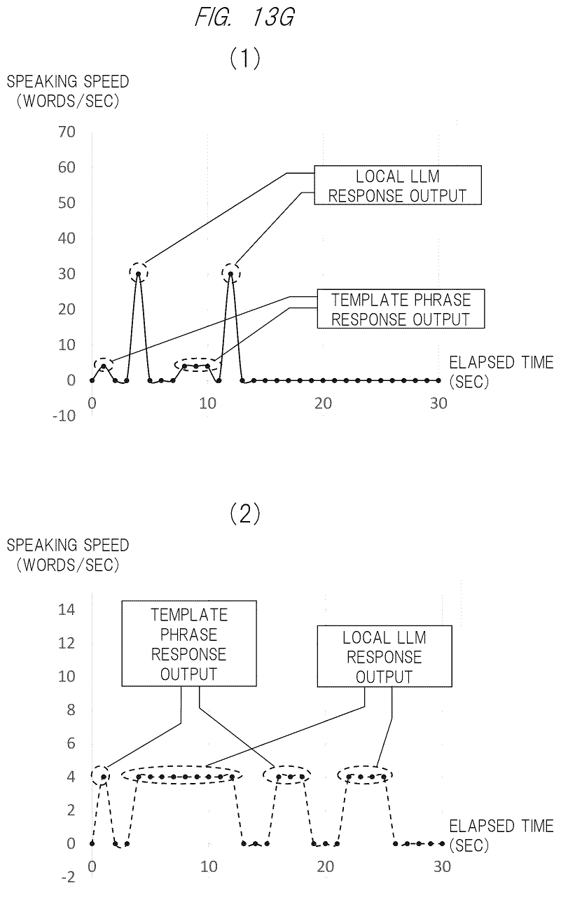

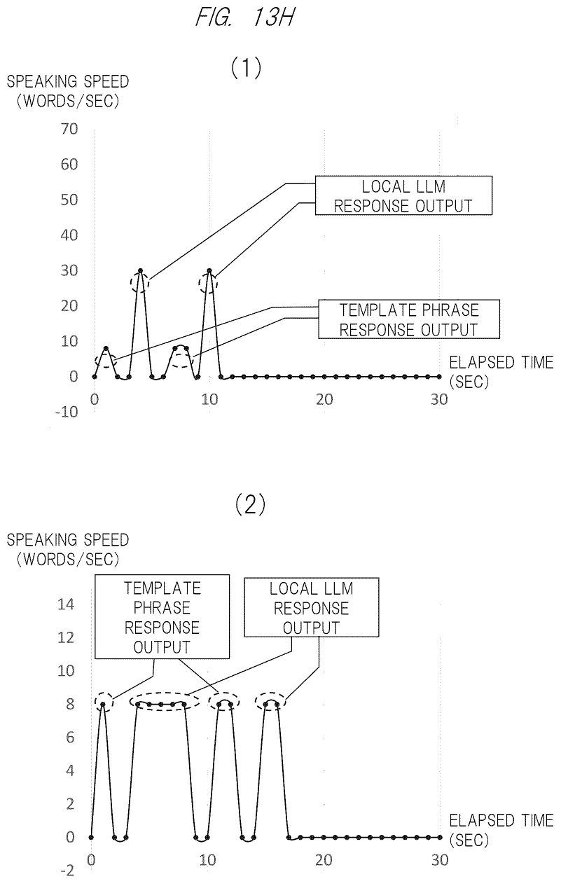

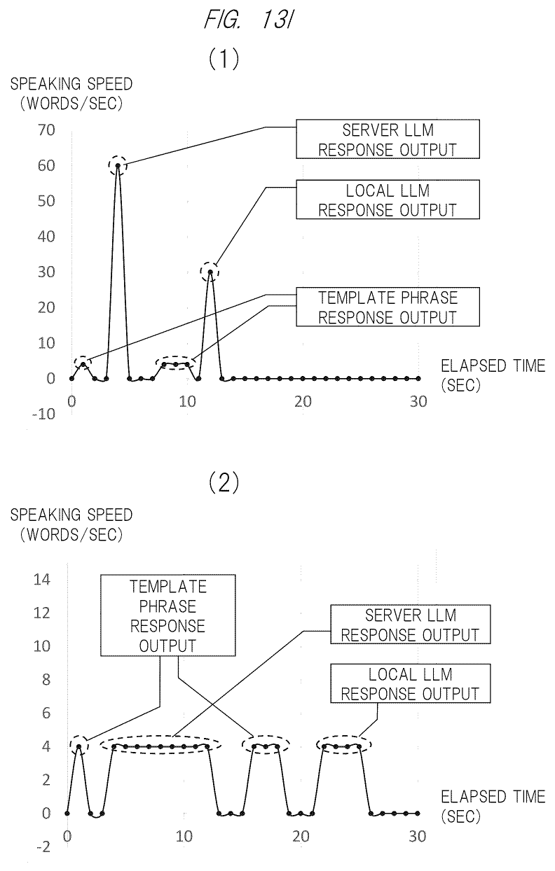

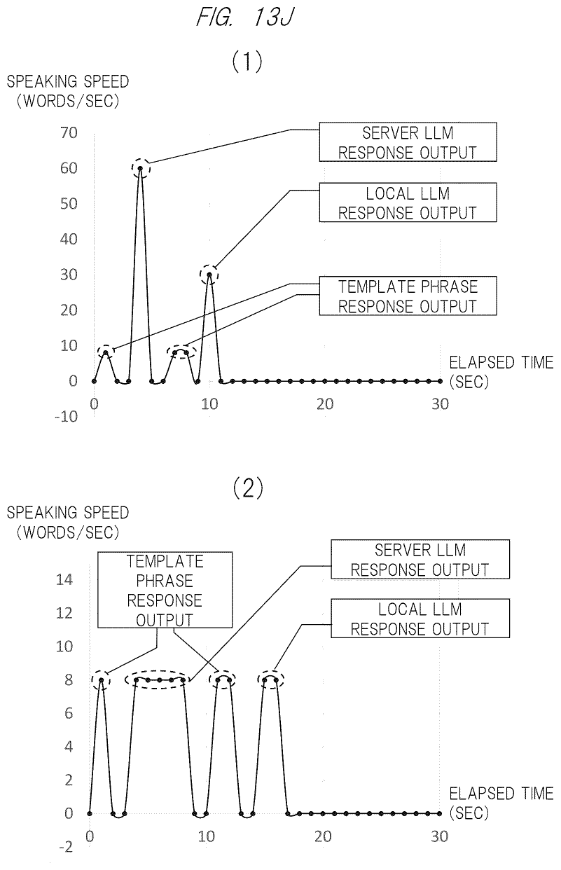

First, an example of settings in which the artificial intelligence response output system according to the present embodiment expresses the personality of each character by the speaking speed of the template phrases will be described with reference to FIG. 13A. Here, in the previous embodiments, four characters for which character IDs 1 to 4 were set has been described. The table shown in FIG. 13A shows information of settings regarding the speaking speed of these characters. The character IDs, names, and images of the character display for the four characters shown in FIG. 13A are the same as those of previous embodiments, and thus, redundant descriptions thereof are omitted as appropriate. In the table shown in FIG. 13A, the speaking speed of the template phrases for each character is set. Specifically, the speaking speed of the template phrases for the character Koto is set to 5 words per second. The speaking speed of the template phrases for the character Tom is set to 6 words per second. The speaking speed of the template phrases for the character Necco is set to 4 words per second. The speaking speed of the template phrases for the character Airia is set to 8 words per second. In the example of FIG. 13A, the unit of the speaking speed is set to words per second, but this is merely an example, and may be set to characters per second, tokens per second, words per minute, characters per minute, or tokens per minute. For example, in the Japanese language, the speaking speed for template phrases for the character Koto at 5 words per second and the character Tom at 6 words per second is typical of the speaking speed of standard human speech. Alternatively, the speaking speed for template phrases for the character Necco at 4 words per second can be considered a slower speaking speed. This makes it possible to provide the user with an impression that the character Necco has a laid-back personality. In addition, the speaking speed for template phrases for the character Airia at 6 words per second can be considered a fast speaking speed. This makes it possible to provide the user with an impression that the character Airia has a quick-thinking and efficient personality. In this manner, the speaking speed can also become a consistent and common characteristics that reflects the personality of each character, and thus, the information shown in the table of FIG. 13A can also be considered as information of the settings related to the conversation characteristics of a character. The information of the settings containing the speaking speed of the template phrases regarding these characters may be stored in the storage 1170 of the artificial intelligence response output apparatus 10010 of FIG. 1B or the like and may be used by the client application. Here, In the example of FIG. 13A, the settings are shown in a case where the client application does not perform speed adjustment control to bring the speaking speed of the natural language text of the response output of the large language model controlled by the LLM application closer to the speaking speed of the template phrases. Therefore, in the table information of FIG. 13A, the LLM response output speaking speed adjustment is “None, output as is” for all characters.

Next, an example in which the settings in the table information of FIG. 13A are modified to adjust the LLM response output speaking speed of each character will be described with reference to FIG. 13B. The settings shown in the table information of FIG. 13B differ only in the adjustment of the LLM response output speaking speed, while all other settings are the same as those in the table information of FIG. 13A. In the settings shown in the table information of FIG. 13B, the LLM response output speaking speed adjustment is “Yes, Bring closer to (Match) template phrase speaking speed”. The LLM response output speaking speed adjustment may perform an adjustment to bring the speaking speed of the response of the large language model acquired from the LLM application at least closer to the speaking speed of the template phrases when spoken as the response output of the character by the client application. Ideally, it is desirable that the speaking speed of the response of the large language model acquired from the LLM application is adjusted to be the same as the speaking speed of the template phrases when spoken as the response output of the character by the client application. However, depending on the performance of the inference of the large language model and the speed and conditions of the transmission path for the communication between LLM application and the client application, it may not always be possible to make such an adjustment, and thus, it is sufficient to bring the speaking speed of the response of the large language model at least closer to the speaking speed of the template phrases. As described above, the speaking speed can also become a consistent and common characteristics that reflects the personality of each character, and thus, the information shown in the table of FIG. 13B can also be considered as information of the settings related to the conversation characteristics of a character

Next, effects of the LLM response output speaking speed adjustment set in the table information of FIG. 13B will be described with reference to FIGS. 13C to 13J.

First, effects of the conversation example will be described with reference to FIG. 13C. In the conversation example of FIG. 13C, the client application first outputs the Template Phrase Response 1 of a greeting. Next, the user inputs the User Prompt 1 containing a question about Yokohama City, Japan into the artificial intelligence response output apparatus 10010. The client application sends the input User Prompt 1 to the LLM application. The LLM application having received the User Prompt 1 executes inference in the large language model based on the User Prompt 1 at a timing indicated by a star 9006. The LLM response generated by the large language model in the inference is sent from the LLM application to the client application, and is output as the LLM Response 1 from the client application of the artificial intelligence response output apparatus 10010 to the user. Next, the user inputs the User Prompt 2 containing a question about a distance between Tokyo and Yokohama into the artificial intelligence response output apparatus 10010. The client application sends the input User Prompt 2 to the LLM application. The LLM application having received the User Prompt 2 executes inference in the large language model based on the User Prompt 2 at a timing indicated by a star 9007. Here, the client application outputs the Template Phrase Response 2 of the back-channel feedback to prevent a long delay in responding to the user due to the execution time of the inference. The LLM response generated by the large language model in the inference is sent from the LLM application to the client application, and the LLM Response 2 is output to the user from the client application of the AI response output apparatus 10010. Note that, in the conversation example of FIG. 13C, for the sake of simplicity, the seventh to ninth embodiments of the present invention has omitted control using the consistent and common characteristic expressions (keywords) that constitute the personality of each character. This is only for the sake of simplicity, and in practice, it is desirable to apply this control in combination with the present embodiment.

Here, in the conversation example of FIG. 13C, the speaking speed of characters in a case where the settings shown in the table information of FIG. 13A are applied and a case where the settings shown in the table information of FIG. 13B are applied will be described with reference to FIGS. 13D to 13J using some of the characters.

First, in the conversation example of FIG. 13C, a case where the client application is performing a control to output the artificial intelligence response from the artificial intelligence response output apparatus 10010 as the response of the character Necco, and a case where the LLM Response 1 and the LLM Response 2 are responses generated by the large language model of the large language model server 20001 controlled by the server LLM application will be described with reference to FIG. 13D.

FIGS. 13D (1) and 13D (2) are both graphs. The vertical axis represents the speaking speed output from the artificial intelligence response output apparatus 10010. The horizontal axis represents elapsed time, indicating the elapsed time when the conversation example of FIG. 13C is output from the artificial intelligence response output apparatus 10010. Here, the speaking speed refers to the speaking speed of the audio output in a case where the output from the artificial intelligence response output apparatus 10010 to the user is audio output. In addition, the speaking speed refers to refers to the speed at which words are displayed in a case where the output from the artificial intelligence response output apparatus 10010 to the user is the word display output.

FIG. 13D (1) shows an example in which the settings shown in the table information of FIG. 13A are applied. In this case, the client application does not adjust the speaking speed of the server LLM response output (server LLM response output) as described in FIG. 13B. Here, the large language model installed on a server such as the large language model of the large language model server 20001 controlled by the server LLM application tend to require significant inference resources, enabling higher inference speed performance compared to the local large language models on various output apparatuses. Therefore, the result of not adjusting the speaking speed as described above for the server LLM response output is shown in FIG. 13D (1). Specifically, in FIG. 13D (1), a portion of the template phrase response output is output at the template phrase speaking speed of 4 words per second for the character Necco shown in FIG. 13A. This is a speed that expresses a laid-back tone. Alternatively, a portion of the server LLM response output is output as is, for example, at 60 words per second which is fast speaking speed for the large language model of the large language model server 20001 controlled by the server LLM application. In the example of FIG. 13D (1), even though the content is output from the artificial intelligence response output apparatus 10010 as the response of the character Necco, there is a fluctuation of more than 10 times in the speaking speed of the output text. That is, there are times when the output text is read slowly and times when it is read quite quickly. As a result, the user engaging in a series of conversations may feel a lack of consistency in the character's personality when receiving content output as the response of the character Necco from the artificial intelligence response output apparatus 10010.

In this regard, FIG. 13D (2) shows an example in which the settings shown in the table information of FIG. 13B are applied. In this case, the client application adjusts the speaking speed of the response output from the server LLM application (server LLM response output) described with reference to FIG. 13B. The inference speed performance of the large language model of the large language model server 20001 controlled by the server LLM application is the same as that of the example of FIG. 13D (1). The result of adjusting the speaking speed as described above for the server LLM response output is shown in FIG. 13D (2). Specifically, even if the response output from the server LLM application (server LLM response output) is output to the client application at a high speed of 60 words per second, the client application controls the speaking speed of the server LLM response output to bring it closer to the template phrase speaking speed of 4 words per second for the character Necco. FIG. 13D (2) shows an example in which the client application adjusts the speed so that the speaking speed of the server LLM response output is approximately the same as the template phrase speaking speed of the character Necco. As a result, the speaking speed of the response phrase output from the artificial intelligence response output apparatus 10010 as the response of the character Necco is brought close to the speaking speed of the template phrase response output even for a portion of the template phrase response output or a portion of the server LLM response output. In this manner, the user engaging in a series of conversations can be provided with a more consistent impression for the character's personality regarding the response output from the artificial intelligence response output apparatus 10010 as the response of the character Necco, as the speaking speed of the response during the conversation is natural.

Next, in the conversation example of FIG. 13C, a case where the client application is performing a control to output the artificial intelligence response from the artificial intelligence response output apparatus 10010 as the response of the character Airia, and a case where the LLM Response 1 and the LLM Response 2 are responses generated by the large language model of the large language model server 20001 controlled by the server LLM application will be described with reference to FIG. 13E.

FIGS. 13E (1) and 13E (2) are both graphs. The vertical axis and the horizontal axis are the same as those described with reference to FIGS. 13D (1) and 13D (2), and thus, redundant descriptions thereof are omitted as appropriate. FIG. 13E (1) shows an example in which the speaking speed adjustment shown in FIG. 13A is not performed for the server LLM response output as in the LLM response output. FIG. 13E (2) shows an example in which the speaking speed adjustment is performed on the server LLM response output as in the LLM response output shown in FIG. 13B. These examples are examples of control in which the client application outputs the artificial intelligence response from the artificial intelligence response output apparatus 10010 as a response of the character Airia, and thus, in both graphs, the template phrase speaking speed is 8 words per second, which is fast speaking.

However, if the response from the large language model of the large language model server 20001 controlled by the server LLM application is output as is, the speed would be 60 words per second which is a faster speaking. As a result, as shown in FIG. 13E (1), if the speaking speed adjustment of the server LLM response output is not performed, there would be a fluctuation of several times in the speaking speed of the output text. In this case, the user engaging in a series of conversations may feel a lack of consistency in the character's personality when receiving content output from the artificial intelligence response output apparatus 10010 as the response of the character Airia since the speaking speed would change unnaturally during the conversation.

Alternatively, as shown in FIG. 13E (2), in a case where the speaking speed adjustment is performed on the LLM response output described with reference to FIG. 13B in the server LLM response output, even if the response output from the server LLM application (server LLM response output) is output to the client application at a high speed of 60 words per second, the client application controls the speaking speed of the server LLM response output to bring it closer to the template phrase speaking speed of 8 words per second for the character Airia. FIG. 13E (2) shows an example in which the client application adjusts the speed so that the speaking speed of the server LLM response output is approximately the same as the template phrase speaking speed of the character Airia. As a result, the speaking speed of the response phrase output from the artificial intelligence response output apparatus 10010 as the response of the character Airia is brought close to the speaking speed of the template phrase response output even for a portion of the template phrase response output or a portion of the server LLM response output. In this manner, the user engaging in a series of conversations can be provided with a more consistent impression for the character's personality regarding the response output from the artificial intelligence response output apparatus 10010 as the response of the character Airia, as the speaking speed of the response during the conversation is natural.

Next, FIG. 13F shows a graph superimposed on the graph of FIG. 13D (2) which shows the results of the speaking speed adjustment of the LLM response output as the response of the character Necco (character ID 3) described in FIG. 13B, and the graph of FIG. 13E (2) which shows the results of the speaking speed adjustment of the LLM response output as the response of the character Airia (character ID 4) described in FIG. 13B.

As shown in FIG. 13F, the speaking speed of the response of the character Airia is close to the template phrase speaking speed of 8 words per second for the character Airia for all responses. In the character Airia's response, the speaking speed is natural, with little fluctuation. In addition, as shown in FIG. 13F, the speaking speed of the response of the character Necco is slow and close to the template phrase speaking speed of 4 words per second for the character Necco for all responses. In the character Necco's response, the speaking speed is natural, with little fluctuation. Nevertheless, in the example of FIG. 13F, it is possible to clearly distinguish between the speaking speed of character Airia's response and that of character Necco's response. That is, in the speaking speed adjustment of the LLM response output described with reference to FIG. 13B, the speaking speed adjustment of the LLM response output is performed based on the template phrase speaking speed set for each character stored in the table information of FIG. 13B, and thus, the speed adjustment results reflect the personality of each character. This differs from systems and apparatuses that use a uniform speaking speed regardless of the character outputting the response in that, the speaking speed adjustment of the LLM response output described with reference to FIG. 13B can achieve an output control of a more natural artificial intelligence response that suppresses fluctuation of the speaking speed while suitably reflecting the personality of each character.

Next, in the conversation example of FIG. 13C, a case where the client application is performing a control to output the artificial intelligence response from the artificial intelligence response output apparatus 10010 as the response of the character Necco, and a case where the LLM Response 1 and the LLM Response 2 are responses generated by the large language model of the local LLM processor 10028 controlled by the local LLM application will be described with reference to FIG. 13G.

The graph of FIG. 13G (1) shows an example in which the speaking speed adjustment of the LLM response output described with reference to FIG. 13B is not performed for the local LLM response generated by the large language model of the local LLM processor 10028. This differs from the graph of FIG. 13D (1) in that the response output from the server LLM application (server LLM response output) is changed to the local LLM response output generated by the large language model of the local LLM processor 10028, causing the local LLM response to be output to the client application at 30 words per second which is slower than the server LLM response. Other portions are the same as those of the graph of FIG. 13D (1), and thus, redundant descriptions thereof are omitted as appropriate. Even if the local LLM response is 30 words per second, this is fast enough compared to the template phrase speaking speed of the character Necco at 4 words per second, resulting in some fluctuations. Therefore, the user engaging in a series of conversations may feel a lack of consistency in the character's personality when receiving content output from the artificial intelligence response output apparatus 10010 as the response of the character Necco since the speaking speed would change unnaturally during the conversation.

Alternatively, the graph of FIG. 13G (2) shows an example in which the speaking speed adjustment of the LLM response output described with reference to FIG. 13B is performed for the local LLM response generated by the large language model of the local LLM processor 10028. This differs from the graph of FIG. 13D (2) in that the response output from the server LLM application (server LLM response output) is changed to the local LLM response output generated by the large language model of the local LLM processor 10028. Other portions are the same as those of the graph of FIG. 13D (2), and thus, redundant descriptions thereof are omitted as appropriate. In the example of FIG. 13G (2) also, even if the response output from the local LLM application (local LLM response output) to the client application is 30 words per second, the client application controls the speaking speed of the local LLM response output to bring it closer to the template phrase speaking speed of 4 words per second for the character Necco. FIG. 13G (2) shows an example in which the client application adjusts the speed so that the speaking speed of local LLM response output is approximately the same as the template phrase speaking speed of the character Necco. As a result, the speaking speed of the response phrase output from the artificial intelligence response output apparatus 10010 as the response of the character Necco is brought close to the speaking speed of the template phrase response output even for a portion of the template phrase response output or a portion of the local LLM response output. In this manner, the user engaging in a series of conversations can be provided with a more consistent impression for the character's personality regarding the response output from the artificial intelligence response output apparatus 10010 as the response of the character Necco, as the speaking speed of the response during the conversation is natural.

Next, in the conversation example of FIG. 13C, a case where the client application is performing a control to output the artificial intelligence response from the artificial intelligence response output apparatus 10010 as the response of the character Airia, and a case where the LLM Response 1 and the LLM Response 2 are responses generated by the large language model of the local LLM processor 10028 controlled by the local LLM application will be described with reference to FIG. 13H.

FIGS. 13H (1) and 13H (2) are both graphs. The vertical axis and the horizontal axis are the same as those described with reference to FIGS. 13G (1) and 13G (2), and thus, redundant descriptions thereof are omitted as appropriate. FIG. 13H (1) shows an example in which the speaking speed adjustment of the LLM response output shown in FIG. 13A is not performed for the local LLM response output. FIG. 13H (2) shows an example in which the speaking speed adjustment of the LLM response output as shown in FIG. 13B is performed on the local LLM response output.

The results in FIG. 13H (1) differ from those in FIG. 13G (1) only in that the speaking speed of the template phrase response is 8 words per second for the character Airia. Other portions are the same as those of the graph of FIG. 13G (1), and thus, redundant descriptions thereof are omitted as appropriate. Even at 30 words per second for the local LLM response, the speaking speed is fast enough compared to the 8 words per second for the template phrase speaking speed of the character Airia, and thus there would be a fluctuation in the speaking speed. Therefore, the user engaging in a series of conversations may feel a lack of consistency in the character's personality regarding the response output from the artificial intelligence response output apparatus 10010 as the response of the character Airia since the speaking speed would change unnaturally during the conversation.

The results in FIG. 13H (2) differ from those in FIG. 13G (2) only in that a control is performed to bring the speaking speed after the speaking speed adjustment of the LLM response output closer to the template phrase speaking speed of the character Airia at 8 words per second. Other portions are the same as those of the graph of FIG. 13G (2), and thus, redundant descriptions thereof are omitted as appropriate. As a result, the speaking speed of the response phrase output from the artificial intelligence response output apparatus 10010 as the response of the character Airia is brought close to the speaking speed of the template phrase response output even for a portion of the template phrase response output or a portion of the local LLM response output. In this manner, the user engaging in a series of conversations can be provided with a more consistent impression for the character's personality regarding the response output from the artificial intelligence response output apparatus 10010 as the response of the character Airia, as the speaking speed of the response during the conversation is natural.

Note that the graph showing the results of the speaking speed adjustment of the LLM response output shown in FIG. 13G (2) for the character Necco and the results of the speaking speed adjustment of the LLM response output shown in FIG. 13H (2) for the character Airia are the same as described with reference to FIG. 13F. That is, according to the control example described with reference to FIG. 13G (2) and the control example described with reference to FIG. 13H (2), even in a case where the local LLM response generated by the large language model of the local LLM processor 10028 controlled by the local LLM application is used, the speaking speed adjustment of the LLM response output is performed based on the template phrase speaking speed set for each character stored in the table information of FIG. 13B, and thus, the speed adjustment results reflect the personality of each character.

Next, in the conversation example of FIG. 13C, a case where the client application performs a control to output the artificial intelligence response from the artificial intelligence response output apparatus 10010 as the response of the character Necco, and a case where the LLM Response 1 is the response generated by the large language model of the large language model server 20001 controlled by the server LLM application, and the LLM Response 2 is the response generated by the large language model of the local LLM processor 10028 controlled by the local LLM application will be described with reference to FIG. 13I. That is, in this example, the client application outputs a mixture of responses including the template phrase response, the server LLM response, and the local LLM response in the output of the artificial intelligence response from the artificial intelligence response output apparatus 10010 in a series of conversations.

The graph of FIG. 13I (1) shows an example in which the speaking speed adjustment of the LLM response output described with reference to FIG. 13B is not performed for the server LLM response generated by the large language model of the large language model server 20001 controlled by the server LLM application and for the local LLM response generated by the large language model of the local LLM processor 10028. This differs from the graph of FIG. 13D (1) in that it is a mixture of the server LLM response generated by the large language model of the large language model server 20001 controlled by the server LLM application and the local LLM response generated by the large language model of the local LLM processor 10028. The server LLM response is output to the client application at 60 words per second, and the local LLM response is output to the client application at 30 words per second which is slower than the server LLM response. Other portions are the same as those of the graph of FIG. 13D (1), and thus, redundant descriptions thereof are omitted as appropriate. The server LLM response speaking speed becomes 60 words per second and the local LLM response speaking speed becomes 30 words per second, and the template phrase speaking speed for the character Necco becomes 4 words per second, and thus, there would be a fluctuation in the speaking speed. Therefore, the user engaging in a series of conversations may feel a lack of consistency in the character's personality when receiving content output from the artificial intelligence response output apparatus 10010 as the response of the character Necco since the speaking speed would change unnaturally during the conversation.

Alternatively, the graph of FIG. 13I (2) shows an example in which the speaking speed adjustment of the LLM response output described with reference to FIG. 13B is performed on the server LLM response generated by the large language model of the large language model server 20001 controlled by the server LLM application and the local LLM response generated by the large language model of the local LLM processor 10028. This differs from the graph of FIG. 13D (2) in that it is a mixture of the server LLM response generated by the large language model of the large language model server 20001 controlled by the server LLM application and the local LLM response generated by the large language model of the local LLM processor 10028. Other portions are the same as those of the graph of FIG. 13D (2), and thus, redundant descriptions thereof are omitted as appropriate.

In the example of FIG. 13I (2) also, even if the response output from the server LLM application (server LLM response output) is output to the client application at a high speed of 60 words per second, or even if the response output from the local LLM application (local LLM response output) is output to the client application at a high speed of 30 words per second, the client application controls the speaking speed of the server LLM response output and the speaking speed of the local LLM response output to bring them closer to the template phrase speaking speed of 4 words per second for the character Necco. FIG. 13I (2) shows an example in which the client application adjusts the speed so that the speaking speed of the server LLM response output and the speaking speed of the local LLM response output are approximately the same as the template phrase speaking speed of the character Necco. As a result, the speaking speed of the response phrase output from the artificial intelligence response output apparatus 10010 as the response of the character Necco is brought close to the speaking speed of the template phrase response output even for a portion of the template phrase response output, or a portion of the server LLM response output, or a portion of the local LLM response output. In this manner, the user engaging in a series of conversations can be provided with a more consistent impression for the character's personality regarding the response output from the artificial intelligence response output apparatus 10010 as the response of the character Necco, as the speaking speed of the response during the conversation is natural.

Next, in the conversation example of FIG. 13C, a case where the client application is performing a control to output the artificial intelligence response from the artificial intelligence response output apparatus 10010 as the response of the character Airia, and a case where the LLM Response 1 is the response generated by the large language model of the large language model server 20001 controlled by the server LLM application and the LLM Response 2 is the response generated by the large language model of the local LLM processor 10028 controlled by the local LLM application will be described with reference to FIG. 13J. That is, in this example also, the client application outputs a mixture of responses including the template phrase response, the server LLM response, and the local LLM response in the output of the artificial intelligence response from the artificial intelligence response output apparatus 10010 in a series of conversations.

FIGS. 13J (1) and 13J (2) are both graphs. The vertical axis and the horizontal axis are the same as those described with reference to FIGS. 13I (1) and 13I (2), and thus, redundant descriptions thereof are omitted as appropriate. FIG. 13J (1) shows an example in which the speaking speed adjustment of the LLM response output shown in FIG. 13A is not performed for the server LLM response output and the local LLM response output. FIG. 13J (2) shows an example in which the speaking speed adjustment of the LLM response output as shown in FIG. 13B is performed on the local LLM response output.

The results in FIG. 13J (1) differ from those in FIG. 13I (1) only in that the speaking speed of the template phrase response is 8 words per second for the character Airia. Other portions are the same as those of the graph of FIG. 13I (1), and thus, redundant descriptions thereof are omitted as appropriate. Even at 60 words per second for the server LLM response or at 30 words per second for the local LLM response the speaking speed is fast enough compared to the 8 words per second for the template phrase speaking speed of the character Airia, and thus there would be a fluctuation in the speaking speed. Therefore, the user engaging in a series of conversations may feel a lack of consistency in the character's personality when receiving content output from the artificial intelligence response output apparatus 10010 as the response of the character Airia since the speaking speed would change unnaturally during the conversation.

The results in FIG. 13J (2) differ from those in FIG. 13I (2) only in that a control is performed to bring the speaking speed after the speaking speed adjustment of the LLM response output closer to the template phrase speaking speed of the character Airia at 8 words per second. Other portions are the same as those of the graph of FIG. 13I (2), and thus, redundant descriptions thereof are omitted as appropriate. As a result, the speaking speed of the response phrase output from the artificial intelligence response output apparatus 10010 as the response of the character Airia is brought close to the speaking speed of the template phrase response output even for a portion of the template phrase response output, or a portion of the server LLM response output, or a portion of the local LLM response output. In this manner, the user engaging in a series of conversations can be provided with a more consistent impression for the character's personality regarding the response output from the artificial intelligence response output apparatus 10010 as the response of the character Airia, as the speaking speed of the response during the conversation is natural.

Note that the graph showing the results of the speaking speed adjustment of the LLM response output shown in FIG. 13I (2) for the character Necco and the results of the speaking speed adjustment of the LLM response output shown in FIG. 13J (2) for the character Airia are the same as described with reference to FIG. 13F. That is, according to the control example described with reference to FIG. 13I (2) and the control example described with reference to FIG. 13J (2), even in a case where the server LLM response generated by the large language model of the large language model server 20001 controlled by the server LLM application is used, or in a case where the local LLM response generated by the large language model of the local LLM processor 10028 controlled by the local LLM application is used, the speaking speed adjustment of the LLM response output is performed based on the template phrase speaking speed set for each character stored in the table information of FIG. 13B, and thus, the speed adjustment results reflect the personality of each character.

As described in the tenth embodiment of the present inventio, when performing the speaking speed adjustment of the LLM response output, it is desirable to adjust the silence period for speaking at the insertion positions of spaces and newline symbols in the LLM response so that they are variable in accordance with the template phrase speaking speed for each character shown in the table information of FIG. 13B. This is because, in a slow tone, a longer silence period at the insertion positions of spaces and newline symbols is more suitable, while in a faster tone, a shorter silence period at the insertion positions of spaces and newline symbols is more suitable. In this manner, it is possible to express the personality of each character by varying the length of the silence period according to the template phrase speaking speed of each character.

As described above with reference to FIG. 2H, when the switch processing of the character is performed, the client application may switch the settings of the speaking speed of the template phrase and response phrase, which are the settings related to the conversation characteristics of a character shown in FIG. 13B, in accordance with the switch processing of the character.

As described above with reference to FIGS. 13A to 13J, in the artificial intelligence response output system of the present embodiment, the client application of the artificial intelligence response output apparatus 10010 performs a control to adjust the speed to bring the speaking speed of the character when the character is speaking closer to the speaking speed of the template phrase response defined for each character even for a portion of the response generated by the large language model. In this manner, the user can be provided with a more consistent impression regarding the character's personality as the speaking speed of the response during the conversation is natural.

Note that the control of the speaking speed of the response according to the above-described tenth embodiment of the present invention may be combined with and applied to various controls used by consistent and common characteristic expressions (keywords) which become the personality of each character described above in the seventh to ninth embodiments. In addition, the template phrase response controlled by the client application of the artificial intelligence response output apparatus 10010 may be output by audio synthesis based on the text information, or may be output with an audio data of a pre-recorded human voice as the template phrase response. In this case also, the speaking speed of the audio data of the human voice may be the speaking speed of the template phrase response described in the present embodiment. That is, the speed adjustment may be performed to bring the speaking speed when the character is speaking closer to the speaking speed of the audio data of the pre-recorded human voice which is the template phrase response of the character even for a portion of the response generated by the large language model.

### Eleventh Embodiment

Next, an eleventh embodiment of the present invention will be described. In the seventh to ninth embodiments of the present invention, an example has been described in which various controls are performed in the artificial intelligence response output system such that the client application and the LLM application cooperate with each other to ensure that consistent and common characteristic expressions (keywords) that constitute the personality of each character are used to perform the series of artificial intelligence response outputs. These controls are intended to achieve an effect in which the user is provided with a more consistent impression for the character's personality regarding the content output from the artificial intelligence response output system. Here, when the consistent and common characteristic expressions (keywords) that constitute the personality of each character in the above-described embodiments are used and output as audio output from the artificial intelligence response output apparatus 10010, it is possible for the user to more clearly perceive the personality of each character by controlling the intonation of a portion of the characteristic expression (keyword). Thus, in the eleventh embodiment of the present invention, in the artificial intelligence response output system, the client application of the artificial intelligence response output apparatus 10010 more suitably controls the intonation in the audio output when the character speaks the characteristic expressions (keywords) for each character.

The eleventh embodiment is a modified version of the artificial intelligence response output apparatus 10010 or artificial intelligence response output system according to the first to tenth embodiments described with reference to the drawings. Specifically, in the response output processing of the artificial intelligence response output apparatus 10010, the client application controls the intonation in the audio output for the portion of the characteristic expressions (keywords) for each character contained in the template phrase response or in the response of the large language model controlled by the LLM application in accordance with an LLM preset instruction. In the present embodiment, only differences from the above-described embodiments will be described, and descriptions of configurations similar to those of the embodiments will be omitted as appropriate.

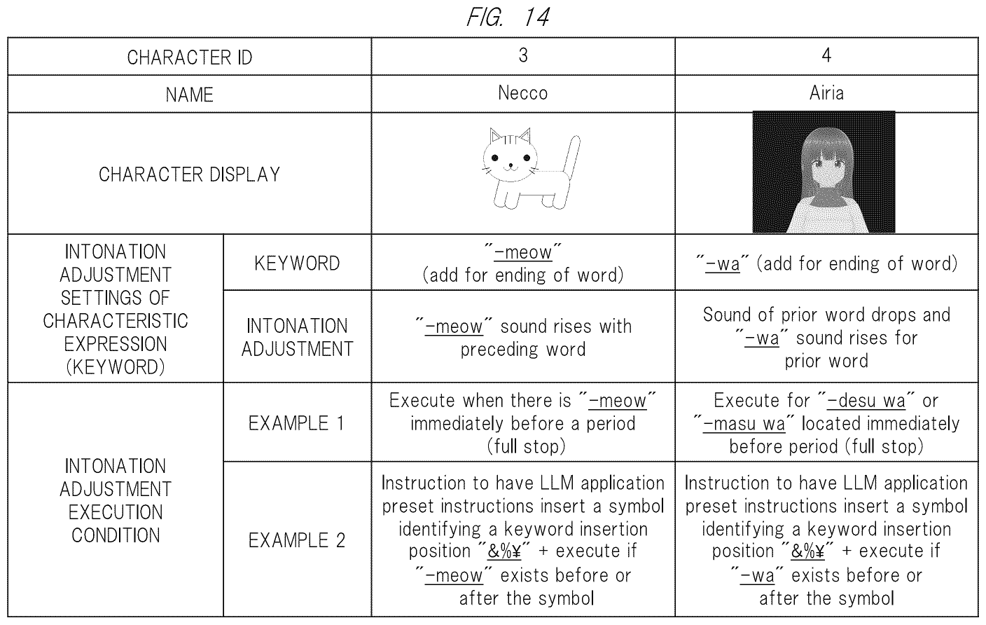

FIG. 14 shows an example of the table information that stores the setting information for controlling the intonation in the audio output for the portion of the characteristic expressions (keywords) for each character. The character IDs, names, and images of the character display in the table information of FIG. 14 are the same as those of the table information of FIG. 9E, and thus, redundant descriptions thereof are omitted as appropriate. The information shown in the table of FIG. 14 may be stored in the storage 1170 or the memory 1109 of the artificial intelligence response output apparatus 10010 shown in FIG. 1B as table information. This may be utilized by the client application.

Here, the information regarding the intonation adjustment settings of the characteristic expressions (keywords) for each character is stored in the table information of FIG. 14, and the target keyword and the content of the intonation adjustment for the keyword are stored for each character. As shown in the table of FIG. 14, the settings information regarding the intonation adjustment for enhancing the personality of each character can be considered to be the settings information related to the conversation characteristics of a character. In a case where the switch processing of the character as described with reference to FIG. 2H is performed, the client application may switch the settings regarding the intonation adjustment which constitute the conversation characteristics of a character shown in FIG. 14 in accordance with the switch processing of the character.

For example, using the control in the above-described embodiments which use the table information such as those shown in FIG. 9E, 10B, or 11A, the keyword “-meow” added to the ending of a phrase by the character Necco corresponds to the characteristic expression. In the example of FIG. 14, the character Necco has the phrase “-meow” set as a keyword to be adjusted for intonation. In addition, in the example of FIG. 14, the content of the intonation adjustment for the keyword “-meow” is set to “‘-meow’ sound rises with preceding word”. Here, the content of the intonation adjustment is described with a sentence, but it is also possible to set the absolute or relative pitch of each word in specific numerical values. The client application of the artificial intelligence response output apparatus 10010 executes intonation adjustment so that when audio is output as the response for the character Necco, if “-meow” is added to the end of a phrase, the “-meow” sound rises for the preceding word.

In addition, for example, using the control in the above-described embodiments which use the table information such as those shown in FIG. 9E, 10B, or 11A, the keyword “-wa” added to the ending of a phrase by the character Airia corresponds to the characteristic expression. In the example of FIG. 14, the character Airia has the phrase “-wa” set as a keyword to be adjusted for intonation. In addition, in the example of FIG. 14, the content of the intonation adjustment for the keyword “-wa” is set to “Sound of prior word drops and ‘-wa’ sound rises for preceding word”. Here, the content of the intonation adjustment is described with a sentence, but it is also possible to set the absolute or relative pitch of each word in specific numerical values. The client application of the artificial intelligence response output apparatus 10010 executes intonation adjustment so that when audio is output as the response for the character Airia, if “-wa” is added to the end of a phrase, the sound of the prior word drops and the “-wa” sound rises for the preceding word.

Note that the client application of the artificial intelligence response output apparatus 10010 may execute the intonation adjustment processing by controlling the audio output unit 1140 to adjust the pitch of the synthesized audio stored in the memory 1109 of FIG. 1B.

Here, the setting information stored in the table information of FIG. 14 may include intonation adjustment execution conditions which are information regarding the conditions under which intonation adjustment is executed. The client application may use these intonation adjustment execution conditions to determine the portions of the response output from the artificial intelligence response output apparatus 10010 where intonation adjustment should be executed. In the example of FIG. 14, two examples of intonation adjustment execution conditions are shown: a first example (Example 1) and a second example (Example 2). The client application of the artificial intelligence response output apparatus 10010 may use either example. Alternatively, the client application of the artificial intelligence response output apparatus 10010 may switch between the two examples by the settings or the like.

First, the first example of the intonation adjustment execution conditions of FIG. 14 is an example in which the characteristic expressions (keywords) for each character and a position relationship between special characters such as periods, commas, newline symbols, or spaces before and after the characteristic expressions are used as conditions for determining the parts where intonation adjustment is to be executed. In Example 1 of FIG. 14, for example, intonation adjustment is executed for the character Necco when the keyword “-meow” is located immediately before a period. This makes it possible for the characteristic expression (keyword) indicating the character Necco's personality to be attached to the end of a phrase in the part that meets the condition. Therefore, this can be considered a suitable condition for performing intonation adjustment for the character Necco. In Example 1 of FIG. 14, intonation adjustment is executed or the character Airia when the keyword “-desu wa” or “-masu wa” is located immediately before a period. The phrase “-wa” is a characteristic expression (keyword) that indicates the character Airia's personality and is simple, short, and single character, and thus, if all instances of “wa” contained in other words are recognized as characteristic expressions (keywords), intonation adjustment may be performed on unnecessary parts. Thus, as in the present conditions, multiple second keywords may be prepared that include the keyword and are suitable for use as characteristic expressions of the keyword, and the intonation adjustment may be executed based on the conditions that these second keywords appear. In the conditions for the character Airia in Example 1 of FIG. 14, the phrases “-desu wa” and “-masu wa” which contain the keyword “-wa” are included in the conditions as second keywords. In this manner, even if “-wa” is just a single character, when it is included in the second keywords “-desu wa” and “-masu wa”, it is highly likely that it is being used as a characteristic expression that indicates the character Airia's personality. In this manner, it is highly likely that the parts that match the conditions will have characteristic expressions (keywords) that indicate the character Airia's personality attached to the end of a phrase. Therefore, this can be considered a suitable condition for performing intonation adjustment for the character Airia.

First, in the second example of intonation adjustment execution conditions of FIG. 14, the client application includes in the LLM application preset instruction described with reference to FIG. 7 an instruction to insert a symbol identifying keyword insertion position that identifies the position where a keyword is inserted into the LLM response at the position where the keyword is inserted as a characteristic expression that indicates the personality of each character. In the example of FIG. 14, “&%Y” is shown as an example of the symbol identifying keyword insertion position. For example, it is instructed to be inserted immediately before or immediately after the keyword. The LLM application that acquires the LLM application preset instruction from the client application executes, for example, inference on the large language model in accordance with the instructions such as the favorite saying or back-channel feedback including the characteristic expressions (keywords) indicating the personality of each character as shown in FIGS. 9E and 10B, and then generates the LLM response phrase with the symbol identifying keyword insertion position “&%Y” inserted at the position where the keyword is used in the response phrase. The client application that acquires the LLM response phrase from the LLM application identifies the position of the symbol identifying keyword insertion position “&%Y” and identifies the characteristic expression (keyword) indicating the personality of each character located immediately before or after it. The client application identifies specific keywords and determines which parts require intonation adjustment, then executes the intonation adjustment. That is, in Example 2 of FIG. 14, the client application sets the condition for executing intonation adjustment as when a keyword is present immediately before or after the symbol identifying keyword insertion position “&%Y”. Note that, before outputting the LLM response phrase to the user as the artificial intelligence response from the artificial intelligence response output apparatus 10010, the client application deletes the symbol identifying keyword insertion position “&%Y”. In addition, “&%Y” is merely an example, and other symbols may be used. It is desirable that the symbol identifying keyword insertion position does not include characters from a natural language that represent vowels. This is because, in the unlikely event that the client application fails to delete the symbol identifying keyword insertion position before the user output, including natural language words that represent vowels in the symbol could result in those words being pronounced as part of the character's voice during audio output. If the symbol does not include natural language words that represent vowels, even if the deleting t fails as described above, the symbol cannot be spoken, and thus, it is suitable that the artificial intelligence response output apparatus 10010 ignores the symbol for audio output.

Note that, as a specific example of Example 2 in FIG. 14 the control example for the character Necco will be described. First, the LLM application preset instruction for the character Necco includes the instruction to insert the symbol identifying keyword insertion position “&%Y” at the position where the keyword “-meow” which is a characteristic expression indicating the character Necco's personality. After the processing of the above-described LLM application, the client application acquires the LLM response phrase containing the keyword “-meow” and the symbol identifying keyword insertion position “&%Y”. The client application identifies the phrase “-meow” located before or after the symbol identifying keyword insertion position “&%Y” in the LLM response phrase as part of the keyword included in the LLM response as characteristic expression indicating the character Necco's personality. The client application executes the intonation adjustment for the character Necco on the part of the keyword “-meow”. The symbol identifying keyword insertion position “&%Y” generated by the large language model with the keyword “-meow” inserted is likely to be the position of a characteristic expression that indicates the character Necco's personality. Therefore, this can be said to be a suitable condition for performing intonation adjustment for the character Necco.

In addition, as a specific example of Example 2 in FIG. 14, the control example for the character Airia will be described. First, the LLM application preset instruction for the character Airia includes the instruction to insert the symbol identifying keyword insertion position “&%Y” at the position where the keyword “-wa” which is a characteristic expression indicating the character Airia's personality. After the processing of the above-described LLM application, the client application acquires the LLM response phrase containing the keyword “-wa” and the symbol identifying keyword insertion position “&%Y”. The client application identifies the phrase “-wa” located before or after the symbol identifying keyword insertion position “&%Y” in the LLM response phrase as part of the keyword included in the LLM response as characteristic expression indicating the character Airia's personality. The client application executes the intonation adjustment for the character Airia on the part of the keyword “-wa”. The symbol identifying keyword insertion position “&%Y” generated by the large language model with the keyword “-wa” inserted is likely to be the position of a characteristic expression that indicates the character Necco's personality. Therefore, this can be said to be a suitable condition for performing intonation adjustment for the character Necco.

As described above with reference to FIG. 14, in the artificial intelligence response output system of the present embodiment, the client application of the artificial intelligence response output apparatus 10010 performs intonation adjustment processing to control the intonation of the characteristic expressions (keywords) that constitute the personality of each character contained in the response phrase. This make is possible for the user to more clearly perceive the personality of each character. In addition, by using conditions that combine special characters or symbols in the response phrase with the above-described keywords as conditions for the intonation adjustment processing, it is possible to perform more suitable control of intonation adjustment processing in the audio output when speaking the characteristic expressions (keywords) for each character.

Note that the control of the intonation adjustment processing according to the eleventh embodiment of the present invention described above may be applied in combination with various controls described in the seventh to tenth embodiments.

The term “character” as used in each embodiment of the present invention described above includes the concepts of AI assistants and avatars.

The table information for various controls described in the seventh to eleventh embodiments of the present invention is information on various settings related to the characteristics of the character conversations, but the output medium for character conversations is mainly natural language. Therefore, if the language output for the character's conversation differs, the various setting information related to the conversation characteristics of the character must also be set differently. Therefore, when the artificial intelligence response output apparatus 10010 of these embodiments is capable of switching between multiple languages as the language output for the character's conversation, the various setting information related to the conversation characteristics of the character corresponding to each of the multiple languages may be stored in the storage 1170 or the memory 1109. When the artificial intelligence response output apparatus 10010 switches the language of the output of the characters' conversations, it is desirable to switch the table information used for the various controls described in the seventh to eleventh embodiments of the present invention.

In particular, regarding the intonation adjustment described in the eleventh embodiment, even if it is a setting intended to make the personality of each character more distinct within the same language, changes in intonation may take on different meanings in different languages. For example, in Japanese, it is easy to use intonation adjustments at the end of words or sentences to make the personality of each character more distinct. However, in English, changing the intonation at the end of words or sentences can alter the meaning of the sentence. For example, raising the pitch at the end of a word or sentence can make it sound like a question. For example, if intonation adjustment settings configured to make each character's personality more distinct to users in Japanese are applied directly to English, it may change the meaning of the sentence and be inappropriate. To prevent this, when the artificial intelligence response output apparatus 10010 can switch between multiple languages as the output language for the characters' conversations, it is desirable to switch the settings related to the characteristics of the characters' conversations regarding intonation adjustment as described in the eleventh embodiment. In the artificial intelligence response output apparatus 10010, if the settings related to the conversation characteristics of the character regarding intonation adjustment are only available for a specific language, when switching the language setting for the output of a character's conversation from that specific language to another language, it is desirable to disable the intonation adjustment function.

In addition, the technology described in the present embodiment makes it possible to provide more suitable artificial intelligence response output technology. Such artificial intelligence response output technology is expected to be introduced into infrastructure that is of higher quality and more reliable. As this technology is introduced into infrastructure, it will contribute to economic development and human welfare by prioritizing affordable and equitable access for all people. This will contribute to the United Nations' Sustainable Development Goals (SDGs) “9: Build resilient infrastructure, promote inclusive and sustainable industrialization, and foster innovation.”

In addition, the technology of the present embodiment makes it possible to provide a more suitable artificial intelligence response output technology. Such artificial intelligence response output technology is expected to be introduced into public transportation facilities to improve accessibility to transportation systems for people in vulnerable positions. The introduction of this technology into public transportation systems is expected to contribute to improving traffic safety through the expansion of public transportation systems, as well as realizing access to sustainable transportation systems that are safe, affordable, and easily accessible to all people. This will contribute to the United Nations' Sustainable Development Goals (SDGs) “11: Sustainable Cities and Communities”.

The above describes various embodiments in detail; however, the present invention is not limited to the embodiments described above and includes various modifications. For example, the above-described embodiments are detailed descriptions of the entire system for the purpose of clearly explaining the present invention and are not necessarily limited to having all the described configurations. Furthermore, it is possible to replace part of the configuration of one embodiment with the configuration of another embodiment, and it is also possible to add the configuration of another embodiment to the configuration of one embodiment. Additionally, it is possible to add, delete, or replace part of the configuration of each embodiment with other configurations.

What is claimed is:

1. A response output apparatus comprising:
an input interface configured to receive a user input;
a controller;
a storage; and
an output interface configured to output a response to a user,
wherein the controller is capable of executing a client application that can exchange information with a large language model application that controls a large language model on a server external to the response output apparatus or stored in the response output apparatus,
wherein the client application is capable of generating a prompt for the large language model based on the user input received via the input interface, sending control information that differs from the prompt to the large language model application, sending the prompt to the large language model application, receiving a response phrase that is a result of inference executed by the large language model from the large language model application, and outputting a response based on the response phrase to the user via the output interface, and
wherein the storage is configured to store settings related to conversation characteristics of a character.

2. The response output apparatus according to claim 1,
wherein the client application is configured to send control information including a stationary instruction based on the settings related to the conversation characteristics of a character to the large language model application, and based on the stationary instruction based on the settings related to the conversation characteristics of a character of the control information and on the prompt generated based on the user input received via the input interface, the large language model application controls the large language model to receive a response phrase which is a result of the executed inference, and
wherein the client application is configured to perform a control to output, from the output interface to the user as a response of the character in a series of conversations, a template phrase associated with the character read from the storage based on the settings related to the conversation characteristics of a character and the response phrase received from the large language model application.

3. The response output apparatus according to claim 2,
wherein the settings related to the conversation characteristics of a character include settings regarding template phrases of a greeting or back-channel feedback of the character and settings regarding the stationary instruction for outputting a favorite saying or back-channel feedback of the character to the large language model.

4. The response output apparatus according to claim 3,
wherein the settings regarding the stationary instruction for outputting a favorite saying or back-channel feedback of the character to the large language model include an instruction for outputting, from the large language model, a common keyword with a keyword indicating the character's personality contained in the settings regarding the template phrases of a greeting or back-channel feedback of the character.

5. The response output apparatus according to claim 4,
wherein the common keyword indicating the character's personality contains conversation characteristics of a character including an expression at the ending of a phrase or an expression of a pronoun.

6. The response output apparatus according to claim 5,
wherein the client application is capable of exchanging information with a server large language model application that controls a server large language model stored in a server external to the response output apparatus, and with a local large language model application that controls a local large language model stored in the response output apparatus, and
wherein the settings related to the conversation characteristics of a character stored in the storage include settings regarding the template phrases of a greeting or back-channel feedback of the character, settings regarding a first stationary instruction for outputting a favorite saying or back-channel feedback of the character by the server large language model, and settings regarding a second stationary instruction for outputting a favorite saying or back-channel feedback of the character by the local large language model.

7. The response output apparatus according to claim 6,
wherein, in the settings related to the conversation characteristics of a character stored in the storage, the settings regarding the first stationary instruction for outputting a favorite saying or back-channel feedback of the character by the server large language model and the settings regarding the second stationary instruction for outputting a favorite saying or back-channel feedback of the character by the local large language model both include the common keyword with the keyword indicating the character's personality contained in the settings regarding the template phrases of a greeting or back-channel feedback of the character.

8. The response output apparatus according to claim 7,
wherein the settings related to the conversation characteristics of a character stored in the storage include settings regarding conversation characteristics related to each of a plurality of characters, and
wherein, in a case where the response output apparatus performs a switch processing of a character that outputs a response, the client application switches the settings related to the conversation characteristics of a character in accordance with the switch processing of the character.

9. The response output apparatus according to claim 2,
wherein the settings related to the conversation characteristics of a character include settings regarding template phrases of back-channel feedback of the character, and
wherein, after the user input is received via the input interface, the client application outputs back-channel feedback based on the settings regarding template phrases of back-channel feedback of the character to the user via the output interface at a timing before inference is executed by the large language model.

10. The response output apparatus according to claim 1,
wherein the settings related to the conversation characteristics of a character stored in the storage include information of a stationary instruction for outputting, by the inference by the large language model, a symbol indicating a position of the back-channel feedback of the character.

11. The response output apparatus according to claim 2,
wherein the client application is configured to perform a control to output, from the output interface to the user, the character's response generated by performing a segmented processing for dividing the response phrase received from the large language model application and an insertion processing for inserting the template phrases associated with the character read from the storage.

12. The response output apparatus according to claim 11,
wherein the client application determines a position at which to divide the response phrase based on a condition regarding a newline symbol contained in the response phrase.

13. The response output apparatus according to claim 12,
wherein the client application sets positions where two newline symbols appear consecutively in the response phrase as candidate positions for dividing the response phrase.

14. The response output apparatus according to claim 2,
wherein the settings related to the conversation characteristics of a character stored in the storage include settings regarding speaking speed of words for when the character speaks the template phrase associated with the character, and
wherein, when the response phrase received from the large language model application is output to the user, the client application is configured to perform a speed adjustment control for adjusting a speaking speed of the response phrase to bring it closer to a speaking speed of words for when the character speaks the template phrase, stored in the storage.

15. The response output apparatus according to claim 14,
wherein the settings related to the conversation characteristics of a character stored in the storage include settings regarding conversation characteristics related to each of a plurality of characters, and
wherein, in a case where the response output apparatus performs a switch processing of a character that outputs a response, the client application switches the settings related to the conversation characteristics of a character in accordance with the switch processing of the character.

16. The response output apparatus according to claim 15,
wherein, when the settings related to the conversation characteristics of a character is switched in accordance with the switch processing of the character and when the response phrase received from the large language model application is output to the user, the client application changes a length of a silence period for speaking at an insertion position where a space symbol or newline symbol in the response phrase in accordance with the switch processing of the character.

17. The response output apparatus according to claim 1,
wherein the settings related to the conversation characteristics of a character stored in the storage include settings regarding a keyword contained in a response and adjustment for an intonation of the keyword for the character, and
wherein, when the character's response is output to the user, based on the settings regarding adjustment of the intonation, the client application performs a control for executing the adjustment of the intonation for the keyword and outputting the response.

18. The response output apparatus according to claim 17,
wherein the settings related to the conversation characteristics of a character stored in the storage include settings regarding conversation characteristics related to each of a plurality of characters, and
wherein, in a case where the response output apparatus performs a switch processing of a character that outputs a response, the client application switches the settings related to the conversation characteristics of a character in accordance with the switch processing of the character.

19. The response output apparatus according to claim 17,
wherein the client application uses a condition of a position relationship between a keyword and a special word contained in the response phrase as a condition for executing adjustment of intonation for the keyword contained in the response phrase received from the large language model application.

20. The response output apparatus according to claim 17,
wherein the client application is configured to send, to the large language model application, a stationary instruction for inserting a predetermined keyword as conversation characteristics of the character and a stationary instruction for outputting an identification symbol indicating a location of the inserted keyword, and
wherein the client application is configured to specify the keyword to which adjustment of the intonation is performed, among the response phrase, based on the identification symbol contained in the response phrase received from the large language model application.
